(19) United States
(12) Patent Application Publication
(10) Pub. No.: US 2025/0216652 A1
(43) Pub. Date: Jul. 3, 2025

(54) OPTICAL PHOTOGRAPHING LENS ASSEMBLY, IMAGING APPARATUS AND ELECTRONIC DEVICE

(71) Applicant: LARGAN PRECISION CO., LTD., Taichung City (TW)

(72) Inventors: Kuan-Ting YEH, Taichung City (TW); I-Chieh CHEN, Taichung City (TW); Cheng-Yu TSAI, Taichung City (TW)

(21) Appl. No.: 18/973,352

(22) Filed: Dec. 9, 2024

(30) Foreign Application Priority Data
Jan. 2, 2024 (TW) 113100162

(51) Int. Cl. G02B 13/00; G02B 9/62; G03B 30/00

(52) U.S. Cl. CPC G02B 13/0045; G02B 9/62; G03B 30/00

(57) ABSTRACT

An optical photographing lens assembly includes two lens element groups, the two lens element groups include six lens elements, the two lens element groups being, in order from an object side to an image side along an optical path, a first lens element group and a second lens element group. The six lens elements are, in order from the object side to the image side along the optical path, a first lens element, a second lens element, a third lens element, a fourth lens element, a fifth lens element and a sixth lens element. Each of the six lens elements has an object-side surface towards the object side and an image-side surface towards the image side.

### RELATED APPLICATIONS

This application claims priority to Taiwan Application Serial Number 113100162, filed Jan. 2, 2024, which is herein incorporated by reference.

### BACKGROUND

### Technical Field

The present disclosure relates to an optical photographing lens assembly and an imaging apparatus. More particularly, the present disclosure relates to an optical photographing lens assembly and an imaging apparatus with compact size applicable to electronic devices.

### Description of Related Art

With recent technology of semiconductor process advances, performances of image sensors are enhanced, so that the smaller pixel size can be achieved. Therefore, optical lens assemblies with high image quality have become an indispensable part of many modern electronics. With rapid developments of technology, applications of electronic devices equipped with optical lens assemblies increase and there is a wide variety of requirements for optical lens assemblies. However, in a conventional optical lens assembly, it is hard to balance among image quality, sensitivity, aperture size, volume or field of view. Thus, there is a demand for an optical lens assembly that meets the aforementioned needs.

### SUMMARY

According to one aspect of the present disclosure, an optical photographing lens assembly includes six lens elements, which are, in order from an object side to an image side along an optical path, a first lens element, a second lens element, a third lens element, a fourth lens element, a fifth lens element and a sixth lens element. Each of the six lens elements has an object-side surface towards the object side and an image-side surface towards the image side. Preferably, the first lens element has positive refractive power. Preferably, the object-side surface of the first lens element is convex in a paraxial region thereof. Preferably, the second lens element has negative refractive power. Preferably, the object-side surface of the second lens element is convex in a paraxial region thereof. Preferably, the image-side surface of the second lens element is concave in a paraxial region thereof. Preferably, the third lens element has positive refractive power. Preferably, the image-side surface of the third lens element is convex in a paraxial region thereof. Preferably, at least one of the first lens element to the sixth lens element includes at least one inflection point. When a maximum field of view of the optical photographing lens assembly at an object distance being infinite is FOVL, a focal length of the second lens element is f2, a focal length of the third lens element is f3, a focal length of the sixth lens element is f6, a central thickness of the second lens element is CT2, a central thickness of the third lens element is CT3, a central thickness of the fourth lens element is CT4, a central thickness of the fifth lens element is CT5, an axial distance between the fifth lens element and the sixth lens element of the optical photographing lens assembly at the object distance being infinite is T56L, a curvature radius of the object-side surface of the second lens element is R3, and a curvature radius of the image-side surface of the second lens element is R4, the following conditions are preferably satisfied: 10.0 degrees<FOVL<55.0 degrees; 0<|f3/f6|<0.75; 0< (CT4+CT5)/T56L<0.90; 4.50<|f2/R3|+|f2/R4|<18.00; and 0.05<CT2/CT3<0.75.

According to another aspect of the present disclosure, an imaging apparatus includes the optical photographing lens assembly of the aforementioned aspect and an image sensor, wherein the image sensor is disposed on an image surface of the optical photographing lens assembly.

According to another aspect of the present disclosure, an electronic device includes the imaging apparatus of the aforementioned aspect.

According to one aspect of the present disclosure, an optical photographing lens assembly includes six lens elements, which are, in order from an object side to an image side along an optical path, a first lens element, a second lens element, a third lens element, a fourth lens element, a fifth lens element and a sixth lens element. Each of the six lens elements has an object-side surface towards the object side and an image-side surface towards the image side. Preferably, the first lens element has positive refractive power. Preferably, the object-side surface of the first lens element is convex in a paraxial region thereof. Preferably, the second lens element has negative refractive power. Preferably, the object-side surface of the second lens element is convex in a paraxial region thereof. Preferably, the image-side surface of the second lens element is concave in a paraxial region thereof. Preferably, the third lens element has positive refractive power. Preferably, the image-side surface of the third lens element is convex in a paraxial region thereof. Preferably, at least one of the first lens element to the sixth lens element includes at least one inflection point. When a maximum field of view of the optical photographing lens assembly at an object distance being infinite is FOVL, a focal length of the third lens element is f3, a focal length of the sixth lens element is f6, a central thickness of the fourth lens element is CT4, a central thickness of the fifth lens element is CT5, an axial distance between the second lens element and the third lens element of the optical photographing lens assembly at the object distance being infinite is T23L, an axial distance between the fifth lens element and the sixth lens element of the optical photographing lens assembly at the object distance being infinite is T56L, a curvature radius of the image-side surface of the first lens element is R2, and a curvature radius of the object-side surface of the second lens element is R3, the following conditions are preferably satisfied: 10.0 degrees<FOVL<55.0 degrees; 0<|f3/f6|<0.75; 0< (CT4+CT5)/T56L<0.90; 0.15< (R2+R3)/(R2−R3)<5.00; and 0.05<CT4/T23L<0.75.

According to one aspect of the present disclosure, an optical photographing lens assembly includes two lens element groups, which include six lens elements. The two lens element groups are, in order from an object side to an image side along an optical path, a first lens element group and a second lens element group. The six lens elements are, in order from the object side to the image side along the optical path, a first lens element, a second lens element, a third lens element, a fourth lens element, a fifth lens element and a sixth lens element. Each of the six lens elements has an object-side surface towards the object side and an image-side surface towards the image side. Preferably, when the imaged object is moved from infinite to macro, the optical photographing lens assembly is changed from a 1st mode to a 2nd mode. During a focusing movement, the second lens element group is moved towards to the image side along an optical axis relative to the first lens element group. During the focusing movement, all lens elements in each of the two lens element groups have no relative movement. Preferably, the first lens element group includes the first lens element, the second lens element and the third lens element. Preferably, the second lens element group includes the fourth lens element, the fifth lens element and the sixth lens element. Preferably, the first lens element has positive refractive power. Preferably, at least one of the first lens element to the sixth lens element includes at least one inflection point. When a central thickness of the first lens element is CT1, a central thickness of the third lens element is CT3, a central thickness of the fourth lens element is CT4, a central thickness of the fifth lens element is CT5, an axial distance between the fifth lens element and the sixth lens element of the optical photographing lens assembly at an object distance being infinite is T56L, an axial distance between the object-side surface of the first lens element and an image surface of the optical photographing lens assembly at the object distance being infinite is TLL, an axial distance between the object-side surface of the first lens element and the image-side surface of the third lens element of the optical photographing lens assembly at the object distance being infinite is Dr1r6L, and an axial distance between the object-side surface of the first lens element and the image surface of the optical photographing lens assembly at the object distance being macro is TLS, the following conditions are satisfied: 0.10< (CT4+CT5)/T56L<1.50; 0.10<CT1/CT3<1.80; 1.00<TLL/Dr1r6L<3.00; and 0.90<TLL/TLS<1.10.

### BRIEF DESCRIPTION OF THE DRAWINGS

The present disclosure can be more fully understood by reading the following detailed description of the embodiment, with reference made to the accompanying drawings as follows:

FIG. 1A is a schematic view of an imaging apparatus at the 1st mode according to the 1st embodiment of the present disclosure.

FIG. 1B is a schematic view of the imaging apparatus at the 2nd mode according to the 1st embodiment.

FIG. 2A shows spherical aberration curves, astigmatic field curves and a distortion curve of the imaging apparatus of FIG. 1A.

FIG. 2B shows spherical aberration curves, astigmatic field curves and a distortion curve of the imaging apparatus of FIG. 1B.

FIG. 3A is a schematic view of an imaging apparatus at the 1st mode according to the 2nd embodiment of the present disclosure.

FIG. 3B is a schematic view of the imaging apparatus at the 2nd mode according to the 2nd embodiment.

FIG. 4A shows spherical aberration curves, astigmatic field curves and a distortion curve of the imaging apparatus of FIG. 3A.

FIG. 4B shows spherical aberration curves, astigmatic field curves and a distortion curve of the imaging apparatus of FIG. 3B.

FIG. 5A is a schematic view of an imaging apparatus 3 at the 1st mode according to the 3rd embodiment of the present disclosure.

FIG. 5B is a schematic view of the imaging apparatus 3 at the 2nd mode according to the 3rd embodiment.

FIG. 6A shows spherical aberration curves, astigmatic field curves and a distortion curve of the imaging apparatus 3 of FIG. 5A.

FIG. 6B shows spherical aberration curves, astigmatic field curves and a distortion curve of the imaging apparatus 3 of FIG. 5B.

FIG. 7A is a schematic view of an imaging apparatus at the 1st mode according to the 4th embodiment of the present disclosure.

FIG. 7B is a schematic view of the imaging apparatus at the 2nd mode according to the 4th embodiment.

FIG. 8A shows spherical aberration curves, astigmatic field curves and a distortion curve of the imaging apparatus of FIG. 7A.

FIG. 8B shows spherical aberration curves, astigmatic field curves and a distortion curve of the imaging apparatus of FIG. 7B.

FIG. 9A is a schematic view of an imaging apparatus at the 1st mode according to the 5th embodiment of the present disclosure.

FIG. 9B is a schematic view of the imaging apparatus at the 2nd mode according to the 5th embodiment.

FIG. 10A shows spherical aberration curves, astigmatic field curves and a distortion curve of the imaging apparatus of FIG. 9A.

FIG. 10B shows spherical aberration curves, astigmatic field curves and a distortion curve of the imaging apparatus of FIG. 9B.

FIG. 11A is a schematic view of an imaging apparatus at the 1st mode according to the 6th embodiment of the present disclosure.

FIG. 11B is a schematic view of the imaging apparatus at the 2nd mode according to the 6th embodiment.

FIG. 12A shows spherical aberration curves, astigmatic field curves and a distortion curve of the imaging apparatus of FIG. 11A.

FIG. 12B shows spherical aberration curves, astigmatic field curves and a distortion curve of the imaging apparatus of FIG. 11B.

FIG. 13A is a schematic view of an imaging apparatus at the 1st mode according to the 7th embodiment of the present disclosure.

FIG. 13B is a schematic view of the imaging apparatus at the 2nd mode according to the 7th embodiment.

FIG. 14A shows spherical aberration curves, astigmatic field curves and a distortion curve of the imaging apparatus of FIG. 13A.

FIG. 14B shows spherical aberration curves, astigmatic field curves and a distortion curve of the imaging apparatus of FIG. 13B.

FIG. 15A is a schematic view of an imaging apparatus at the 1st mode according to the 8th embodiment of the present disclosure.

FIG. 15B is a schematic view of the imaging apparatus at the 2nd mode according to the 8th embodiment.

FIG. 16A shows spherical aberration curves, astigmatic field curves and a distortion curve of the imaging apparatus of FIG. 15A.

FIG. 16B shows spherical aberration curves, astigmatic field curves and a distortion curve of the imaging apparatus of FIG. 15B.

FIG. 17A is a schematic view of an imaging apparatus at the 1st mode according to the 9th embodiment of the present disclosure.

FIG. 17B is a schematic view of the imaging apparatus at the 2nd mode according to the 9th embodiment.

FIG. 18A shows spherical aberration curves, astigmatic field curves and a distortion curve of the imaging apparatus of FIG. 17A.

FIG. 18B shows spherical aberration curves, astigmatic field curves and a distortion curve of the imaging apparatus of FIG. 17B.

FIG. 19A is a schematic view of an imaging apparatus at the 1st mode according to the 10th embodiment of the present disclosure.

FIG. 19B is a schematic view of the imaging apparatus at the 2nd mode according to the 10th embodiment.

FIG. 20A shows spherical aberration curves, astigmatic field curves and a distortion curve of the imaging apparatus of FIG. 19A.

FIG. 20B shows spherical aberration curves, astigmatic field curves and a distortion curve of the imaging apparatus of FIG. 19B.

FIG. 21A is a schematic view of the inflection points and the critical points of each lens element at the 1st mode of FIG. 1A according to the 1st embodiment.

FIG. 21B is a schematic view of partial parameters of the optical photographing lens assembly under the 1st mode according to the 1st embodiment of FIG. 1A.

FIG. 22A is a schematic view of the imaging apparatus with another reflective element E8 at the 1st mode according to the 1st embodiment.

FIG. 22B is a schematic view of the imaging apparatus with another reflective element E8 at the 2nd mode according to the 1st embodiment.

FIG. 23A is a schematic view of any one of the stops with a non-circular shape according to the 1st embodiment of FIG. 1A.

FIG. 23B is a schematic view of any one of the stops with another non-circular shape according to the 1st embodiment of FIG. 1A.

FIG. 24 is a schematic view of an imaging apparatus according to the 11th embodiment of the present disclosure.

FIG. 25A is a schematic view of one side of an electronic device according to the 12th embodiment of the present disclosure.

FIG. 25B is a schematic view of another side of the electronic device of FIG. 25A.

FIG. 25C is a system schematic view of the electronic device of FIG. 25A.

FIG. 26 is a schematic view of one side of an electronic device according to the 13th embodiment of the present disclosure.

FIG. 27 is a schematic view of one side of an electronic device 400 according to the 14th embodiment of the present disclosure.

FIG. 28A is a schematic view of one side of an electronic device according to the 15th embodiment of the present disclosure.

FIG. 28B is a schematic view of another side of the electronic device according to the 15th embodiment of FIG. 28A.

FIG. 29A is a schematic view of an arrangement of a reflective element disposed between the imaged object and the lens element group in the optical photographing lens assembly of the present disclosure.

FIG. 29B is a schematic view of another arrangement of a reflective element disposed between the imaged object and the lens element group in the optical photographing lens assembly of the present disclosure.

FIG. 29C is a schematic view of another arrangement of a reflective element disposed between the imaged object and the lens element group in the optical photographing lens assembly of the present disclosure.

FIG. 30A is a schematic view of an arrangement of two reflective elements in the optical photographing lens assembly of the present disclosure.

FIG. 30B is a schematic view of another arrangement of two reflective elements in the optical photographing lens assembly of the present disclosure.

FIG. 31A is a schematic view of an arrangement of a reflective element in the optical photographing lens assembly of the present disclosure.

FIG. 31B is a schematic view of another arrangement of a reflective element in the optical photographing lens assembly of the present disclosure.

FIG. 31C is a schematic view of another arrangement of a reflective element in the optical photographing lens assembly of the present disclosure.

FIG. 32A is a schematic view of another arrangement of a reflective element in the optical photographing lens assembly of the present disclosure.

FIG. 32B is a schematic view of another arrangement of a reflective element in the optical photographing lens assembly of the present disclosure.

### DETAILED DESCRIPTION

The present disclosure provides an optical photographing lens assembly, which includes two lens element groups. The two lens element groups include six lens elements. The two lens element groups are, in order from an object side to an image side along an optical path, a first lens element group and a second lens element group. The six lens elements are, in order from the object side to the image side along the optical path, a first lens element, a second lens element, a third lens element, a fourth lens element, a fifth lens element and a sixth lens element. Each of the six lens elements has an object-side surface towards the object side and an image-side surface towards the image side. Therefore, it is favorable for obtaining the balance among the volume, the focusing function in the object distance movement, the image quality and the difficulty of assembling by the arrangement of the two lens element groups. In detail, the optical photographing lens assembly of the present disclosure provides the design of the lens element groups, so that the focal length thereof can be adjusted by changing the distance between the lens element groups according to the object distance so as to achieve the focusing process. Further, by providing different light traveling directions, it is favorable for providing more flexible using space of the optical photographing lens assembly to present telephoto function with long focal length, and also favorable for obtaining high image quality at both of distance shooting and close up shooting so as to promote the flexibility of photographing.

When the imaged object is moved from infinite to macro, the optical photographing lens assembly is changed from a 1st mode to a 2nd mode. During a focusing movement, the second lens element group is moved towards to the image side along an optical axis relative to the first lens element group. Therefore, it is favorable for achieving the close-up shooting effect and simplifying the complexity of the optical design and the mechanism.

During the focusing movement, all lens elements in each of the two lens element groups have no relative movement. Therefore, it is favorable for simplifying the complexity of the mechanism.

In the optical photographing lens assembly, the first lens element has positive refractive power. Therefore, light can be further gathered by adjusting the refractive power of the first lens element, so that it is favorable for controlling the photographing field of view and enhancing the amount of incoming light. The object-side surface of the first lens element can be convex in a paraxial region thereof. Therefore, it is favorable for compressing the outer diameter of the object-side end of the optical photographing lens assembly by adjusting the surface shape of the first lens element.

The second lens element can have negative refractive power. Therefore, it is favorable for effectively balancing the refractive power of the first lens element so as to avoid excessive aberrations generated by too large refraction angle of light. The object-side surface of the second lens element can be convex in a paraxial region thereof. Therefore, it is favorable for converging light by adjusting the traveling direction of light. The image-side surface of the second lens element can be concave in a paraxial region thereof. Therefore, it is favorable for balancing spherical aberration of the optical photographing lens assembly by adjusting the refractive power of the second lens element.

The third lens element can have positive refractive power. Therefore, it is favorable for converging light, controlling the traveling direction of light effectively, and obtaining the balance between the field of view and the volume. The image-side surface of the third lens element can be convex in a paraxial region thereof. Therefore, it is favorable for enlarging the image surface by adjusting the light exiting direction from the third lens element.

The object-side surface of the fourth lens element can be concave in a paraxial region thereof. Therefore, the light incident angle on the object-side surface of the fourth lens element can be controlled, so that it is favorable for avoiding the light divergence and poor relative illumination in the peripheral area caused by excessive incident angle.

The object-side surface of the fifth lens element can be convex in a paraxial region thereof, so that it is favorable for balancing the refractive power of the fifth lens element and reducing the back focal length.

The sixth lens element can have negative refractive power. Therefore, the refractive power of the image-side end of the sixth lens element can be balanced, so that it is favorable for enhancing the light convergence quality on the image surface of light from each field of view and reducing aberrations. The image-side surface of the sixth lens element can be convex in a paraxial region thereof, so that it is favorable for balancing the back focal length of the optical photographing lens assembly and also correcting off-axis aberration.

At least one of the first lens element to the sixth lens element can include at least one inflection point. Therefore, it is favorable for correcting astigmatism by enhancing the flexibility of optical design.

At least one of the object-side surface and the image-side surface of the fourth lens element can include at least one critical point. Therefore, it is favorable for correcting astigmatism and enlarging the image surface by adjusting the surface shape of the fourth lens element in the peripheral area. Further, the object-side surface of the fourth lens element can include at least one convex critical point. Therefore, it is favorable for avoiding the vignetting generated on the peripheral area of the image and reducing the distortion by controlling the angle of the peripheral light at the object side of the fourth lens element.

When a central thickness of the fourth lens element is CT4, a central thickness of the fifth lens element is CT5, and an axial distance between the fifth lens element and the sixth lens element of the optical photographing lens assembly at the object distance being infinite is T56L, the following condition is satisfied: 0< (CT4+CT5)/T56L<0.90; or 0.10< (CT4+CT5)/T56L<1.50. Therefore, it is favorable for balancing the light incident angle on the image surface during the focusing movement by arranging the greater distance between the fifth lens element and the sixth lens element so as to avoid the generation of stray light. Furthermore, the following condition can be satisfied: 0.15< (CT4+CT5)/T56L<0.75. Furthermore, the following condition can be satisfied: 0.28≤(CT4+CT5)/T56L≤0.63.

When a maximum field of view of the optical photographing lens assembly at the object distance being infinite is FOVL, the following condition is satisfied: 10.0 degrees<FOVL<55.0 degrees. Therefore, the optical photographing lens assembly can have proper field of view for telephoto applications. Furthermore, the following condition can be satisfied: 20.0 degrees<FOVL<45.0 degrees. Furthermore, the following condition can be satisfied: 25.0 degrees<FOVL<40.0 degrees. Furthermore, the following condition can be satisfied: 33.6 degrees≤FOVL≤35.6 degrees.

When a focal length of the third lens element is f3, and a focal length of the sixth lens element is f6, the following condition is satisfied: 0<|f3/f6|<0.75. Thus, the ratio of the refractive power of the third lens element and the sixth lens element can be adjusted, the third lens element can obtain the ability of light convergence which can be balance by the sixth lens element. Therefore, it is favorable for enhancing the light convergence quality of the entire field of view by balancing light convergence or light divergence. Furthermore, the following condition can be satisfied: 0.03<|f3/f6|<0.65. Furthermore, the following condition can be satisfied: 0.08≤|f3/f6|≤0.60.

When a focal length of the second lens element is f2, a curvature radius of the object-side surface of the second lens element is R3, and a curvature radius of the image-side surface of the second lens element is R4, the following condition is satisfied: 4.50<|f2/R3|+|f2/R4|<18.00. Therefore, the refractive power of the second lens element, the curvature radius of the object-side surface of the second lens element and the curvature radius of the image-side surface of the second lens element can be adjusted, it is favorable for efficiently balancing the deflection angle of the light from the first lens element so as to reduce aberrations. Furthermore, the following condition can be satisfied: 6.00<|f2/R3|+|f2/R4|<15.00. Furthermore, the following condition can be satisfied: 6.09≤|f2/R3|+|f2/R4|≤12.09.

When a central thickness of the second lens element is CT2, and a central thickness of the third lens element is CT3, the following condition is satisfied: 0.05<CT2/CT3<0.75. Therefore, it is favorable for concerning the manufacturing limitation of the third lens element by controlling the ratio between the central thicknesses of the second lens element and the third lens element, and is also favorable for reducing the volume of the optical photographing lens assembly by adjusting the central thickness of the second lens element. Furthermore, the following condition can be satisfied: 0.12<CT2/CT3<0.65. Furthermore, the following condition can be satisfied: 0.19≤CT2/CT3≤0.53.

When a curvature radius of the image-side surface of the first lens element is R2, and a curvature radius of the object-side surface of the second lens element is R3, the following condition is satisfied: 0.15< (R2+R3)/(R2−R3)<5.00. Therefore, it is favorable for adjusting the traveling direction of the light on the peripheral area by effectively balancing the curvature radius of the image-side surface of the first lens element and the curvature radius of the object-side surface of the second lens element so as to correct astigmatism and reduce stray light of the optical photographing lens assembly. Furthermore, the following condition can be satisfied: 0.20< (R2+R3)/(R2−R3)<3.00. Furthermore, the following condition can be satisfied: 0.25< (R2+R3)/(R2−R3)<2.50. Furthermore, the following condition can be satisfied: 0.30< (R2+R3)/(R2−R3)<2.00. Furthermore, the following condition can be satisfied: 0.40≤(R2+R3)/(R2−R3)≤1.83.

When the central thickness of the fourth lens element is CT4, and an axial distance between the second lens element and the third lens element of the optical photographing lens assembly at the object distance being infinite is T23L, the following condition is satisfied: 0.05<CT4/T23L<0.75. Therefore, it is favorable for balancing the space arrangement of the lens element group on the object side and the lens element group on the image side and also favorable for maintaining high quality of light convergence at several object distances by balancing the axial distance between the second lens element and the third lens element and the central thickness of the fourth lens element. Furthermore, the following condition can be satisfied: 0.12<CT4/T23L<0.65. Furthermore, the following condition can be satisfied: 0.17≤CT4/T23L≤0.59.

When a central thickness of the first lens element is CT1, and the central thickness of the third lens element is CT3, the following condition is satisfied: 0.10<CT1/CT3<1.80. Therefore, it is favorable for enhancing the design flexibility and reducing the manufacturing tolerances by controlling the ratio between the central thickness of the first lens element and the central thickness of the third lens element. Furthermore, the following condition can be satisfied: 0.10<CT1/CT3<1.20. Furthermore, the following condition can be satisfied: 0.20<CT1/CT3<1.40. Furthermore, the following condition can be satisfied: 0.30<CT1/CT3<1.00. Furthermore, the following condition can be satisfied: 0.55≤ CT1/CT3≤0.90.

When an axial distance between the object-side surface of the first lens element and the image surface of the optical photographing lens assembly at the object distance being infinite is TLL, and an axial distance between the object-side surface of the first lens element and the image-side surface of the third lens element of the optical photographing lens assembly at the object distance being infinite is Dr1r6L, the following condition is satisfied: 1.00<TLL/Dr1r6L<3.50. Therefore, it is favorable for compressing the volume of the optical photographing lens assembly by maintaining the ratio between the total track length thereof and the length of the first lens element group. Furthermore, the following condition can be satisfied: 1.00<TLL/Dr1r6L<3.00. Furthermore, the following condition can be satisfied: 1.50<TLL/Dr1r6L<3.00. Furthermore, the following condition can be satisfied: 1.80<TLL/Dr1r6L<2.50. Furthermore, the following condition can be satisfied: 2.15≤TLL/Dr1r6L≤2.30.

When the axial distance between the object-side surface of the first lens element and the image surface of the optical photographing lens assembly at the object distance being infinite is TLL, and an axial distance between the object-side surface of the first lens element and the image surface of the optical photographing lens assembly at the object distance being macro is TLS, the following condition is satisfied: 0.90<TLL/TLS<1.10. Therefore, it is favorable for simplifying the complexity of the mechanism design by maintaining the same optical total track length during focusing movement so as to facilitate the assembling of the optical photographing lens assembly. Furthermore, the following condition can be satisfied: 0.95<TLL/TLS<1.05. Furthermore, the following condition can be satisfied: 0.98<TLL/TLS<1.02. Furthermore, the following condition can be satisfied: TLL/TLS=1.00.

When the axial distance between the object-side surface of the first lens element and the image-side surface of the third lens element of the optical photographing lens assembly at the object distance being infinite is Dr1r6L, and an axial distance between the object-side surface of the fourth lens element and the image-side surface of the sixth lens element of the optical photographing lens assembly at the object distance being infinite is Dr7r12L, the following condition is satisfied: 1.00<Dr1r6L/Dr7r12L<2.00. Therefore, the axial length of the lens element group on the object side and the axial length of the moved lens element group can be adjusted, so that it is favorable for balancing the space arrangement of the lens elements so as to reduce the sensitivity of the optical photographing lens assembly during the focusing movement. Furthermore, the following condition can be satisfied: 1.20<Dr1r6L/Dr7r12L<1.80.

At least one of the first lens element to the sixth lens element can be made of glass material. Therefore, the sensitivity of the environment factors can be effectively reduced by using the glass material, so that it is favorable for maintaining high stability to apply on different environments. At least one of the first lens element to the third lens element can be made of glass material.

When the curvature radius of the object-side surface of the second lens element is R3, and the curvature radius of the image-side surface of the second lens element is R4, the following condition is satisfied: 0< (R3−R4)/(R3+R4)<0.50. Therefore, it is favorable for compressing the outer diameter of the first lens element group by effectively balancing the curvature radius of the object-side surface of the second lens element and the curvature radius of the image-side surface of the second lens element. Furthermore, the following condition can be satisfied: 0.10< (R3−R4)/(R3+R4)<0.35.

When a curvature radius of the object-side surface of the first lens element is R1, and the curvature radius of the image-side surface of the second lens element is R4, the following condition is satisfied: 0.10<R4/R1<0.70. Therefore, it is favorable for balancing the convergence ability of light from the object side by adjusting the curvature radius of the object-side surface of the first lens element and the curvature radius of the image-side surface of the second lens element. Furthermore, the following condition can be satisfied: 0.15<R4/R1<0.65.

When a curvature radius of the object-side surface of the third lens element is R5, and a curvature radius of the image-side surface of the third lens element is R6, the following condition is satisfied: −0.20< (R5+R6)/(R5−R6)<2.00. Therefore, the curvature radius of the object-side surface of the third lens element and the curvature radius of the image-side surface of the third lens element can be effectively balanced, it is favorable for enhancing light convergence ability of the imaging light so as to improve the image curvature and spherical aberration. Furthermore, the following condition can be satisfied: −0.10< (R5+R6)/(R5−R6)<1.25. Furthermore, the following condition can be satisfied: 0< (R5+R6)/(R5−R6)<1.50.

When a central thickness of the first lens element is CT1, and an axial distance between the second lens element and the third lens element of the optical photographing lens assembly at the object distance being infinite is T23L, the following condition is satisfied: 0.10<CT1/T23L<1.70. Therefore, it is favorable for maintaining the space arrangement of the first lens element group by adjusting the central thickness of the first lens element and the axial distance between the second lens element and the third lens element. Furthermore, the following condition can be satisfied: 0.35<CT1/T23L<1.70. Furthermore, the following condition can be satisfied: 0.42<CT1/T23L<1.55. Furthermore, the following condition can be satisfied: 0.42<CT1/T23L<1.50.

When an axial distance between an image-side surface of a lens element closet to the image side and an image surface of the optical photographing lens assembly at the object distance being infinite is BLL, and a maximum image height of the optical photographing lens assembly is ImgH, the following condition is satisfied: 0.50<BLL/ImgH<1.10. Therefore, it is favorable for maintaining the proper back focal length and enlarging the image surface. Furthermore, the following condition can be satisfied: 0.60<BLL/ImgH<1.00.

When a displacement in parallel with an optical axis from an axial vertex on the object-side surface of the third lens element to a maximum effective radius position on the object-side surface of the third lens element of the optical photographing lens assembly at the object distance being infinite is Sag3R1L, and the central thickness of the third lens element is CT3, the following condition is satisfied: 0<|Sag3R1L|/CT3<0.30. Therefore, it is favorable for effectively controlling the deflection angle of the light incident from the peripheral area of the object side of the third lens element by balancing the curvature of the surface shape on the peripheral area of the object-side surface of the third lens element. Furthermore, the following condition can be satisfied: 0.01<|Sag3R1L|/CT3<0.20.

When a displacement in parallel with the optical axis from an axial vertex on the image-side surface of the sixth lens element to a maximum effective radius position on the image-side surface of the sixth lens element of the optical photographing lens assembly at the object distance being infinite is Sag6R2L, and a central thickness of the sixth lens element is CT6, the following condition is satisfied: 0.60<|Sag6R2L|/CT6<5.00. Therefore, it is favorable for enlarging the image surface and correcting aberrations, such as distortion, by. Balancing the curvature of the surface shape on the peripheral area of the image-side surface of the sixth lens element. Furthermore, the following condition can be satisfied: 0.75<|Sag6R2L|/CT6<3.00.

When a maximum effective radius position of the object-side surface of the first lens element of the optical photographing lens assembly at the object distance being infinite is Y1R1L, and a maximum effective radius position of the image-side surface of the sixth lens element of the optical photographing lens assembly at the object distance being infinite is Y6R2L, the following condition is satisfied: 0.80<Y1R1L/Y6R2L<1.30. Therefore, the light traveling direction can be adjusted by balancing the effective radius position of the object-side surface of the first lens element and the effective radius position of the image-side surface of the sixth lens element, so that it is favorable for compressing the outer diameter and enlarging the image surface. Furthermore, the following condition can be satisfied: 0.90<Y1R1L/Y6R2L<1.20.

The optical photographing lens assembly can further include a reflective element, which is favorable for providing different light traveling directions in the optical photographing lens assembly so that the arrangement of the optical photographing lens assembly can be more flexible, and the limitation of mechanism can be reduced and the compactness of the optical photographing lens assembly can be obtained. Furthermore, the reflective element can be disposed between an imaged object and the first lens element. Therefore, it is favorable for providing the advantage of capturing long distance scenery and also favorable for reducing the specification restriction of thickness of the electronic device.

When the focal length of the third lens element is f3, and a focal length of the fifth lens element is f5, the following condition is satisfied: 0.01<|f3/f5|<0.80. Therefore, it is favorable for controlling the light traveling direction by adjusting the ratio of the refractive power of the third lens element and the fifth lens element, so that the incident angle of the light on the image surface can be decreased. Furthermore, the following condition can be satisfied: 0.03<|f3/f5|<0.55.

When a central thickness of the third lens element is CT3, the central thickness of the fourth lens element is CT4, the central thickness of the fifth lens element is CT5, and an axial distance between the fourth lens element and the fifth lens element of the optical photographing lens assembly at the object distance being infinite is T45L, the following condition is satisfied: 0.80<CT3/(CT4+T45L+CT5)<3.00. Therefore, it is favorable for correcting off-axis aberration and maintaining low chromatic aberration by arranging the ratio between the central thickness of the third lens element and the axial distance between the fourth lens element and the fifth lens element. Furthermore, the following condition can be satisfied: 1.00<CT3/(CT4+T45L+CT5)<2.50.

When the axial distance between the second lens element and the third lens element of the optical photographing lens assembly at the object distance being infinite is T23L, and an axial distance between the fourth lens element and the fifth lens element of the optical photographing lens assembly at the object distance being infinite is T45L, the following condition is satisfied: 0.01<T45L/T23L<0.50. Therefore, it is favorable for compressing the volume and correcting spherical aberration by balancing the axial distance between the second lens element and the third lens element and the axial distance between the fourth lens element and the fifth lens element. Furthermore, the following condition can be satisfied: 0.03<T45L/T23L<0.45.

When an Abbe number of the fourth lens element is V4, and an Abbe number of the sixth lens element is V6, the following condition is satisfied: 90.0<V4+V6<130.0. Therefore, it is favorable for preventing the image overlapping under different object distances by adjusting the material of the fourth lens element and the sixth lens element. Furthermore, the following condition can be satisfied: 100.0<V4+V6<120.0.

When an axial distance between the first lens element group and the second lens element group of the optical photographing lens assembly at the object distance being infinite is TG1G2L, and an axial distance between the first lens element group and the second lens element group of the optical photographing lens assembly at the object distance being macro is TG1G2S, the following condition is satisfied: 2.20< (TG1G2S−TG1G2L)/TG1G2L<6.00. Therefore, it is favorable for capturing the object under smaller object distance and satisfying the specification requirement of the image sensor with large size by enlarging moving amount of the second lens element group during focusing movement. Furthermore, the following condition can be satisfied: 2.50< (TG1G2S−TG1G2L)/TG1G2L<5.00.

When an axial distance between an image-side surface of a lens element closet to the image side and an image surface of the optical photographing lens assembly at the object distance being infinite is BLL, and an axial distance between an image-side surface of a lens element closet to the image side and an image surface of the optical photographing lens assembly at the object distance being macro is BLS, the following condition is satisfied: 1.50<BLL/BLS<3.00. Therefore, it is favorable for decreasing the incident angle of light on the image surface and increasing the illumination by balancing the moving amount of the second lens element group via the back focal length during focusing movement. Furthermore, the following condition can be satisfied: 1.60<BLL/BLS<2.60.

When a central thickness of the sixth lens element is CT6, and the axial distance between the fifth lens element and the sixth lens element of the optical photographing lens assembly at the object distance being infinite is T56L, the following condition is satisfied: 0.01<CT6/T56L<1.00. Therefore, it is favorable for increasing the efficiency of space utilization by balancing the axial distance between the fifth lens element and the sixth lens element and the central thickness of the sixth lens element. Furthermore, the following condition can be satisfied: 0.05<CT6/T56L<0.80.

Moreover, a barrel or a lens element of the optical photographing lens assembly can be cut for reducing the length of single axis, so that the volume of the optical photographing lens assembly can be decreased so as to reach the compactness.

Each of the aforementioned features of the optical photographing lens assembly can be utilized in various combinations for achieving the corresponding effects.

According to the optical photographing lens assembly of the present disclosure, the lens elements thereof can be made of glass or plastic materials. When the lens elements are made of glass materials, the distribution of the refractive power of the optical photographing lens assembly may be more flexible to design. The glass lens element can either be made by grinding or molding. When the lens elements are made of plastic materials, manufacturing costs can be effectively reduced. Furthermore, surfaces of each lens element can be arranged to be aspheric (ASP), since the aspheric surface of the lens element is easy to form a shape other than a spherical surface so as to have more controllable variables for eliminating aberrations thereof, and to further decrease the required amount of lens elements in the optical photographing lens assembly. Therefore, the total track length of the optical photographing lens assembly can also be reduced. The aspheric surfaces may be formed by a plastic injection molding method, a glass molding method or other manufacturing methods.

According to the optical photographing lens assembly of the present disclosure, additives can be selectively added into any one (or more) material of the lens elements so as to change the transmittance of the lens element in a particular wavelength range. Therefore, the stray light and chromatic aberration can be reduced. For example, the additives can have the absorption ability for light in a wavelength range of 600 nm-800 nm in the optical photographing lens assembly so as to reduce extra red light or infrared light, or the additives can have the absorption ability for light in a wavelength range of 350 nm-450 nm in the optical photographing lens assembly so as to reduce blue light or ultraviolet light. Therefore, additives can prevent the image from interfering by light in a particular wavelength range. Furthermore, the additives can be homogeneously mixed with the plastic material, and the lens elements can be made by the injection molding method. Moreover, the additives can be coated on the lens surfaces to provide the aforementioned effects.

According to the optical photographing lens assembly of the present disclosure, when a surface of the lens element is aspheric, it indicates that entire optical effective region of the surface of the lens element or a part thereof is aspheric.

According to the optical photographing lens assembly of the present disclosure, when the lens elements have surfaces being convex and the convex surface position is not defined, it indicates that the aforementioned surfaces of the lens elements can be convex in the paraxial region thereof. When the lens elements have surfaces being concave and the concave surface position is not been defined, it indicates that the aforementioned surfaces of the lens elements can be concave in the paraxial region thereof. In the optical photographing lens assembly of the present disclosure, if the lens element has positive refractive power or negative refractive power, or the focal length of the lens element, all can be referred to the refractive power, or the focal length, in the paraxial region of the lens element.

According to the optical photographing lens assembly of the present disclosure, a critical point is a non-axial point of the lens surface where its tangent is perpendicular to the optical axis; an inflection point is a point on a lens surface with a curvature changing from positive to negative or from negative to positive.

According to the optical photographing lens assembly of the present disclosure, the image surface thereof, based on the corresponding image sensor, can be flat or curved. In particular, the image surface can be a concave curved surface facing towards the object side. Furthermore, the optical photographing lens assembly of the present disclosure can selectively include at least one image correcting element (such as a field flattener) inserted between the lens element closest to the image surface and the image surface, thus the effect of correcting image aberrations (such as field curvature) can be achieved. The optical properties of the aforementioned image correcting element, such as curvature, thickness, refractive index, position, surface shape (convex or concave, spherical or aspheric, diffraction surface and Fresnel surface, etc.) can be adjusted corresponding to the demands of the imaging apparatus. Generally, a preferred configuration of the image correcting element is to dispose a thin plano-concave element having a concave surface toward the object side on the position closed to the image surface.

According to the optical photographing lens assembly of the present disclosure, the optical photographing lens assembly can further include at least one reflective element, such as a prism or a reflective mirror, etc., so that the space arrangement can be more flexible. The reflective element disposed between an imaged object and the image surface, so that it is favorable for reducing the volume of the optical photographing lens assembly. The light path can be reflected at least once via the reflective element, wherein an angle between a reflective surface (such as a normal line thereof) and the optical axis can be, but not limited to 45 degrees, which can be other angle according to the requirements, such as space arrangement. The angle between the optical axis vector close to the object side and the optical axis vector close to the image side can be any angle, and will not be limited to 0 degrees, 90 degrees or 180 degrees. Further, in order to reduce the occupied volume or others reasons, the length and the width of the reflective mirror can be unequal, and the length, the width and the height of the prism can be unequal to each other. The surface shape of the reflective element can be planar, aspheric or a freeform surface, etc., based on the optical design or others requirements, and will not be limited thereto. Examples of different types and arrangements of reflective elements are described below with reference to the drawings, but the present disclosure will not be limited thereto.

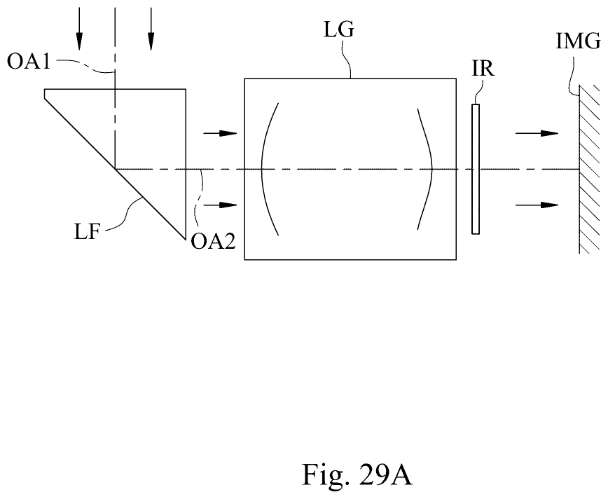

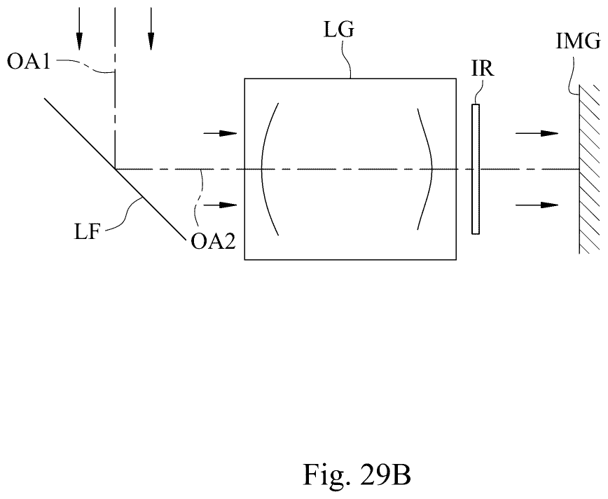

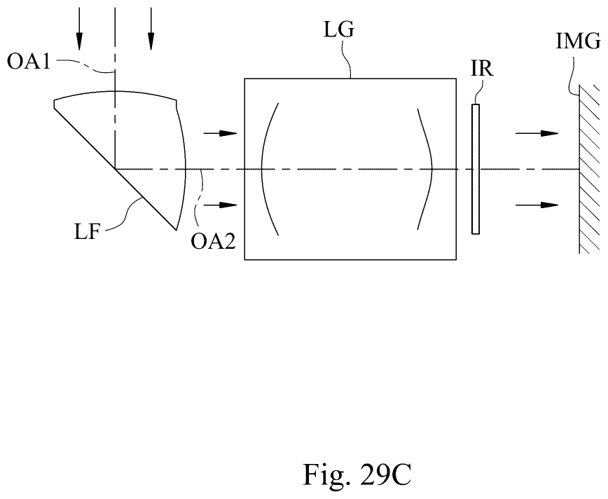

FIG. 29A, FIG. 29B and FIG. 29C are schematic views of each different arrangement of a reflective element LF disposed between the imaged object and the lens element group LG in the optical photographing lens assembly of the present disclosure. In each of FIG. 29A, FIG. 29B and FIG. 29C, the optical photographing lens assembly includes, in order from an imaged object to an image surface IMG along an optical path, a first optical axis OA1, a reflective element LF, a second optical axis OA2, a lens element group LG and a filter IR, wherein the reflective element LF is disposed between the imaged object and the lens element group LG. Specifically, in FIG. 29A, the reflective element LF is a prism, which has an light incident surface and light exiting surface being both planar; in FIG. 29B, the reflective element LF is a reflective mirror being planar; in FIG. 29C, the reflective element LF is a prism, which has an light incident surface and light exiting surface being both curved.

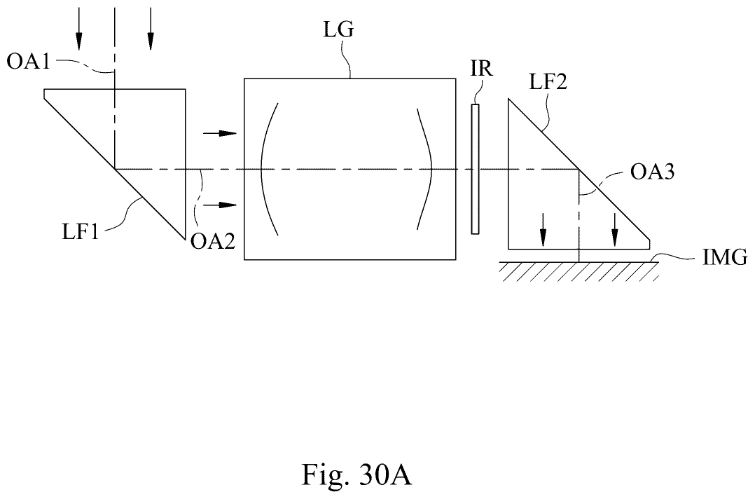

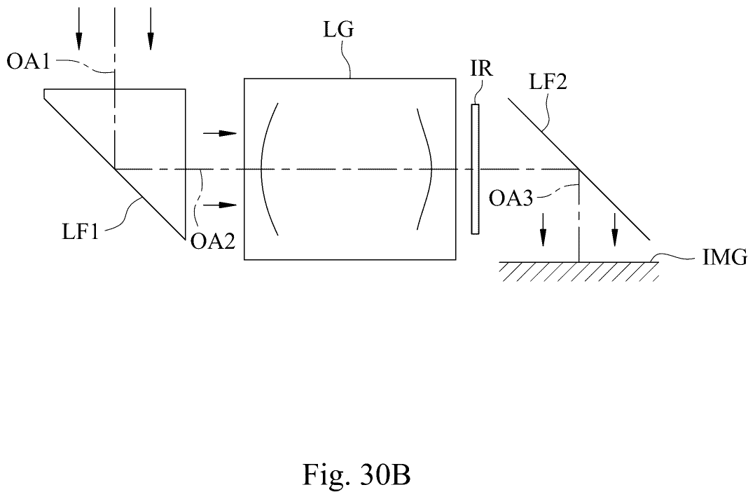

FIG. 30A and FIG. 30B are schematic views of each different arrangement of two reflective elements LF1, LF2 in the optical photographing lens assembly of the present disclosure. In each of FIG. 30A and FIG. 30B, the optical photographing lens assembly includes, in order from an imaged object to an image surface IMG along an optical path, a first optical axis OA1, the reflective element LF1, a second optical axis OA2, a filter IR, the reflective element LF2 and a third optical axis OA3, wherein the reflective element LF1 is disposed between the imaged object and a lens element group LG, the reflective element LF2 is disposed between the filter IR and the image surface IMG of the optical photographing lens assembly. Specifically, in FIG. 30A, both of the reflective element LF1 and the reflective element LF2 are prisms, which have an light incident surface and light exiting surface being both planar; in FIG. 30B, the reflective element LF1 is a prism, which has an light incident surface and light exiting surface being both planar, and the reflective element LF2 is a reflective mirror being planar.

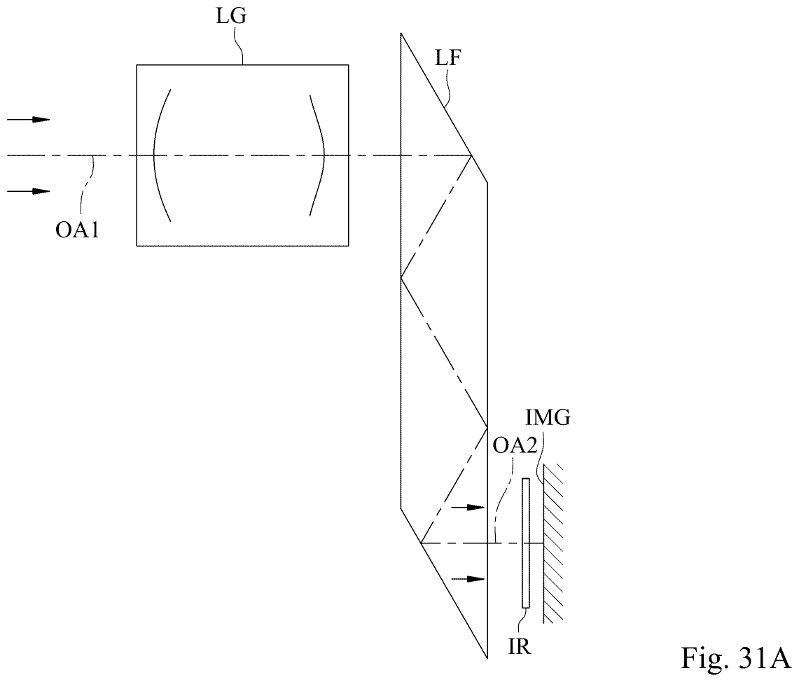

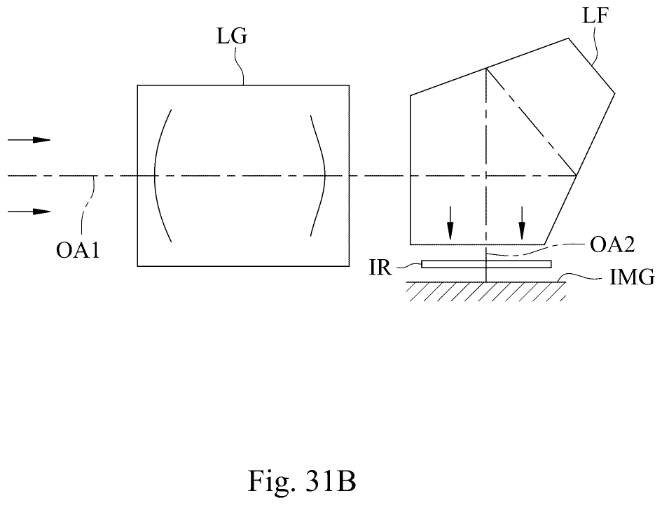

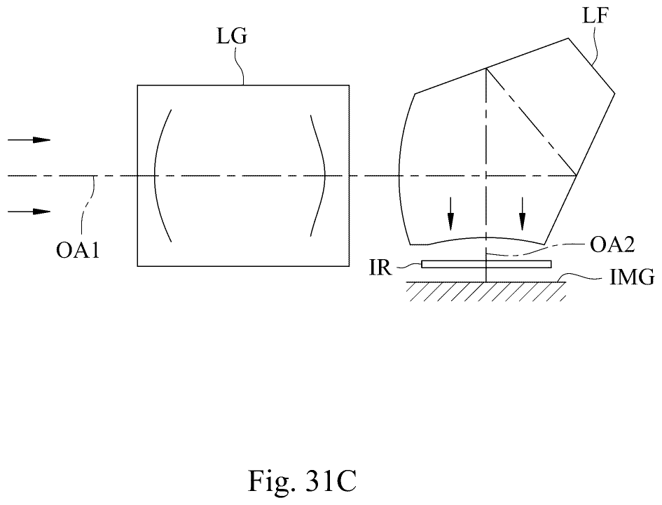

FIG. 31A, FIG. 31B and FIG. 31C are schematic views of each different arrangement of a reflective element LF in the optical photographing lens assembly of the present disclosure. In each of FIG. 31A, FIG. 31B and FIG. 31C, the reflective element LF is disposed between a lens element group LG and an image surface IMG, and the reflective element LF provides at least twice reflections, that is, the light is reflected at least twice by the reflective element LF after enters the lens element group LG along a first optical axis OA1, and then passes through a filter IR along a second optical axis OA2 so as to image on the image surface IMG. Specifically, in FIG. 31A, the reflective element LF provides four times reflections; in FIG. 31B, the reflective element LF is a pentaprism, which provides twice reflections, and has an light incident surface and light exiting surface being both planar; in FIG. 31C, the reflective element LF is a pentaprism, which provides twice reflections, and has an light incident surface and light exiting surface being both curved.

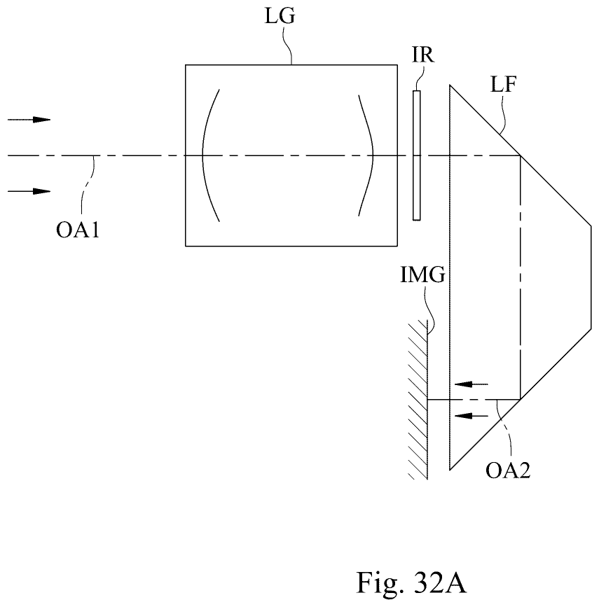

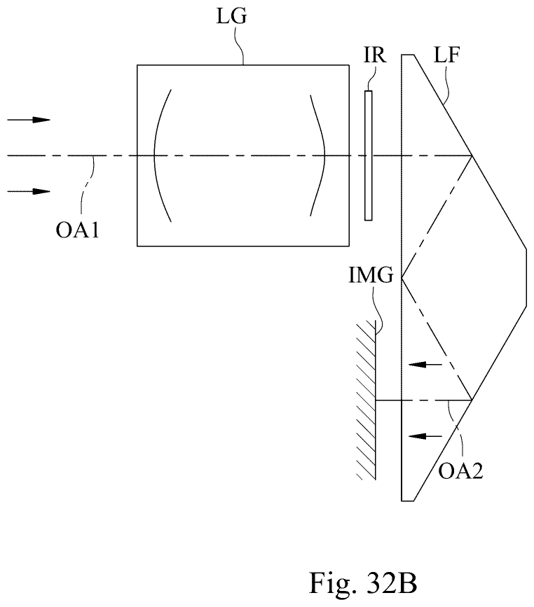

FIG. 32A and FIG. 32B are schematic views of each different arrangement of a reflective element LF in the optical photographing lens assembly of the present disclosure. In each of FIG. 32A and FIG. 32B, the reflective element LF is disposed between a filter IR and an image surface IMG, and the filter IR is disposed on an image side of a lens element group LG. The reflective element LF provides at least twice reflections, that is, the light is reflected at least twice by the reflective element LF after enters the lens element group LG along a first optical axis OA1 and passes through a filter IR, and then is imaged the image surface IMG along a second optical axis OA2. Specifically, in FIG. 32A, the reflective element LF provides twice reflections; in FIG. 32A, the reflective element LF provides thrice reflections.

Furthermore, according to the optical photographing lens assembly of the present disclosure, the optical photographing lens assembly can include at least one stop, such as an aperture stop, a glare stop or a field stop, for eliminating stray light and thereby improving image resolution thereof.

According to the optical photographing lens assembly of the present disclosure, the aperture stop can be configured as a front stop or a middle stop, wherein the front stop indicates that the aperture stop is disposed between an object and the first lens element, and the middle stop indicates that the aperture stop is disposed between the first lens element and the image surface. When the aperture stop is a front stop, a longer distance between an exit pupil of the optical photographing lens assembly and the image surface can be obtained, and thereby obtains a telecentric effect and improves the image-sensing efficiency of the image sensor, such as CCD or CMOS. The middle stop is favorable for enlarging the field of view of the optical photographing lens assembly and thereby provides a wider field of view for the same.

According to the optical photographing lens assembly of the present disclosure, an aperture control unit can be properly configured. The aperture control unit can be a mechanical element or a light controlling element, and the dimension and the shape of the aperture control unit can be electrically controlled. The mechanical element can include a moveable component such a blade group or a shielding plate. The light controlling element can include a screen component such as a light filter, an electrochromic material, a liquid crystal layer or the like. The amount of incoming light or the exposure time of the image can be controlled by the aperture control unit to enhance the image moderation ability. In addition, the aperture control unit can be the aperture stop of the optical photographing lens assembly according to the present disclosure, so as to moderate the image quality by changing f-number such as changing the depth of field or the exposure speed.

The optical photographing lens assembly according to the present disclosure can include at least one optical lens element, an optical element or a carrier. A low reflection layer is disposed on at least one surface of at least one optical lens element, the optical element or the carrier, wherein the low reflection layer is favorable for effectively reducing the stray light formed by the reflection of light on the interface. The low reflection layer can be disposed on the non-optically effective area of the object-side surface or the image-side surface of the optical lens element, or can be disposed on the connecting surface between the object-side surface or the image-side surface; wherein the optical element can be at least one of a light blocking element, an annular spacer element, a barrel element, a cover glass, a blue glass, a filter or a color filter, a light path folding element, a prism or a mirror, etc.; wherein the carrier can be a lens group lens mount, a micro lens disposed on the image sensor, the peripheral of the image sensor substrate or a glass sheet for protecting the image sensor, etc.

According to the optical photographing lens assembly of the present disclosure, the optical photographing lens assembly of the present disclosure can be applied to 3D (three-dimensional) image capturing applications, in products such as digital cameras, mobile devices, digital tablets, smart TVs, surveillance systems, motion sensing input devices, driving recording systems, rearview camera systems, wearable devices, unmanned aerial vehicles, and other electronic imaging products.

According to the present disclosure, an imaging apparatus including the aforementioned optical photographing lens assembly and an image sensor is provided, wherein the image sensor is disposed on the image surface of the optical photographing lens assembly. By the arrangement of the refractive power, thicknesses and locations in the optical photographing lens assembly, it is favorable for strengthening the convergence ability of the lens elements on the image side, reducing the total track length of the optical photographing lens assembly and increasing the efficiency of space utilization. Moreover, the imaging apparatus can further include a barrel member, a holder member or a combination thereof.

According to the present disclosure, an electronic device including the aforementioned imaging apparatus is provided. Therefore, the image quality can be increased. Moreover, the electronic device can further include a control unit, a display, a storage unit, a random-access memory unit (RAM) or a combination thereof.

According to the above description of the present disclosure, the following specific embodiments are provided for further explanation.

### 1st Embodiment

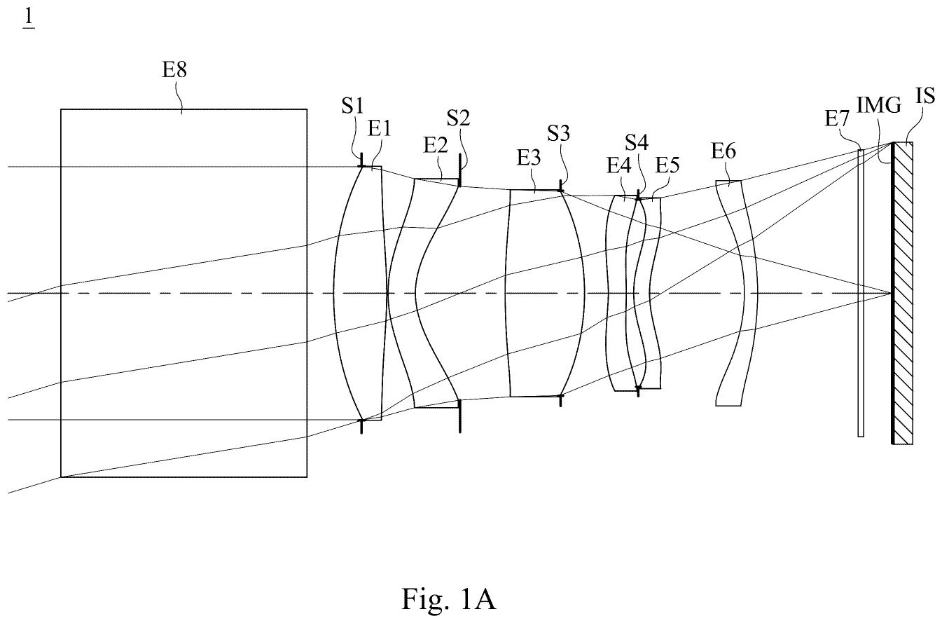

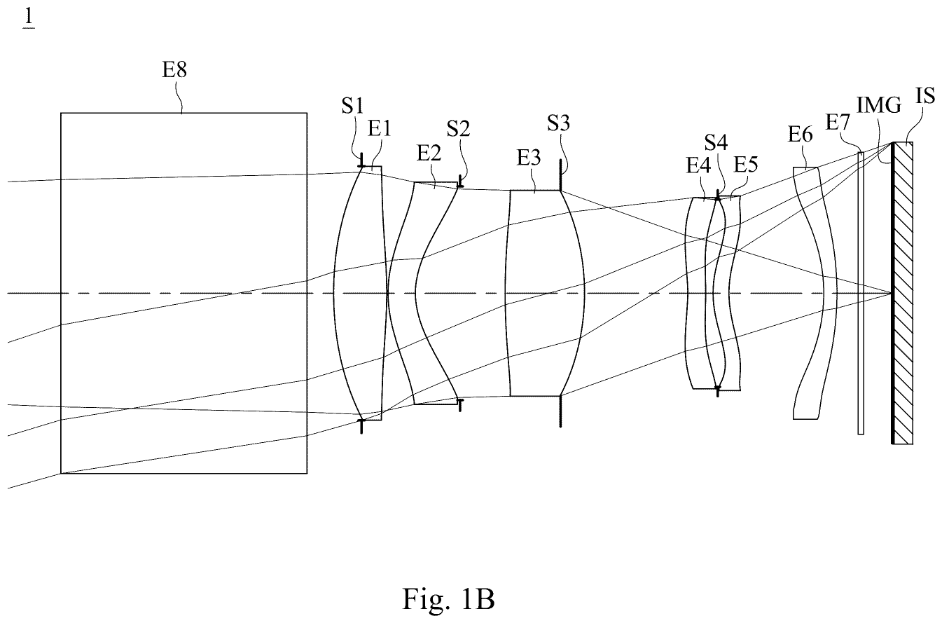

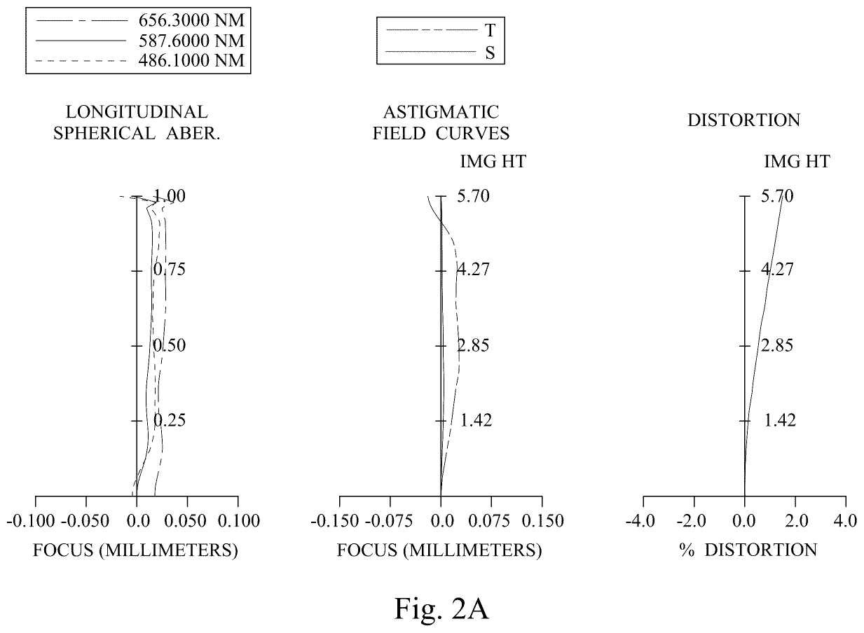

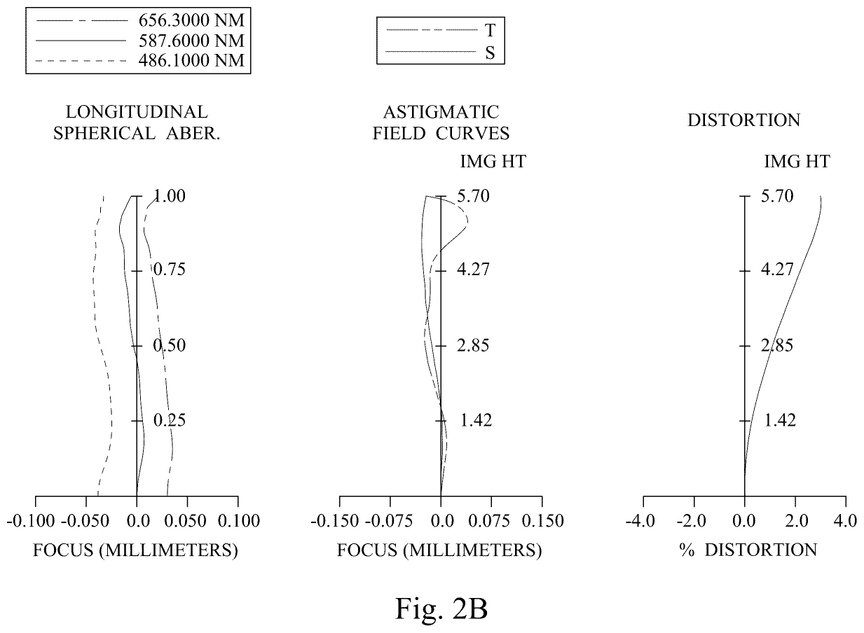

FIG. 1A is a schematic view of an imaging apparatus 1 at the 1st mode according to the 1st embodiment of the present disclosure. FIG. 1B is a schematic view of the imaging apparatus 1 at the 2nd mode according to the 1st embodiment. FIG. 2A shows spherical aberration curves, astigmatic field curves and a distortion curve of the imaging apparatus 1 of FIG. 1A. FIG. 2B shows spherical aberration curves, astigmatic field curves and a distortion curve of the imaging apparatus 1 of FIG. 1B. In FIG. 1A and FIG. 1B, the imaging apparatus 1 includes an optical photographing lens assembly (its reference numeral is omitted) and an image sensor IS. The optical photographing lens assembly includes, in order from an object side to an image side along an optical path, a reflective element E8, a stop S1, a first lens element E1, a second lens element E2, a stop S2, a third lens element E3, a stop S3, a fourth lens element E4, a stop S4, a fifth lens element E5, a sixth lens element E6, a filter E7 and an image surface IMG, wherein the image sensor IS is disposed on the image surface IMG of the optical photographing lens assembly. The optical photographing lens assembly includes six lens elements (E1, E2, E3, E4, E5, E6) without additional one or more lens elements inserted between the first lens element E1 and the sixth lens element E6. Further, the optical photographing lens assembly includes two lens element groups, which are in order from the object side to the image side along the optical path, a first lens element group and a second lens element group. As shown in FIG. 1A and FIG. 1B, according to the 1st embodiment, the first lens element group includes the first lens element E1, the second lens element E2 and the third lens element E3, the second lens element group includes the fourth lens element E4, the fifth lens element E5 and the sixth lens element E6. When the imaged object is moved from infinite to macro, the optical photographing lens assembly is changed from the 1st mode to the 2nd mode. During the focusing movement (that is, the 1st mode is changed to the 2nd mode), the second lens element group is moved towards to the image side along the optical axis relative to the first lens element group; During the focusing movement, all lens elements in each of the lens element groups have no relative movement. Further, at the 1st mode in FIG. 1A, the stop S2 is the aperture stop in the optical photographing lens assembly; at the 2nd mode in FIG. 1B, the stop S3 is the aperture stop in the optical photographing lens assembly.

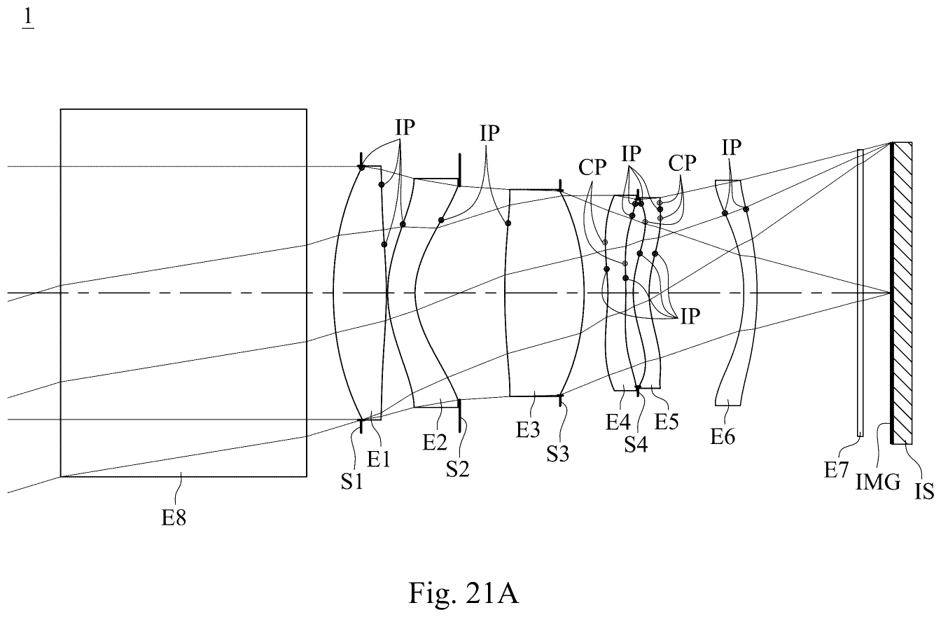

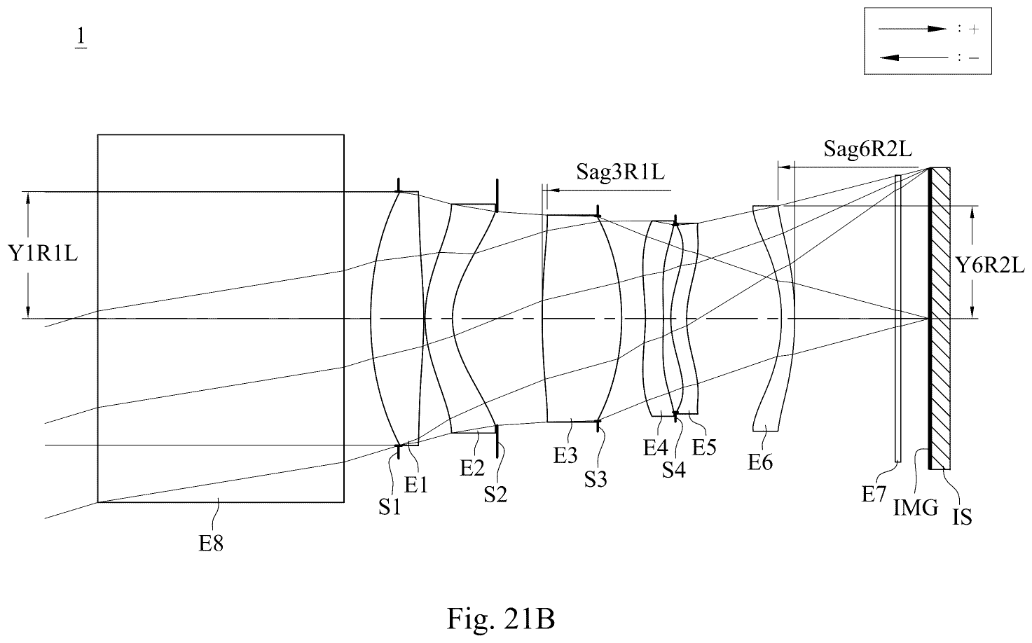

The first lens element E1 with positive refractive power has an object-side surface being convex in a paraxial region thereof and an image-side surface being convex in a paraxial region thereof. The first lens element E1 is made of glass material, and has the object-side surface and the image-side surface being both aspheric. Furthermore, FIG. 21A is a schematic view of the inflection points IP and the critical points CP of each lens element at the 1st mode of FIG. 1A according to the 1st embodiment. In FIG. 21A, the object-side surface of the first lens element E1 includes one inflection point IP, and the image-side surface of the first lens element E1 includes two inflection points IP.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Furthermore, the object-side surface of the second lens element E2 includes one inflection point IP (as shown in FIG. 21A), the image-side surface of the second lens element E2 includes one inflection point IP (as shown in FIG. 21A).

The third lens element E3 with positive refractive power has an object-side surface being convex in a paraxial region thereof and an image-side surface being convex in a paraxial region thereof. The third lens element E3 is made of plastic material, and has the object-side surface and the image-side surface being both aspheric. Furthermore, the object-side surface of the third lens element E3 includes one inflection point IP (as shown in FIG. 21A).

The fourth lens element E4 with negative refractive power has an object-side surface being concave in a paraxial region thereof and an image-side surface being convex in a paraxial region thereof. The fourth lens element E4 is made of plastic material, and has the object-side surface and the image-side surface being both aspheric. Furthermore, the object-side surface of the fourth lens element E4 includes one inflection point IP (as shown in FIG. 21A) and a convex critical point CP (as shown in FIG. 21A), and the image-side surface of the fourth lens element E4 includes three inflection points IP (as shown in FIG. 21A) and a concave critical point CP (as shown in FIG. 21A).

The fifth lens element E5 with positive refractive power has an object-side surface being convex in a paraxial region thereof and an image-side surface being concave in a paraxial region thereof. The fifth lens element E5 is made of plastic material, and has the object-side surface and the image-side surface being both aspheric. Furthermore, the object-side surface of the fifth lens element E5 includes two inflection points IP (as shown in FIG. 21A) and a concave critical point CP (as shown in FIG. 21A), and the image-side surface of the fifth lens element E5 includes two inflection points IP (as shown in FIG. 21A) and one convex critical point CP and one concave critical point CP (as shown in FIG. 21A).

The sixth lens element E6 with negative refractive power has an object-side surface being concave in a paraxial region thereof and an image-side surface being convex in a paraxial region thereof. The sixth lens element E6 is made of plastic material, and has the object-side surface and the image-side surface being both aspheric. Furthermore, the object-side surface of the sixth lens element E6 includes one inflection point IP (as shown in FIG. 21A), and the image-side surface of the sixth lens element E6 includes one inflection point IP (as shown in FIG. 21A).

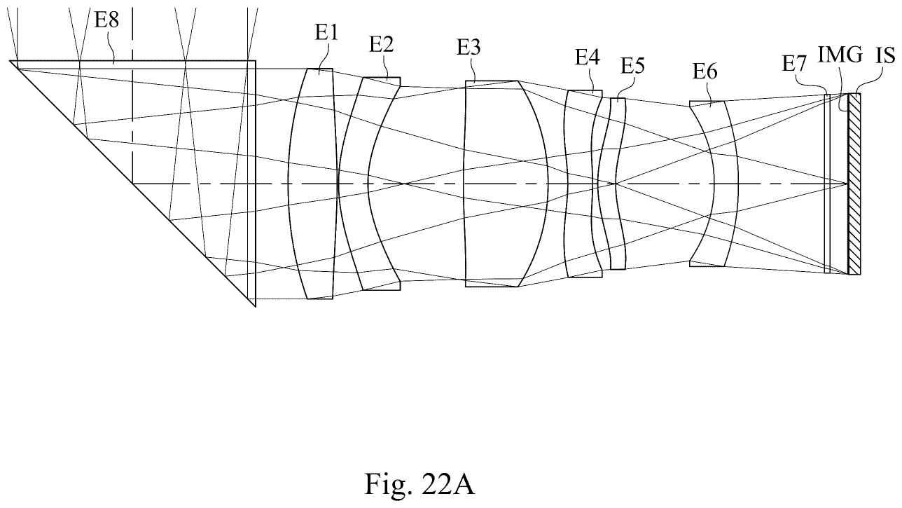

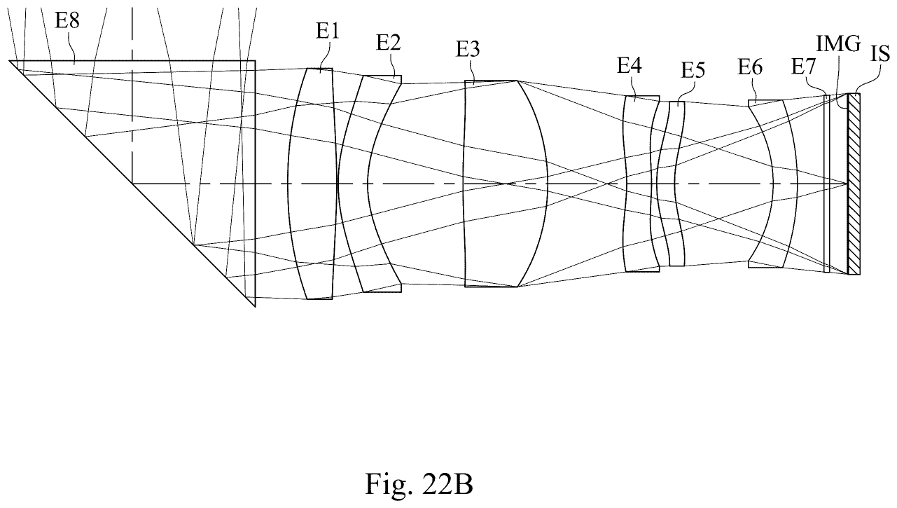

According to the 1st embodiment, the reflective element E8 is disposed between the imaged object and the first lens element E1, that is, the reflective element E8 is at the most object side of the optical photographing lens assembly, wherein, according to the 1st embodiment, the reflective element E8 is a prism, which is made of glass material. Furthermore, FIG. 22A and FIG. 22B are schematic views of the imaging apparatus 1 with another reflective element E8 at the 1st mode and the 2nd mode according to the 1st embodiment, respectively. In FIG. 22A and FIG. 22B, the reflective element E8 is a prism which can fold the optical path, but the present disclosure will not be limited thereto.

The filter E7 is made of glass material, which is located between the sixth lens element E6 and the image surface IMG in order, and will not affect the focal length of the optical photographing lens assembly.

The equation of the aspheric surface profiles of the aforementioned lens elements of the 1st embodiment is expressed as follows:

$$X ( Y ) = ( {Y}^{2} / R ) / ( 1 + sqrt ( 1 - ( 1 + k ) \times {( Y / R )}^{2} ) ) + {\sum }_{i} ( Ai ) \times ( {Y}^{i} ) ,$$

where,
X is the displacement in parallel with an optical axis from the intersection point of the aspheric surface and the optical axis to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient.

The detailed optical data of the 1st embodiment are shown in Table 1A and the aspheric surface data are shown in Table 1B below.

TABLE 1A
1st Embodiment

| Surface | | | | | | | | Focal |
|---|---|---|---|---|---|---|---|---|
| # | | Curvature Radius | | Thickness | Material | Index | Abbe # | Length |
| 0 | Object | Plano | | D0 | | | | |
| 1 | Prism | Plano | | 9.300 | Glass | 1.785 | 25.7 | — |
| 2 | | Plano | | 2.062 | | | | |
| 3 | Stop | Plano | | −1.055 | | | | |
| 4 | Lens 1 | 12.3749 | ASP | 2.006 | Glass | 1.497 | 81.6 | 14.71 |
| 5 | | −16.9261 | ASP | 0.050 | | | | |
| 6 | Lens 2 | 4.6341 | ASP | 1.033 | Plastic | 1.614 | 25.6 | −17.04 |
| 7 | | 2.9386 | ASP | 1.690 | | | | |
| 8 | Stop | Plano | | 1.701 | | | | |
| 9 | Lens 3 | 24.7502 | ASP | 3.000 | Plastic | 1.544 | 56.0 | 12.29 |
| 10 | | −8.7652 | ASP | −0.905 | | | | |
| 11 | Stop | Plano | | D1 | | | | |
| 12 | Lens 4 | −6.6894 | ASP | 0.677 | Plastic | 1.544 | 56.0 | −26.52 |
| 13 | | −12.9169 | ASP | 0.455 | | | | |
| 14 | Stop | Plano | | −0.176 | | | | |
| 15 | Lens 5 | 3.8553 | ASP | 0.600 | Plastic | 1.544 | 56.0 | 82.94 |
| 16 | | 3.9843 | ASP | 3.582 | | | | |
| 17 | Lens 6 | −6.1650 | ASP | 0.500 | Plastic | 1.544 | 56.0 | −26.54 |
| 18 | | −11.0663 | ASP | D2 | | | | |

| | | | | | | | |
|---|---|---|---|---|---|---|---|
| 19 | Filter | Plano | 0.210 | Glass | 1.517 | 64.2 | — |
| 20 | | Plano | 1.100 | | | | |
| 21 | Image | Plano | — | | | | |

Reference wavelength is 587.6 nm (d-line).
Effective radius of Surface 3 (stop S1) is 4.800 mm.
Effective radius of Surface 8 (stop S2) is 4.036 mm.
Effective radius of Surface 11 (stop S3) is 3.872 mm.
Effective radius of Surface 14 (stop S4) is 3.537 mm.

TABLE 1B
Aspheric Coefficients

| Surface # | 4 | 5 | 6 | 7 |
|---|---|---|---|---|
| k= | 3.94213000E−01 | −2.29694000E+01 | −1.21669000E+00 | −1.46615000E+00 |
| A4= | 5.62358417E−04 | 1.55887535E−03 | −4.51142665E−03 | −5.79391086E−03 |
| A6= | −7.07402433E−05 | −9.42691527E−05 | 3.22565053E−04 | 5.56875029E−04 |
| A8= | 8.67141152E−06 | 1.09973665E−05 | −2.60739934E−05 | −7.44710095E−06 |
| A10= | −5.81495106E−07 | −1.76739834E−06 | 5.37697696E−06 | −1.40946637E−05 |
| A12= | 1.06446189E−08 | 1.82678352E−07 | −1.82823002E−06 | 3.39101561E−06 |
| A14= | 1.23609053E−09 | −1.11626094E−08 | 3.61077193E−07 | −4.78727708E−07 |
| A16= | −9.63508844E−11 | 3.98616366E−10 | −4.32608236E−08 | 4.84393403E−08 |
| A18= | 2.79588727E−12 | −7.73137543E−12 | 3.35678819E−09 | −3.64683722E−09 |
| A20= | −3.08041749E−14 | 6.25589303E−14 | −1.71358392E−10 | 1.98623517E−10 |
| A22= | | | 5.58750453E−12 | −7.29598529E−12 |
| A24= | | | −1.05876308E−13 | 1.59601369E−13 |
| A26= | | | 8.88805670E−16 | −1.55578664E−15 |
| Surface # | 9 | 10 | 12 | 13 |
| k= | 1.90064000E+01 | −5.69847000E−01 | −9.49456000E−01 | 1.13249000E+01 |
| A4= | −3.03132810E−04 | −2.52516994E−05 | 2.38649718E−02 | 2.85409037E−02 |
| A6= | −6.27420928E−05 | −3.09228887E−05 | −6.44390020E−03 | −1.21009614E−02 |
| A8= | 4.28630090E−05 | 1.50718372E−05 | 2.00240074E−03 | 5.91969479E−03 |
| A10= | −2.40953835E−05 | −8.16599256E−06 | −5.69290262E−04 | −2.45251207E−03 |
| A12= | 8.86832010E−06 | 2.79424405E−06 | 1.33766093E−04 | 7.90018627E−04 |
| A14= | −2.23101321E−06 | −6.08086550E−07 | −2.44547248E−05 | −1.91148418E−04 |
| A16= | 3.90528273E−07 | 8.66850632E−08 | 3.35517967E−06 | 3.42216058E−05 |
| A18= | −4.79390876E−08 | −8.21469964E−09 | −3.36530082E−07 | −4.48276069E−06 |
| A20= | 4.10789611E−09 | 5.13384190E−10 | 2.40020983E−08 | 4.22691630E−07 |
| A22= | −2.40519431E−10 | −2.03458570E−11 | −1.16986341E−09 | −2.78752257E−08 |
| A24= | 9.16666065E−12 | 4.63622455E−13 | 3.64361361E−11 | 1.21891484E−09 |
| A26= | −2.04856488E−13 | −4.62867567E−15 | −6.36707444E−13 | −3.17367656E−11 |
| A28= | 2.03618534E−15 | | 4.51291939E−15 | 3.72467132E−13 |
| Surface # | 15 | 16 | 17 | 18 |
| k= | −7.67834000E−01 | −3.05128000E−02 | −7.17388000E−01 | 4.01958000E+00 |
| A4= | −3.82521685E−03 | −1.33569854E−02 | 8.90104950E−04 | 1.17185728E−03 |
| A6= | −7.46265675E−03 | −4.98382178E−04 | 3.23964993E−05 | 1.42232783E−04 |
| A8= | 5.24185385E−03 | 1.08255689E−03 | −1.93798068E−04 | −1.70488766E−04 |
| A10= | −2.57265768E−03 | −7.22546474E−04 | 9.85675815E−05 | 6.49044353E−05 |
| A12= | 9.11713020E−04 | 2.96901916E−04 | −2.93431188E−05 | −1.48505751E−05 |
| A14= | −2.33855835E−04 | −8.19250836E−05 | 6.09380167E−06 | 2.32308408E−06 |
| A16= | 4.34406918E−05 | 1.56829201E−05 | −9.20186945E−07 | −2.56884509E−07 |
| A18= | −5.82362805E−06 | −2.10885464E−06 | 1.02134081E−07 | 2.01929744E−08 |
| A20= | 5.56718298E−07 | 1.98593819E−07 | −8.30179673E−09 | −1.11611056E−09 |
| A22= | −3.69669714E−08 | −1.28286442E−08 | 4.86939583E−10 | 4.21798138E−11 |
| A24= | 1.61881402E−09 | 5.41749827E−10 | −2.00244428E−11 | −1.03217357E−12 |
| A26= | −4.20058373E−11 | −1.34745489E−11 | 5.47221595E−13 | 1.46535447E−14 |
| A28= | 4.88858120E−13 | 1.49668066E−13 | −8.92111564E−15 | −9.10468244E−17 |
| A30= | | | 6.56360470E−17 | |

In Table 1A, the curvature radius, the thickness and the focal length are shown in millimeters (mm). Surface numbers 0-21 represent the surfaces sequentially arranged from the object side to the image side along the optical axis. In Table 1B, k represents the conic coefficient of the equation of the aspheric surface profiles. A4-A30 represent the aspheric coefficients ranging from the 4th order to the 30th order. The tables presented below for each embodiment correspond to schematic parameter and aberration curves of each embodiment, and term definitions of the tables are the same as those in Table 1A and Table 1B of the 1st embodiment. Therefore, an explanation in this regard will not be provided again.

FIG. 1A represents the optical photographing lens assembly of the 1st embodiment at the 1st mode, which is the status of the optical photographing lens assembly when the imaged object is at infinite; FIG. 1B represents the optical photographing lens assembly of the 1st embodiment at the 2nd mode, which is the status of the optical photographing lens assembly when the object distance is less than 200 mm (that is, the object distance being macro in the present disclosure). The object distance is an axial distance between the imaged object and the object-side surface of the lens element closest to the object side of the optical photographing lens assembly (that is, the first lens element E1). Please refer to Table 1A, the object distances and the data of D0, D1 and D2 in Table 1A of the 1st embodiment at the 1st mode and the 2nd mode are listed in Table 1C as below.

TABLE 1C
1st Embodiment

| | 1st mode | | 2nd mode |
|---|---|---|---|
| Object distance (mm) | infinite | Object distance (mm) | 120.207 |
| D0 (mm) | infinite | D0 (mm) | 109.900 |
| D1 (mm) | 1.806 | D1 (mm) | 4.806 |
| D2 (mm) | 3.800 | D2 (mm) | 0.800 |

In the optical photographing lens assembly at the 1st mode in FIG. 1A according to the 1st embodiment, when a focal length of the optical photographing lens assembly at the object distance being infinite is fL, an f-number of the optical photographing lens assembly at the object distance being infinite is FnoL, half of a maximum field of view of the optical photographing lens assembly at the object distance being infinite is HFOVL, and the maximum field of view of the optical photographing lens assembly at the object distance being infinite is FOVL, these parameters have the following values: fL=18.58 mm; FnoL=1.94; HFOVL=16.8 degrees; and FOVL=33.6 degrees.

In the optical photographing lens assembly at the 2nd mode in FIG. 1B according to the 1st embodiment, when a focal length of the optical photographing lens assembly at the object distance being macro is fS, an f-number of the optical photographing lens assembly at the object distance being macro is FnoS, half of a maximum field of view of the optical photographing lens assembly at the object distance being macro is HFOVS, and the maximum field of view of the optical photographing lens assembly at the object distance being macro is FOVS, these parameters have the following values: fS=14.26 mm; FnoS=1.88; HFOVS=16.7 degrees; and FOVS=33.4 degrees.

In the optical photographing lens assembly according to the 1st embodiment, when an axial distance between the object-side surface of the first lens element E1 and the image surface IMG of the optical photographing lens assembly at the object distance being infinite is TLL, and an axial distance between the object-side surface of the first lens element E1 and the image surface IMG of the optical photographing lens assembly at the object distance being macro is TLS, the following conditions are satisfied: TLL/TLS=1.00.

In the optical photographing lens assembly according to the 1st embodiment, when an axial distance between an image-side surface of a lens element closet to the image side (that is, the sixth lens element E6) and the image surface IMG of the optical photographing lens assembly at the object distance being infinite is BLL, and an axial distance between the image-side surface of the lens element closet to the image side (that is, the sixth lens element E6) and the image surface IMG of the optical photographing lens assembly at the object distance being macro is BLS, the following condition is satisfied: BLL/BLS=2.42.

In the optical photographing lens assembly according to the 1st embodiment, when an axial distance between the first lens element group and the second lens element group of the optical photographing lens assembly at the object distance being infinite is TG1G2L, and an axial distance between the first lens element group and the second lens element group of the optical photographing lens assembly at the object distance being macro is TG1G2S, the following condition is satisfied: (TG1G2S−TG1G2L)/TG1G2L=3.33.

In the optical photographing lens assembly according to the 1st embodiment, when the axial distance between the image-side surface of the lens element closet to the image side (that is, the sixth lens element E6) and the image surface IMG of the optical photographing lens assembly at the object distance being infinite is BLL, and a maximum image height of the optical photographing lens assembly is ImgH, the following condition is satisfied: BLL/ImgH=0.90.

In the optical photographing lens assembly according to the 1st embodiment, when a focal length of the third lens element E3 is f3, a focal length of the fifth lens element E5 is f5, and a focal length of the sixth lens element E6 is f6, the following conditions are satisfied: |f3/f6|=0.46; and |f3/f5|=0.15.

In the optical photographing lens assembly according to the 1st embodiment, when a focal length of the second lens element E2 is f2, a curvature radius of the object-side surface of the second lens element E2 is R3, and a curvature radius of the image-side surface of the second lens element E2 is R4, the following condition is satisfied: |f2/R3|+|f2/R4|=9.47.

In the optical photographing lens assembly according to the 1st embodiment, when the axial distance between the object-side surface of the first lens element E1 and the image surface IMG of the optical photographing lens assembly at the object distance being infinite is TLL, an axial distance between the object-side surface of the first lens element E1 and the image-side surface of the third lens element E3 of the optical photographing lens assembly at the object distance being infinite is Dr1r6L, and an axial distance between the object-side surface of the fourth lens element E4 and the image-side surface of the sixth lens element E6 of the optical photographing lens assembly at the object distance being infinite is Dr7r12L, the following conditions are satisfied: TLL/Dr1r6L=2.23; and Dr1r6L/Dr7r12L=1.68.

In the optical photographing lens assembly according to the 1st embodiment, when a central thickness of the first lens element E1 is CT1, a central thickness of the second lens element E2 is CT2, a central thickness of the third lens element E3 is CT3, and an axial distance between the second lens element E2 and the third lens element E3 of the optical photographing lens assembly at the object distance being infinite is T23L, the following conditions are satisfied: CT1/T23L=0.59; CT1/CT3=0.67; and CT2/CT3=0.34.

In the optical photographing lens assembly according to the 1st embodiment, when the central thickness of the third lens element E3 is CT3, the central thickness of the fourth lens element E4 is CT4, the central thickness of the fifth lens element E5 is CT5, and an axial distance between the fourth lens element E4 and the fifth lens element E5 of the optical photographing lens assembly at the object distance being infinite is T45L, the following condition is satisfied: CT3/(CT4+T45L+CT5)=1.93.

In the optical photographing lens assembly according to the 1st embodiment, when the central thickness of the fourth lens element E4 is CT4, and an axial distance between the second lens element E2 and the third lens element E3 of the optical photographing lens assembly at the object distance being infinite is T23L, the following condition is satisfied: CT4/T23L=0.20.

In the optical photographing lens assembly according to the 1st embodiment, when the central thickness of the fourth lens element E4 is CT4, the central thickness of the fifth lens element E5 is CT5, and an axial distance between the fifth lens element E5 and the sixth lens element E6 of the optical photographing lens assembly at the object distance being infinite is T56L, the following condition is satisfied: (CT4+CT5)/T56L=0.36.

In the optical photographing lens assembly according to the 1st embodiment, when a central thickness of the sixth lens element E6 is CT6, and the axial distance between the fifth lens element E5 and the sixth lens element E6 of the optical photographing lens assembly at the object distance being infinite is T56L, the following condition is satisfied: CT6/T56L=0.14.

In the optical photographing lens assembly according to the 1st embodiment, when the axial distance between the second lens element E2 and the third lens element E3 of the optical photographing lens assembly at the object distance being infinite is T23L, and the axial distance between the fourth lens element E4 and the fifth lens element E5 of the optical photographing lens assembly at the object distance being infinite is T45L, the following condition is satisfied: T45L/T23L=0.08.

In the optical photographing lens assembly according to the 1st embodiment, when a curvature radius of the image-side surface of the first lens element E1 is R2, the curvature radius of the object-side surface of the second lens element E2 is R3, and the curvature radius of the image-side surface of the second lens element E2 is R4, the following conditions are satisfied: (R2+R3)/(R2−R3)=0.57; and (R3−R4)/(R3+R4)=0.22.

In the optical photographing lens assembly according to the 1st embodiment, when a curvature radius of the object-side surface of the third lens element E3 is R5, and a curvature radius of the image-side surface of the third lens element E3 is R6, the following condition is satisfied: (R5+R6)/(R5−R6)=0.48.

In the optical photographing lens assembly according to the 1st embodiment, when a curvature radius of the object-side surface of the first lens element E1 is R1, and the curvature radius of the image-side surface of the second lens element E2 is R4, the following condition is satisfied: R4/R1=0.24.

In the optical photographing lens assembly according to the 1st embodiment, when an Abbe number of the fourth lens element E4 is V4, and an Abbe number of the sixth lens element E6 is V6, the following condition is satisfied: V4+V6=112.0.

FIG. 21B is a schematic view of partial parameters of the optical photographing lens assembly under the 1st mode according to the 1st embodiment of FIG. 1A. In FIG. 21B, when a displacement in parallel with an optical axis from an axial vertex on the object-side surface of the third lens element E3 to a maximum effective radius position on the object-side surface of the third lens element E3 of the optical photographing lens assembly at the object distance being infinite is Sag3R1L, and the central thickness of the third lens element E3 is CT3, the following condition is satisfied: |Sag3R1L|/CT3=0.06.

In the optical photographing lens assembly according to the 1st embodiment, when a displacement in parallel with the optical axis from an axial vertex on the image-side surface of the sixth lens element E6 to a maximum effective radius position on the image-side surface of the sixth lens element E6 of the optical photographing lens assembly at the object distance being infinite is Sag6R2L (as shown in FIG. 21B), and a central thickness of the sixth lens element E6 is CT6, the following condition is satisfied: |Sag6R2L|/CT6=1.26.

In the optical photographing lens assembly according to the 1st embodiment, when a maximum effective radius position of the object-side surface of the first lens element E1 of the optical photographing lens assembly at the object distance being infinite is Y1R1L, and a maximum effective radius position of the image-side surface of the sixth lens element E6 of the optical photographing lens assembly at the object distance being infinite is Y6R2L, the following condition is satisfied: Y1R1L/Y6R2L=1.13.

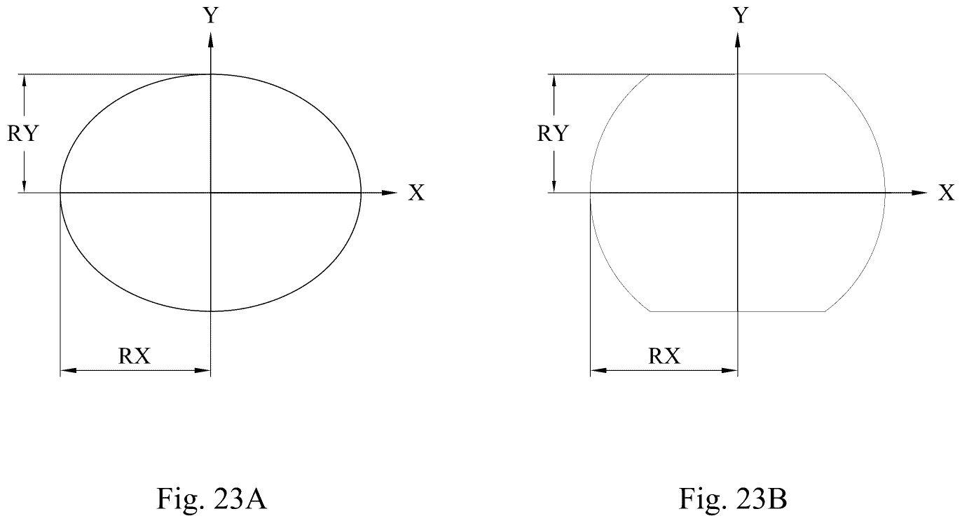

Moreover, FIG. 23A and FIG. 23B are schematic views of any one of the stops S1, S2, S3, S4 with different non-circular shapes according to the 1st embodiment of FIG. 1A. In FIG. 23A, any one of the stops S1, S2, S3, S4 has fixed shape being elliptical, which has a major axis and a minor axis, wherein the major axis extends along a direction X, and the minor axis extends along a direction Y, and the elliptical shape has a minor axis effective radius RY and a major axis effective radius RX. In FIG. 23B, any one of the stops S1, S2, S3, S4 has fixed shape. The difference with the disclosure in FIG. 23A is, the stop in FIG. 23B is an elliptical shape with two cutting sides relative to each other along the direction X (which is the direction of the major axis), which also has a minor axis effective radius RY and a major axis effective radius RX. It should be noted that the stop of the present disclosure will not be limited to the disclosure in FIG. 23A and FIG. 23B.

### 2nd Embodiment

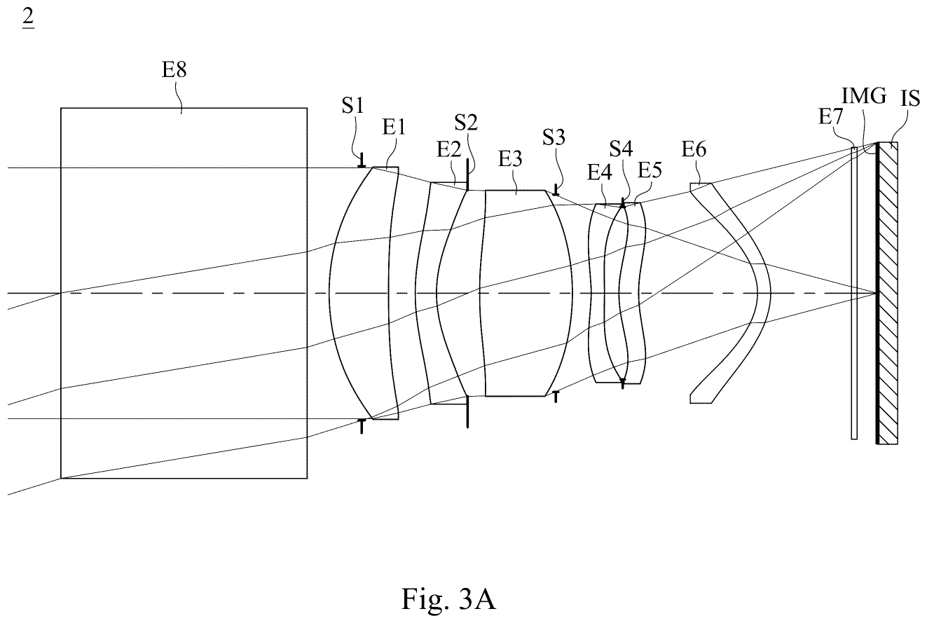

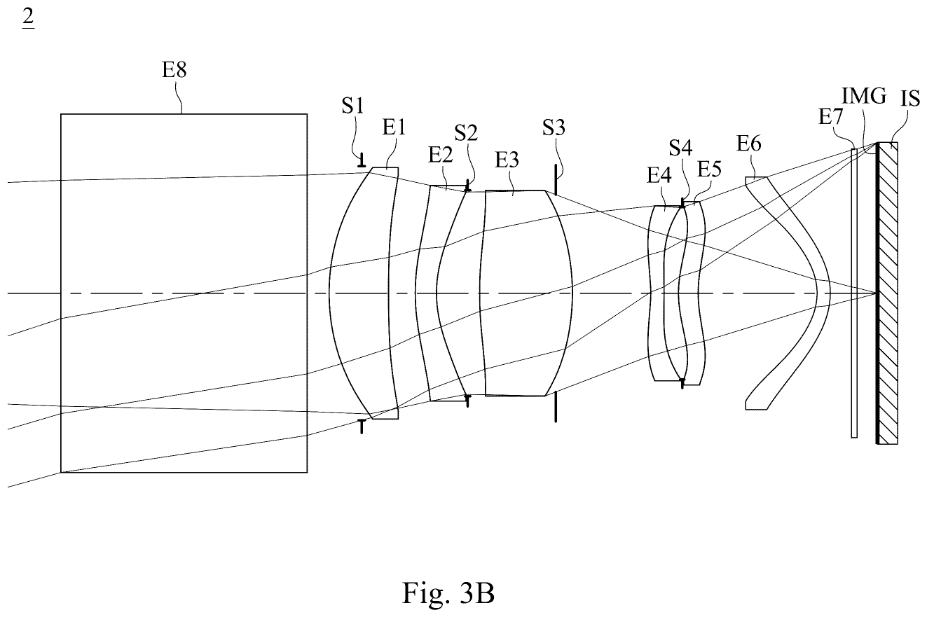

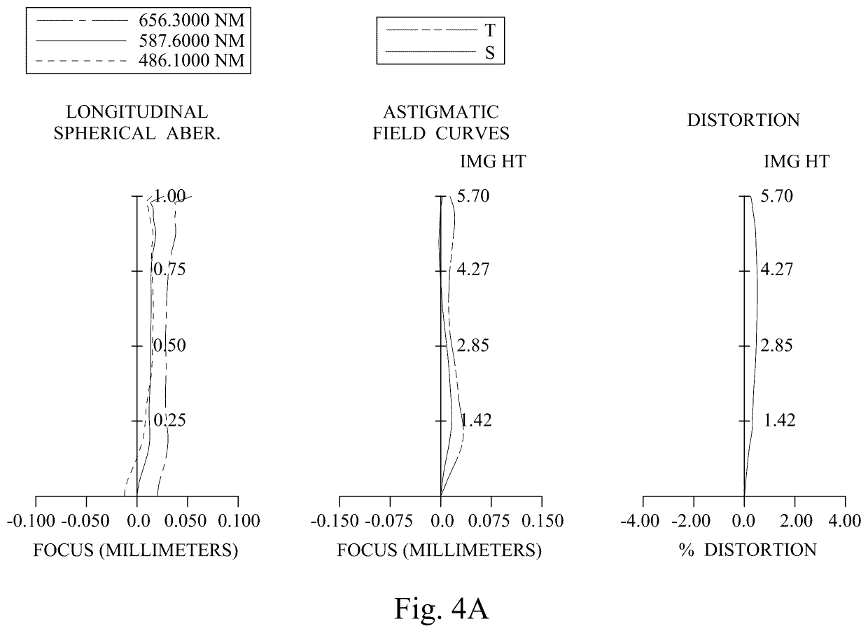

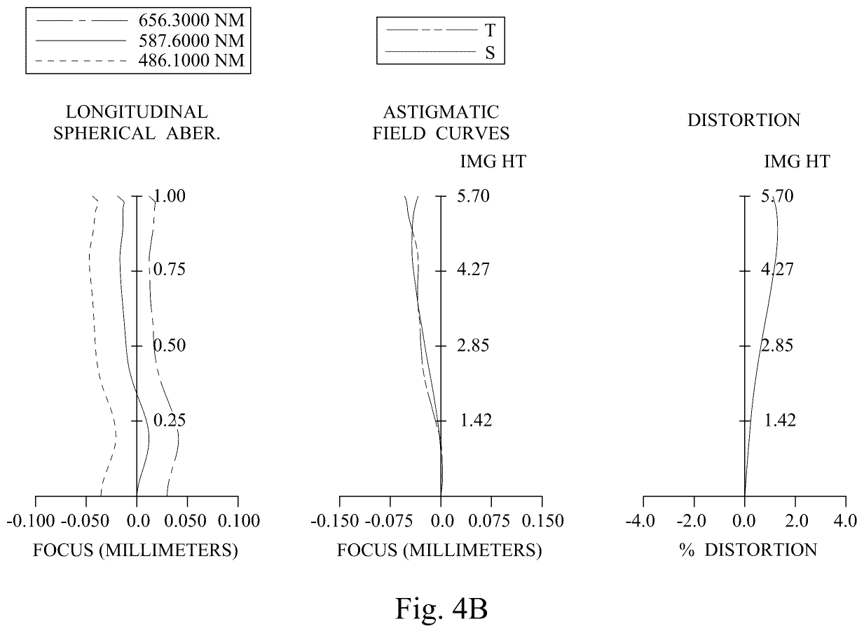

FIG. 3A is a schematic view of an imaging apparatus 2 at the 1st mode according to the 2nd embodiment of the present disclosure. FIG. 3B is a schematic view of the imaging apparatus 2 at the 2nd mode according to the 2nd embodiment. FIG. 4A shows spherical aberration curves, astigmatic field curves and a distortion curve of the imaging apparatus 2 of FIG. 3A. FIG. 4B shows spherical aberration curves, astigmatic field curves and a distortion curve of the imaging apparatus 2 of FIG. 3B. In FIG. 3A and FIG. 3B, the imaging apparatus 2 includes an optical photographing lens assembly (its reference numeral is omitted) and an image sensor IS. The optical photographing lens assembly includes, in order from an object side to an image side along an optical path, a reflective element E8, a stop S1, a first lens element E1, a second lens element E2, a stop S2, a third lens element E3, a stop S3, a fourth lens element E4, a stop S4, a fifth lens element E5, a sixth lens element E6, a filter E7 and an image surface IMG, wherein the image sensor IS is disposed on the image surface IMG of the optical photographing lens assembly. The optical photographing lens assembly includes six lens elements (E1, E2, E3, E4, E5, E6) without additional one or more lens elements inserted between the first lens element E1 and the sixth lens element E6. Further, the optical photographing lens assembly includes two lens element groups, which are in order from the object side to the image side along the optical path, a first lens element group and a second lens element group. As shown in FIG. 3A and FIG. 3B, according to the 2nd embodiment, the first lens element group includes the first lens element E1, the second lens element E2 and the third lens element E3, the second lens element group includes the fourth lens element E4, the fifth lens element E5 and the sixth lens element E6. When the imaged object is moved from infinite to macro, the optical photographing lens assembly is changed from the 1st mode to the 2nd mode. During the focusing movement (that is, the 1st mode is changed to the 2nd mode), the second lens element group is moved towards to the image side along the optical axis relative to the first lens element group; during the focusing movement, all lens elements in each of the lens element groups have no relative movement. Further, at the 1st mode in FIG. 3A, the stop S2 is the aperture stop in the optical photographing lens assembly; at the 2nd mode in FIG. 3B, the stop S3 is the aperture stop in the optical photographing lens assembly.

The first lens element E1 with positive refractive power has an object-side surface being convex in a paraxial region thereof and an image-side surface being concave in a paraxial region thereof. The first lens element E1 is made of glass material, and has the object-side surface and the image-side surface being both aspheric. Furthermore, the object-side surface of the first lens element includes one inflection point, and the image-side surface of the first lens element includes one inflection point.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Furthermore, the object-side surface of the second lens element includes two inflection points.

The third lens element E3 with positive refractive power has an object-side surface being convex in a paraxial region thereof and an image-side surface being convex in a paraxial region thereof. The third lens element E3 is made of plastic material, and has the object-side surface and the image-side surface being both aspheric. Furthermore, the object-side surface of the third lens element E3 includes one inflection point and a concave critical point.

The fourth lens element E4 with negative refractive power has an object-side surface being concave in a paraxial region thereof and an image-side surface being convex in a paraxial region thereof. The fourth lens element E4 is made of plastic material, and has the object-side surface and the image-side surface being both aspheric. Furthermore, the object-side surface of the fourth lens element E4 includes one inflection point and a convex critical point, and the image-side surface of the fourth lens element E4 includes one inflection point and a concave critical point.

The fifth lens element E5 with positive refractive power has an object-side surface being convex in a paraxial region thereof and an image-side surface being concave in a paraxial region thereof. The fifth lens element E5 is made of plastic material, and has the object-side surface and the image-side surface being both aspheric. Furthermore, the object-side surface of the fifth lens element includes two inflection points and a concave critical point, and the image-side surface of the fifth lens element E5 includes two inflection points and one convex critical point.

The sixth lens element E6 with negative refractive power has an object-side surface being concave in a paraxial region thereof and an image-side surface being convex in a paraxial region thereof. The sixth lens element E6 is made of plastic material, and has the object-side surface and the image-side surface being both aspheric. Furthermore, the object-side surface of the sixth lens element E6 includes one inflection point, and the image-side surface of the sixth lens element E6 includes one inflection point.

According to the 2nd embodiment, the reflective element E8 is disposed between the imaged object and the first lens element E1, that is, the reflective element E8 is at the most object side of the optical photographing lens assembly, wherein, according to the 2nd embodiment, the reflective element E8 is a prism, which is made of glass material.

The filter E7 is made of glass material, which is located between the sixth lens element E6 and the image surface IMG in order, and will not affect the focal length of the optical photographing lens assembly.

The detailed optical data of the 2nd embodiment are shown in Table 2A and the aspheric surface data are shown in Table 2B below.

TABLE 2A
2nd Embodiment

| Surface | | | | | | | | Focal |
|---|---|---|---|---|---|---|---|---|
| # | | Curvature Radius | | Thickness | Material | Index | Abbe # | Length |
| 0 | Object | Plano | | D0 | | | | |
| 1 | Prism | Plano | | 9.300 | Glass | 1.785 | 25.7 | — |
| 2 | | Plano | | 2.062 | | | | |
| 3 | Stop | Plano | | −1.231 | | | | |
| 4 | Lens 1 | 7.7813 | ASP | 2.243 | Glass | 1.497 | 81.6 | 18.37 |
| 5 | | 47.6190 | ASP | 1.010 | | | | |
| 6 | Lens 2 | 7.5097 | ASP | 0.802 | Plastic | 1.639 | 23.5 | −20.09 |
| 7 | | 4.5400 | ASP | 1.179 | | | | |
| 8 | Stop | Plano | | 0.454 | | | | |
| 9 | Lens 3 | 15.3487 | ASP | 3.500 | Plastic | 1.544 | 56.0 | 10.62 |
| 10 | | −8.5155 | ASP | −0.626 | | | | |
| 11 | Stop | Plano | | D1 | | | | |
| 12 | Lens 4 | −5.7448 | ASP | 0.502 | Plastic | 1.534 | 56.0 | −16.23 |
| 13 | | −17.5488 | ASP | 0.688 | | | | |
| 14 | Stop | Plano | | −0.144 | | | | |
| 15 | Lens 5 | 4.2445 | ASP | 0.745 | Plastic | 1.566 | 37.4 | 37.60 |
| 16 | | 4.9656 | ASP | 4.489 | | | | |
| 17 | Lens 6 | −2.2315 | ASP | 0.500 | Plastic | 1.544 | 56.0 | −33.72 |
| 18 | | −2.7411 | ASP | D2 | | | | |

| | | | | | | | |
|---|---|---|---|---|---|---|---|
| 19 | Filter | Plano | 0.210 | Glass | 1.517 | 64.2 | — |
| 20 | | Plano | 0.775 | | | | |
| 21 | Image | Plano | — | | | | |

Reference wavelength is 587.6 nm (d-line).
Effective radius of Surface 3 (stop S1) is 4.800 mm.
Effective radius of Surface 8 (stop S2) is 3.891 mm.
Effective radius of Surface 11 (stop S3) is 3.727 mm.
Effective radius of Surface 14 (stop S4) is 3.256 mm.

TABLE 2B
Aspheric Coefficients

| Surface # | 4 | 5 | 6 | 7 |
|---|---|---|---|---|
| k= | −1.14463000E−01 | −4.92326000E+01 | −1.53217000E−01 | −1.15867000E+00 |
| A4= | 9.94393968E−05 | 5.19525109E−04 | −3.53910834E−03 | −3.88632707E−03 |
| A6= | 1.04458150E−05 | 1.40463632E−04 | 3.85036656E−04 | 4.88769371E−04 |
| A8= | 1.23870989E−06 | −3.41908537E−05 | −5.82808046E−05 | −9.80912977E−05 |
| A10= | −5.48621806E−07 | 4.32367160E−06 | −1.60711643E−06 | 8.25156905E−06 |
| A12= | 7.57135909E−08 | −3.47492470E−07 | 2.50142879E−06 | 1.03892493E−06 |
| A14= | −5.61180717E−09 | 1.78104631E−08 | −5.37819717E−07 | −3.98327662E−07 |
| A16= | 2.35573611E−10 | −5.58428973E−10 | 6.56089529E−08 | 5.63883912E−08 |
| A18= | −5.28795863E−12 | 9.59821241E−12 | −5.17412457E−09 | −4.58710473E−09 |
| A20= | 4.89490696E−14 | −6.79051498E−14 | 2.68697857E−10 | 2.21699044E−10 |
| A22= | | | −8.89643016E−12 | −5.79569650E−12 |
| A24= | | | 1.70522706E−13 | 5.54829236E−14 |
| A26= | | | −1.44128459E−15 | 3.07983254E−16 |
| Surface # | 9 | 10 | 12 | 13 |
| k= | −6.44451000E+00 | 3.98399000E−02 | −2.54172000E+00 | 9.78201000E+00 |
| A4= | −7.47733955E−04 | 6.09738921E−05 | 2.81152318E−02 | 2.38501377E−02 |
| A6= | 1.32156873E−04 | −3.13841705E−04 | −8.78875518E−03 | −7.85390544E−03 |
| A8= | −1.16057558E−04 | 1.76088357E−04 | 3.28257482E−03 | 3.58954831E−03 |
| A10= | 5.75430334E−05 | −6.35081905E−05 | −1.06903892E−03 | −1.43871423E−03 |
| A12= | −1.97399042E−05 | 1.52626713E−05 | 2.70776741E−04 | 4.65069612E−04 |
| A14= | 4.68254157E−06 | −2.54335223E−06 | −5.17114372E−05 | −1.18621382E−04 |
| A16= | −7.78922758E−07 | 2.98667829E−07 | 7.36385188E−06 | 2.33608971E−05 |
| A18= | 9.15355300E−08 | −2.46579476E−08 | −7.72343829E−07 | −3.46283435E−06 |
| A20= | −7.55590074E−09 | 1.40047666E−09 | 5.83995444E−08 | 3.75302190E−07 |
| A22= | 4.28223766E−10 | −5.20721435E−11 | −3.06716018E−09 | −2.86425784E−08 |
| A24= | −1.58538369E−11 | 1.14049092E−12 | 1.04794614E−10 | 1.45164531E−09 |
| A26= | 3.45068156E−13 | −1.11492257E−14 | −2.05244121E−12 | −4.37422737E−11 |
| A28= | −3.34654480E−15 | | 1.68493744E−14 | 5.92301339E−13 |
| Surface # | 15 | 16 | 17 | 18 |
| k= | −8.67928000E−01 | 3.21380000E−01 | −1.20370000E+00 | −8.99999000E−01 |
| A4= | −1.28482070E−02 | −1.32025451E−02 | 2.87724787E−03 | 6.52479504E−03 |
| A6= | 1.45659988E−04 | 3.60014285E−04 | −1.63909644E−03 | −2.13492823E−03 |
| A8= | 2.39806659E−04 | 2.14771171E−04 | 6.75332025E−04 | 9.53083872E−04 |
| A10= | −5.18532270E−05 | −1.89216437E−04 | −8.35472845E−05 | −2.54129724E−04 |
| A12= | −4.50041684E−06 | 9.45935492E−05 | −3.74712214E−05 | 4.17180539E−05 |
| A14= | 4.34697750E−06 | −3.18791232E−05 | 2.03202000E−05 | −4.11743508E−06 |
| A16= | −1.02573361E−06 | 7.36016183E−06 | −4.86808036E−06 | 1.91746502E−07 |
| A18= | 1.33421298E−07 | −1.17520059E−06 | 7.26495710E−07 | 5.86776688E−09 |
| A20= | −9.99708390E−09 | 1.29685389E−07 | −7.30922357E−08 | −1.52782695E−09 |
| A22= | 3.33079230E−10 | −9.71450046E−09 | 5.05536566E−09 | 1.06936064E−10 |
| A24= | 7.33430468E−12 | 4.71740100E−10 | −2.37514863E−10 | −3.98083438E−12 |
| A26= | −9.99611446E−13 | −1.33969796E−11 | 7.24866629E−12 | 7.95411903E−14 |
| A28= | 2.46365346E−14 | 1.68859380E−13 | −1.29615305E−13 | −6.72624233E−16 |
| A30= | | | 1.03012149E−15 | |

Please refer to Table 2A, the object distances and the data of DO, D1 and D2 in Table 2A of the 2nd embodiment at the 1st mode and the 2nd mode are listed in Table 2C as below.

TABLE 2C
2nd Embodiment

| | 1st mode | | 2nd mode |
|---|---|---|---|
| Object distance (mm) | infinite | Object distance (mm) | 120.031 |
| D0 (mm) | infinite | D0 (mm) | 109.900 |
| D1 (mm) | 1.337 | D1 (mm) | 3.587 |
| D2 (mm) | 3.050 | D2 (mm) | 0.800 |

In the 2nd embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 2nd embodiment, so an explanation in this regard will not be provided again.

Moreover, these parameters can be calculated from Table 2A, Table 2B and Table 2C as the following values and satisfy the following conditions in Table 2D:

TABLE 2D
2nd Embodiment

| | | | |
|---|---|---|---|
| fL [mm] | 18.40 | CT1/T23L | 1.37 |
| FnoL | 1.94 | CT1/CT3 | 0.64 |
| HFOVL [deg.] | 17.1 | CT2/CT3 | 0.23 |
| FOVL [deg.] | 34.2 | CT3/(CT4 + | 1.95 |
| | | T45L + CT5) | |
| fS [mm] | 14.77 | CT4/T23L | 0.31 |
| FnoS | 1.96 | (CT4 + CT5)/T56L | 0.28 |
| HFOVS [deg.] | 16.5 | CT6/T56L | 0.11 |
| FOVS [deg.] | 33.0 | T45L/T23L | 0.33 |
| TLL/TLS | 1.00 | (R2 + R3)/(R2 − R3) | 1.37 |
| BLL/BLS | 2.26 | (R3 − R4)/(R3 + R4) | 0.25 |
| (TG1G2S − | 3.16 | (R5 + R6)/(R5 − R6) | 0.29 |
| TG1G2L)/TG1G2L | | | |
| BLL/ImgH | 0.71 | R4/R1 | 0.58 |
| \|f3/f6\| | 0.31 | V4 + V6 | 112.0 |
| \|f3/f5\| | 0.28 | \|Sag3R1L\|/CT3 | 0.06 |
| \|f2/R3\| + \|f2/R4\| | 7.10 | \|Sag6R2L\|/CT6 | 4.48 |
| TLL/Dr1r6L | 2.25 | Y1R1L/Y6R2L | 1.15 |
| Dr1r6L/Dr7r12L | 1.36 | | |

### 3rd Embodiment

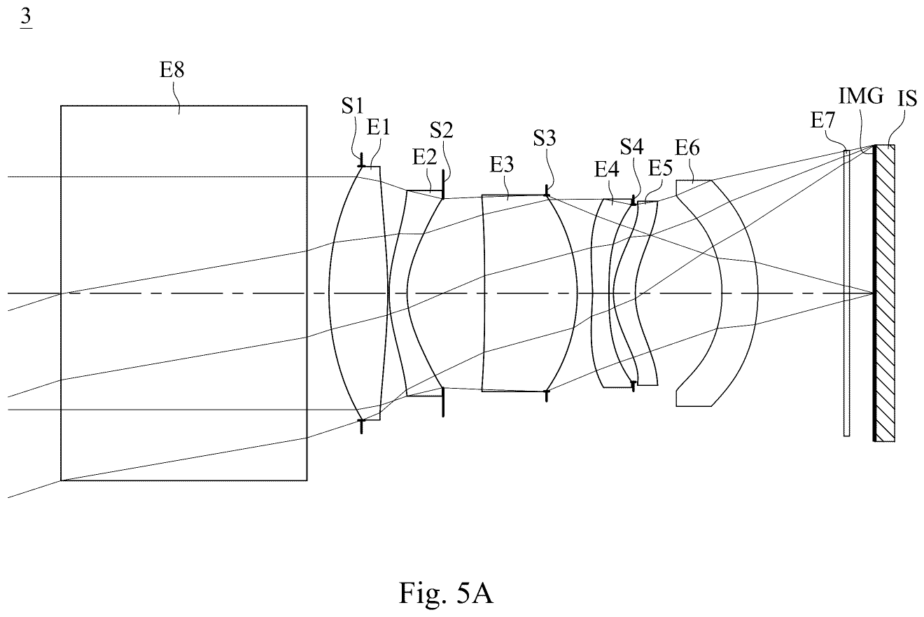

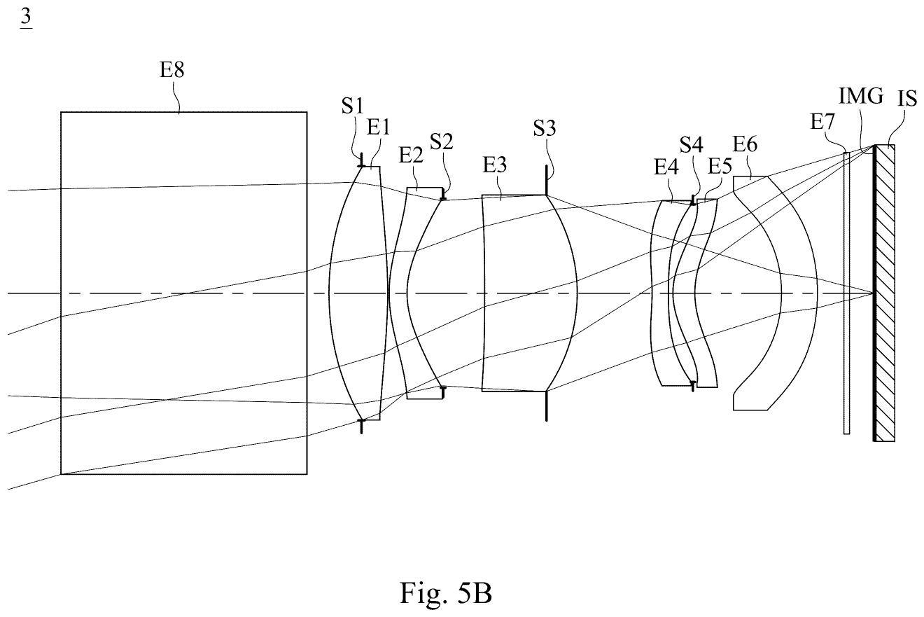

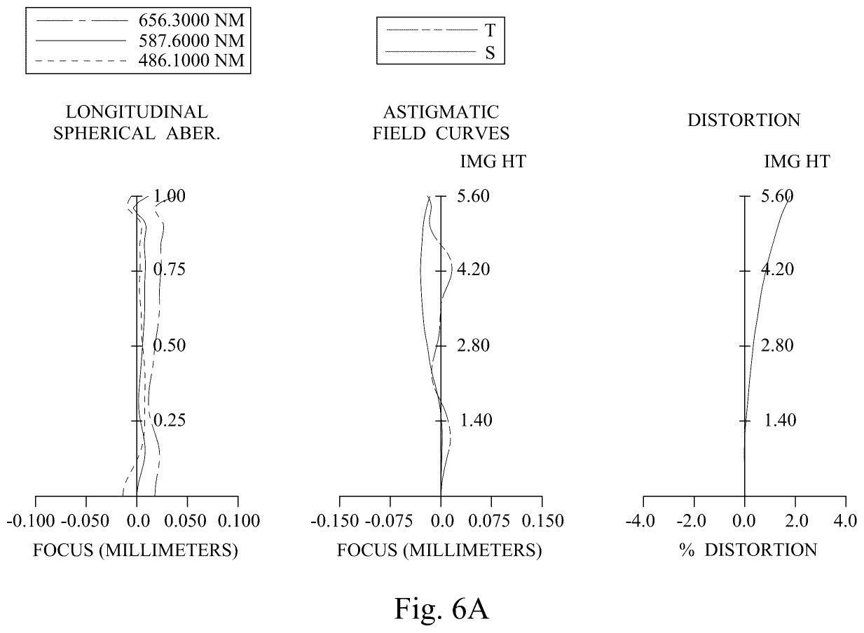

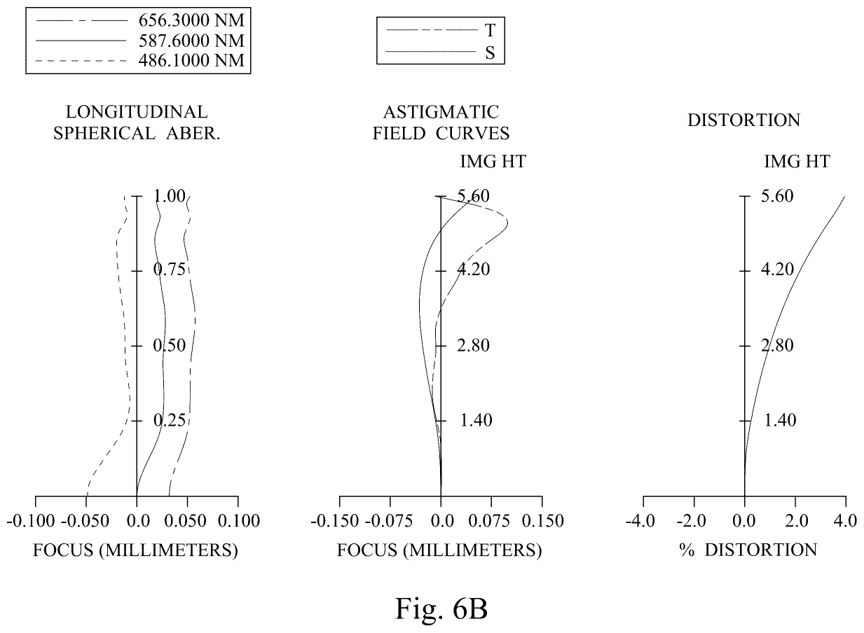

FIG. 5A is a schematic view of an imaging apparatus 3 at the 1st mode according to the 3rd embodiment of the present disclosure. FIG. 5B is a schematic view of the imaging apparatus 3 at the 2nd mode according to the 3rd embodiment. FIG. 6A shows spherical aberration curves, astigmatic field curves and a distortion curve of the imaging apparatus 3 of FIG. 5A. FIG. 6B shows imaging apparatus 3 of FIG. 5B. In FIG. 5A and FIG. 5B, the imaging apparatus 3 includes an optical photographing lens assembly (its reference numeral is omitted) and an image sensor IS. The optical photographing lens assembly includes, in order from an object side to an image side along an optical path, a reflective element E8, a stop S1, a first lens element E1, a second lens element E2, a stop S2, a third lens element E3, a stop S3, a fourth lens element E4, a stop S4, a fifth lens element E5, a sixth lens element E6, a filter E7 and an image surface IMG, wherein the image sensor IS is disposed on the image surface IMG of the optical photographing lens assembly. The optical photographing lens assembly includes six lens elements (E1, E2, E3, E4, E5, E6) without additional one or more lens elements inserted between the first lens element E1 and the sixth lens element E6. Further, the optical photographing lens assembly includes two lens element groups, which are in order from the object side to the image side along the optical path, a first lens element group and a second lens element group. As shown in FIG. 5A and FIG. 5B, according to the 2nd embodiment, the first lens element group includes the first lens element E1, the second lens element E2 and the third lens element E3, the second lens element group includes the fourth lens element E4, the fifth lens element E5 and the sixth lens element E6. When the imaged object is moved from infinite to macro, the optical photographing lens assembly is changed from the 1st mode to the 2nd mode. During the focusing movement (that is, the 1st mode is changed to the 2nd mode), the second lens element group is moved towards to the image side along the optical axis relative to the first lens element group; during the focusing movement, all lens elements in each of the lens element groups have no relative movement. Further, at the 1st mode in FIG. 5A, the stop S2 is the aperture stop in the optical photographing lens assembly; at the 2nd mode in FIG. 5B, the stop S3 is the aperture stop in the optical photographing lens assembly.

The first lens element E1 with positive refractive power has an object-side surface being convex in a paraxial region thereof and an image-side surface being convex in a paraxial region thereof. The first lens element E1 is made of plastic material, and has the object-side surface and the image-side surface being both aspheric. Furthermore, the image-side surface of the first lens element E1 includes two inflection points.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Furthermore, the object-side surface of the second lens element includes one inflection point.

The third lens element E3 with positive refractive power has an object-side surface being concave in a paraxial region thereof and an image-side surface being convex in a paraxial region thereof. The third lens element E3 is made of plastic material, and has the object-side surface and the image-side surface being both aspheric. Furthermore, the object-side surface of the third lens element E3 includes one inflection point.

The fourth lens element E4 with negative refractive power has an object-side surface being concave in a paraxial region thereof and an image-side surface being concave in a paraxial region thereof. The fourth lens element E4 is made of plastic material, and has the object-side surface and the image-side surface being both aspheric. Furthermore, the object-side surface of the fourth lens element E4 includes one inflection point and a convex critical point.

The fifth lens element E5 with positive refractive power has an object-side surface being convex in a paraxial region thereof and an image-side surface being concave in a paraxial region thereof. The fifth lens element E5 is made of plastic material, and has the object-side surface and the image-side surface being both aspheric. Furthermore, the object-side surface of the fifth lens element includes one inflection point and a concave critical point, and the image-side surface of the fifth lens element E5 includes two inflection points.

The sixth lens element E6 with negative refractive power has an object-side surface being concave in a paraxial region thereof and an image-side surface being convex in a paraxial region thereof. The sixth lens element E6 is made of plastic material, and has the object-side surface and the image-side surface being both aspheric. Furthermore, the object-side surface of the sixth lens element E6 includes one inflection point, and the image-side surface of the sixth lens element E6 includes one inflection point.

According to the 3rd embodiment, the reflective element E8 is disposed between the imaged object and the first lens element E1, that is, the reflective element E8 is at the most object side of the optical photographing lens assembly, wherein, according to the 3rd embodiment, the reflective element E8 is a prism, which is made of glass material.

The filter E7 is made of glass material, which is located between the sixth lens element E6 and the image surface IMG in order, and will not affect the focal length of the optical photographing lens assembly.

The detailed optical data of the 3rd embodiment are shown in Table 3A and the aspheric surface data are shown in Table 3B below.

TABLE 3A
3rd Embodiment

| Surface | | | | | | | | Focal |
|---|---|---|---|---|---|---|---|---|
| # | | Curvature Radius | | Thickness | Material | Index | Abbe # | Length |
| 0 | Object | Plano | | D0 | | | | |
| 1 | Prism | Plano | | 9.300 | Glass | 1.785 | 25.7 | — |
| 2 | | Plano | | 2.062 | | | | |
| 3 | Stop | Plano | | −1.231 | | | | |
| 4 | Lens 1 | 10.2365 | ASP | 2.226 | Plastic | 1.545 | 56.1 | 12.35 |
| 5 | | −18.1462 | ASP | 0.050 | | | | |
| 6 | Lens 2 | 5.1047 | ASP | 0.678 | Plastic | 1.639 | 23.5 | −16.71 |
| 7 | | 3.2746 | ASP | 1.365 | | | | |
| 8 | Stop | Plano | | 1.568 | | | | |
| 9 | Lens 3 | −166.6667 | ASP | 3.500 | Plastic | 1.545 | 56.1 | 11.95 |
| 10 | | −6.3112 | ASP | −1.160 | | | | |
| 11 | Stop | Plano | | D1 | | | | |
| 12 | Lens 4 | −7.3375 | ASP | 0.620 | Plastic | 1.566 | 37.4 | −10.42 |
| 13 | | 30.9968 | ASP | 0.925 | | | | |
| 14 | Stop | Plano | | −0.757 | | | | |
| 15 | Lens 5 | 2.6151 | ASP | 0.828 | Plastic | 1.566 | 37.4 | 15.62 |
| 16 | | 3.2887 | ASP | 3.278 | | | | |
| 17 | Lens 6 | −4.9144 | ASP | 1.357 | Plastic | 1.534 | 56.0 | −40.53 |
| 18 | | −6.9682 | ASP | D2 | | | | |

| | | | | | | | |
|---|---|---|---|---|---|---|---|
| 19 | Filter | Plano | 0.210 | Glass | 1.517 | 64.2 | — |
| 20 | | Plano | 0.951 | | | | |
| 21 | Image | Plano | — | | | | |

Reference wavelength is 587.6 nm (d-line).
Effective radius of Surface 3 (stop S1) is 4.800 mm.
Effective radius of Surface 8 (stop S2) is 3.573 mm.
Effective radius of Surface 11 (stop S3) is 3.704 mm.
Effective radius of Surface 14 (stop S4) is 3.354 mm.

TABLE 3B
Aspheric Coefficients

| Surface # | 4 | 5 | 6 | 7 |
|---|---|---|---|---|
| k= | −1.75905000E−01 | −6.17378000E+00 | −1.93766000E+00 | −1.42221000E+00 |
| A4= | 2.32299057E−04 | −2.42894948E−04 | −7.07609220E−03 | −7.01809659E−03 |
| A6= | −8.74762836E−05 | 5.67628267E−04 | 8.55641504E−04 | 4.39565472E−04 |
| A8= | 2.27337956E−05 | −1.23296463E−04 | −2.16295230E−05 | 1.72540817E−04 |
| A10= | −3.30997302E−06 | 1.46260099E−05 | −1.24692384E−05 | −6.61679044E−05 |
| A12= | 3.01602817E−07 | −1.06811695E−06 | −1.73048633E−07 | 9.87849225E−06 |
| A14= | −1.72084587E−08 | 4.87540140E−08 | 7.38108454E−07 | −4.99674462E−07 |
| A16= | 5.96519571E−10 | −1.34503601E−09 | −1.55589414E−07 | −5.70007177E−08 |
| A18= | −1.14949265E−11 | 2.02391241E−11 | 1.68496940E−08 | 1.19120771E−08 |
| A20= | 9.43733723E−14 | −1.24401766E−13 | −1.10184922E−09 | −9.54615304E−10 |
| A22= | | | 4.40977843E−11 | 4.18319326E−11 |
| A24= | | | −1.00099036E−12 | −9.95911961E−13 |
| A26= | | | 9.92121777E−15 | 1.02992863E−14 |
| Surface # | 9 | 10 | 12 | 13 |
| k= | 3.15618000E+01 | −4.16225000E−01 | −2.57253000E+00 | −9.90000000E+01 |
| A4= | −3.04643063E−04 | 3.55420554E−04 | 3.54450616E−02 | 2.46783458E−02 |
| A6= | −1.95839393E−04 | −3.76984379E−04 | −1.56036919E−02 | −1.71809157E−02 |
| A8= | 1.65454827E−04 | 2.08770930E−04 | 7.03137537E−03 | 1.09343569E−02 |
| A10= | −9.48092673E−05 | −8.02816053E−05 | −2.52391058E−03 | −4.83896223E−03 |
| A12= | 3.75701208E−05 | 2.12329047E−05 | 6.74464254E−04 | 1.51073412E−03 |
| A14= | −1.07642265E−05 | −3.92695540E−06 | −1.32197398E−04 | −3.40856271E−04 |
| A16= | 2.28374523E−06 | 5.11129957E−07 | 1.89297259E−05 | 5.63731649E−05 |
| A18= | −3.61228789E−07 | −4.65196506E−08 | −1.96764339E−06 | −6.85972896E−06 |
| A20= | 4.23378192E−08 | 2.89336255E−09 | 1.46308483E−07 | 6.09296290E−07 |
| A22= | −3.61073475E−09 | −1.17030368E−10 | −7.56138879E−09 | −3.85716473E−08 |
| A24= | 2.16822093E−10 | 2.77132971E−12 | 2.57295619E−10 | 1.65461221E−09 |
| A26= | −8.65629009E−12 | −2.91309037E−14 | −5.16999822E−12 | −4.32378720E−11 |
| A28= | 2.05642009E−13 | | 4.63641615E−14 | 5.20697615E−13 |
| A30= | −2.19484428E−15 | | | |
| Surface # | 15 | 16 | 17 | 18 |
| k= | −8.11949000E−01 | −2.83246000E−01 | −2.15364000E−01 | 1.20666000E+00 |
| A4= | −1.63237695E−02 | −1.09761513E−02 | −7.85986635E−04 | −1.02488898E−03 |
| A6= | −2.12412813E−03 | 1.26762544E−03 | 2.07776182E−04 | 8.23414985E−04 |
| A8= | 3.01161400E−03 | −1.49783706E−03 | −3.16237376E−04 | −4.85192074E−04 |
| A10= | −1.43923703E−03 | 1.08868303E−03 | 1.99048752E−04 | 1.72832629E−04 |
| A12= | 4.33076318E−04 | −4.92153153E−04 | −8.40346328E−05 | −4.04221707E−05 |
| A14= | −9.35925071E−05 | 1.46773689E−04 | 2.55824340E−05 | 6.48974667E−06 |
| A16= | 1.54038324E−05 | −3.01056782E−05 | −5.72189697E−06 | −7.32273560E−07 |
| A18= | −1.98087788E−06 | 4.32291756E−06 | 9.36940881E−07 | 5.86000750E−08 |
| A20= | 1.97383955E−07 | −4.34131161E−07 | −1.10999663E−07 | −3.30911502E−09 |
| A22= | −1.46069811E−08 | 2.98805898E−08 | 9.33609337E−09 | 1.28925585E−10 |
| A24= | 7.44670088E−10 | −1.34297508E−09 | −5.40430480E−10 | −3.29495258E−12 |
| A26= | −2.30278070E−11 | 3.54939936E−11 | 2.03845315E−11 | 4.95907768E−14 |
| A28= | 3.22374687E−13 | −4.18193088E−13 | −4.49673164E−13 | −3.31541838E−16 |
| A30= | | | 4.39120173E−15 | |

Please refer to Table 3A, the object distances and the data of DO, D1 and D2 in Table 3A of the 3rd embodiment at the 1st mode and the 2nd mode are listed in Table 3C as below.

TABLE 3C
3th Embodiment

| | 1st mode | | 2nd mode |
|---|---|---|---|
| Object distance (mm) | infinite | Object distance (mm) | 120.031 |
| D0 (mm) | infinite | D0 (mm) | 109.900 |
| D1 (mm) | 1.740 | D1 (mm) | 3.990 |
| D2 (mm) | 3.250 | D2 (mm) | 1.000 |

In the 3rd embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 3rd embodiment, so an explanation in this regard will not be provided again.

Moreover, these parameters can be calculated from Table 3A, Table 3B and Table 3C as the following values and satisfy the following conditions in Table 3D:

TABLE 3D
3rd Embodiment

| | | | |
|---|---|---|---|
| fL [mm] | 17.10 | CT1/T23L | 0.76 |
| FnoL | 1.94 | CT1/CT3 | 0.64 |
| HFOVL [deg.] | 17.8 | CT2/CT3 | 0.19 |
| FOVL [deg.] | 35.6 | CT3/(CT4 + | 2.17 |
| | | T45L + CT5) | |
| fS [mm] | 14.11 | CT4/T23L | 0.21 |
| FnoS | 1.95 | (CT4 + CT5)/T56L | 0.44 |
| HFOVS [deg.] | 17.0 | CT6/T56L | 0.41 |
| FOVS [deg.] | 34.0 | T45L/T23L | 0.06 |
| TLL/TLS | 1.00 | (R2 + R3)/(R2 − R3) | 0.56 |
| BLL/BLS | 2.04 | (R3 − R4)/(R3 + R4) | 0.22 |
| (TG1G2S − | 3.88 | (R5 + R6)/(R5 − R6) | 1.08 |
| TG1G2L)/TG1G2L | | | |
| BLL/ImgH | 0.79 | R4/R1 | 0.32 |
| \|f3/f6\| | 0.29 | V4 + V6 | 93.4 |
| \|f3/f5\| | 0.76 | \|Sag3R1L\|/CT3 | 0.03 |
| \|f2/R3\| + \|f2/R4\| | 8.37 | \|Sag6R2L\|/CT6 | 1.30 |
| TLL/Dr1r6L | 2.20 | Y1R1L/Y6R2L | 1.12 |
| Dr1r6L/Dr7r12L | 1.50 | | |

### 4th Embodiment

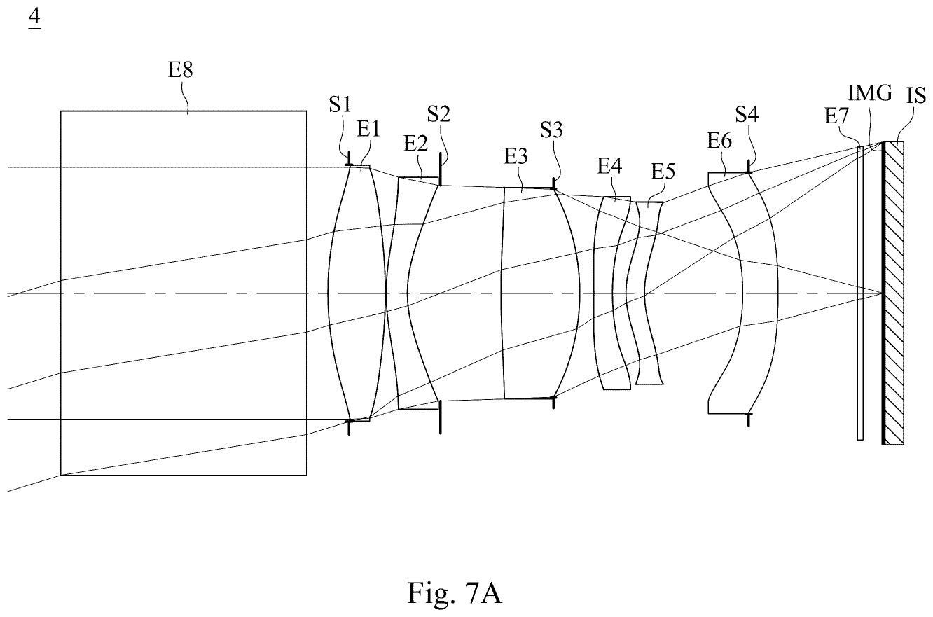

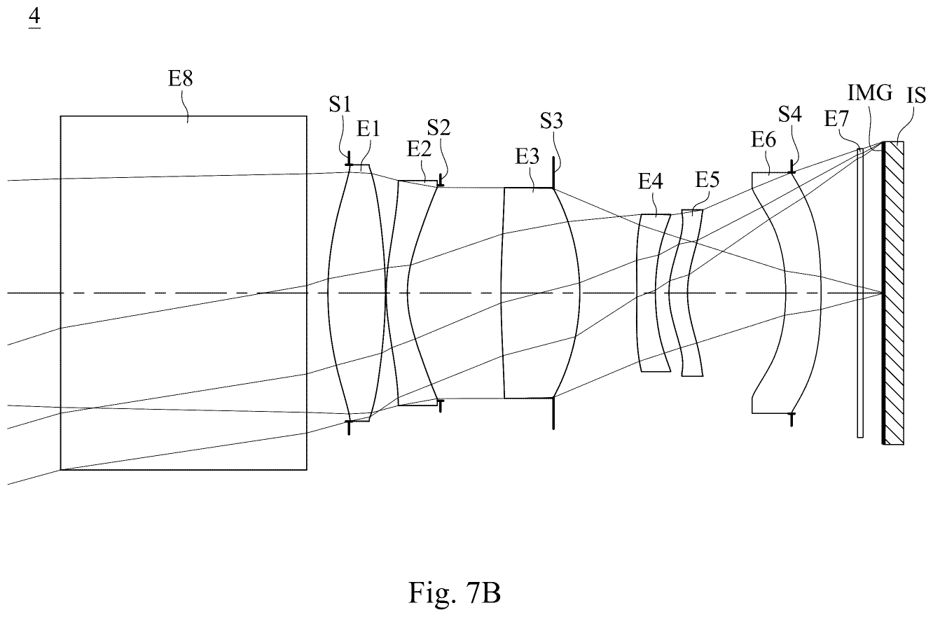

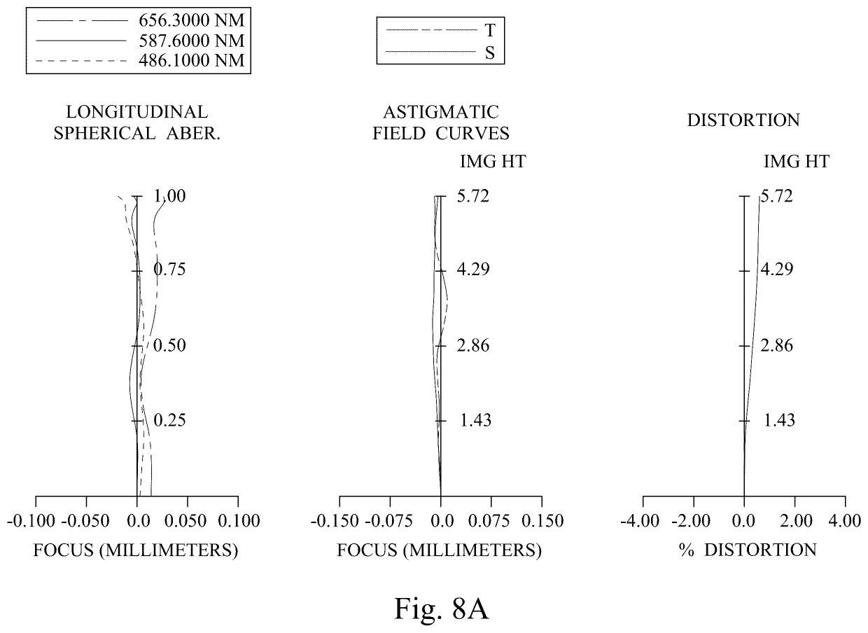

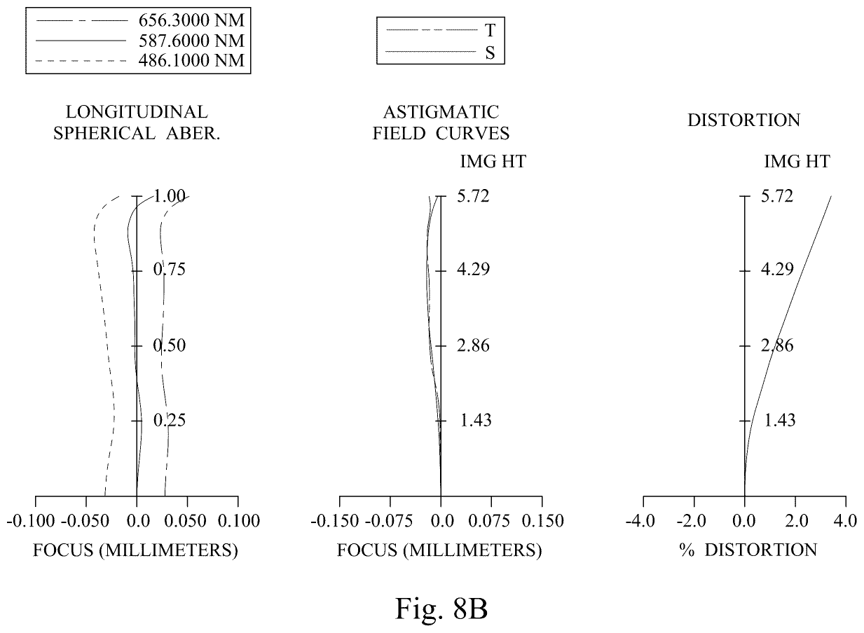

FIG. 7A is a schematic view of an imaging apparatus 4 at the 1st mode according to the 4th embodiment of the present disclosure. FIG. 7B is a schematic view of the imaging apparatus 4 at the 2nd mode according to the 4th embodiment. FIG. 8A shows spherical aberration curves, astigmatic field curves and a distortion curve of the imaging apparatus 4 of FIG. 7A. FIG. 8B shows spherical aberration curves, astigmatic field curves and a distortion curve of the imaging apparatus 4 of FIG. 7B. In FIG. 7A and FIG. 7B, the imaging apparatus 4 includes an optical photographing lens assembly (its reference numeral is omitted) and an image sensor IS. The optical photographing lens assembly includes, in order from an object side to an image side along an optical path, a reflective element E8, a stop S1, a first lens element E1, a second lens element E2, a stop S2, a third lens element E3, a stop S3, a fourth lens element E4, a fifth lens element E5, a sixth lens element E6, a stop S4, a filter E7 and an image surface IMG, wherein the image sensor IS is disposed on the image surface IMG of the optical photographing lens assembly. The optical photographing lens assembly includes six lens elements (E1, E2, E3, E4, E5, E6) without additional one or more lens elements inserted between the first lens element E1 and the sixth lens element E6. Further, the optical photographing lens assembly includes two lens element groups, which are in order from the object side to the image side along the optical path, a first lens element group and a second lens element group. As shown in FIG. 7A and FIG. 7B, according to the 4th embodiment, the first lens element group includes the first lens element E1, the second lens element E2 and the third lens element E3, the second lens element group includes the fourth lens element E4, the fifth lens element E5 and the sixth lens element E6. When the imaged object is moved from infinite to macro, the optical photographing lens assembly is changed from the 1st mode to the 2nd mode. During the focusing movement (that is, the 1st mode is changed to the 2nd mode), the second lens element group is moved towards to the image side along the optical axis relative to the first lens element group; during the focusing movement, all lens elements in each of the lens element groups have no relative movement. Further, at the 1st mode in FIG. 7A, the stop S2 is the aperture stop in the optical photographing lens assembly; at the 2nd mode in FIG. 7B, the stop S3 is the aperture stop in the optical photographing lens assembly.

The first lens element E1 with positive refractive power has an object-side surface being convex in a paraxial region thereof and an image-side surface being convex in a paraxial region thereof. The first lens element E1 is made of plastic material, and has the object-side surface and the image-side surface being both aspheric. Furthermore, the object-side surface of the first lens element E1 includes one inflection point.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Furthermore, the object-side surface of the second lens element includes two inflection points.

The third lens element E3 with positive refractive power has an object-side surface being convex in a paraxial region thereof and an image-side surface being convex in a paraxial region thereof. The third lens element E3 is made of glass material, and has the object-side surface and the image-side surface being both aspheric. Furthermore, the object-side surface of the third lens element E3 includes two inflection points.

The fourth lens element E4 with negative refractive power has an object-side surface being concave in a paraxial region thereof and an image-side surface being concave in a paraxial region thereof. The fourth lens element E4 is made of plastic material, and has the object-side surface and the image-side surface being both aspheric. Furthermore, the object-side surface of the fourth lens element E4 includes one inflection point and a convex critical point, and the image-side surface of the fourth lens element E4 includes two inflection points.

The fifth lens element E5 with positive refractive power has an object-side surface being convex in a paraxial region thereof and an image-side surface being concave in a paraxial region thereof. The fifth lens element E5 is made of plastic material, and has the object-side surface and the image-side surface being both aspheric. Furthermore, the object-side surface of the fifth lens element includes two inflection points and a concave critical point, and the image-side surface of the fifth lens element E5 includes two inflection points.

The sixth lens element E6 with negative refractive power has an object-side surface being concave in a paraxial region thereof and an image-side surface being convex in a paraxial region thereof. The sixth lens element E6 is made of plastic material, and has the object-side surface and the image-side surface being both aspheric. Furthermore, the object-side surface of the sixth lens element E6 includes one inflection point, and the image-side surface of the sixth lens element E6 includes one inflection point.

According to the 4th embodiment, the reflective element E8 is disposed between the imaged object and the first lens element E1, that is, the reflective element E8 is at the most object side of the optical photographing lens assembly, wherein, according to the 4th embodiment, the reflective element E8 is a prism, which is made of glass material.

The filter E7 is made of glass material, which is located between the sixth lens element E6 and the image surface IMG in order, and will not affect the focal length of the optical photographing lens assembly.

The detailed optical data of the 4th embodiment are shown in Table 4A and the aspheric surface data are shown in Table 4B below.

TABLE 4A
4th Embodiment

| Surface | | | | | | | | Focal |
|---|---|---|---|---|---|---|---|---|
| # | | Curvature Radius | | Thickness | Material | Index | Abbe # | Length |
| 0 | Object | Plano | | D0 | | | | |
| 1 | Prism | Plano | | 9.300 | Glass | 1.785 | 25.7 | — |
| 2 | | Plano | | 1.598 | | | | |
| 3 | Stop | Plano | | −0.798 | | | | |
| 4 | Lens 1 | 11.7556 | ASP | 2.172 | Plastic | 1.545 | 56.1 | 13.16 |
| 5 | | −17.1912 | ASP | 0.030 | | | | |
| 6 | Lens 2 | 7.4375 | ASP | 0.800 | Plastic | 1.639 | 23.5 | −18.62 |
| 7 | | 4.3840 | ASP | 1.251 | | | | |
| 8 | Stop | Plano | | 2.287 | | | | |
| 9 | Lens 3 | 33.5586 | ASP | 2.976 | Glass | 1.589 | 61.2 | 11.72 |
| 10 | | −8.4058 | ASP | −0.994 | | | | |
| 11 | Stop | Plano | | D1 | | | | |
| 12 | Lens 4 | −33.3293 | ASP | 0.700 | Plastic | 1.544 | 56.0 | −12.10 |
| 13 | | 8.2614 | ASP | 0.512 | | | | |
| 14 | Lens 5 | 3.2895 | ASP | 0.700 | Plastic | 1.544 | 56.0 | 28.32 |
| 15 | | 3.8687 | ASP | 3.712 | | | | |
| 16 | Lens 6 | −8.3640 | ASP | 1.334 | Plastic | 1.544 | 56.0 | −25.30 |
| 17 | | −22.5185 | ASP | −1.113 | | | | |

| | | | | | | | |
|---|---|---|---|---|---|---|---|
| 18 | Stop | Plano | D2 | | | | |
| 19 | Filter | Plano | 0.210 | Glass | 1.517 | 64.2 | — |
| 20 | | Plano | 0.776 | | | | |
| 21 | Image | Plano | — | | | | |

Reference wavelength is 587.6 nm (d-line).
Effective radius of Surface 3 (stop S1) is 4.850 mm.
Effective radius of Surface 8 (stop S2) is 4.073 mm.
Effective radius of Surface 11 (stop S3) is 3.945 mm.
Effective radius of Surface 18 (stop S4) is 4.557 mm.

TABLE 4B
Aspheric Coefficients

| Surface # | 4 | 5 | 6 | 7 |
|---|---|---|---|---|
| k= | −6.00533000E+00 | 0.00000000E+00 | 0.00000000E+00 | −2.02257000E+00 |
| A4= | 4.63345766E−04 | 8.13397361E−04 | −4.80367645E−03 | −4.24567101E−03 |
| A6= | −1.97317084E−05 | −9.29405477E−05 | 1.82132268E−04 | 3.14296495E−04 |
| A8= | −1.75790676E−06 | 1.40288222E−05 | 7.43232461E−06 | −1.01306733E−05 |
| A10= | 4.85860258E−07 | −1.41489469E−06 | −2.00264333E−06 | −7.57084252E−07 |
| A12= | −5.00227552E−08 | 8.15583845E−08 | 1.33284194E−07 | 9.54233542E−08 |
| A14= | 2.88042220E−09 | −2.79991486E−09 | −3.88755533E−09 | −3.60990656E−09 |
| A16= | −1.02204559E−10 | 5.41020487E−11 | 4.31919834E−11 | 4.96844922E−11 |
| A18= | 2.07660180E−12 | −4.63914083E−13 | | |
| A20= | −1.86405869E−14 | | | |
| Surface # | 9 | 10 | 12 | 13 |
| k= | 3.93985000E+01 | −2.17604000E−01 | 2.73469000E+01 | −1.66401000E+01 |
| A4= | −4.52891457E−04 | 5.30114676E−05 | 6.94992989E−03 | 3.52625683E−04 |
| A6= | −3.10203383E−05 | −4.21422374E−05 | −5.37314420E−04 | 2.05271704E−03 |
| A8= | 3.20549626E−06 | 6.34793044E−06 | 4.78618086E−05 | −6.08377616E−04 |
| A10= | −3.45415753E−07 | −6.74681624E−07 | −1.21396259E−05 | 9.99637153E−05 |
| A12= | 2.44735833E−08 | 4.42018814E−08 | 3.57542198E−06 | −8.26312095E−06 |
| A14= | −8.33455975E−10 | −1.56425313E−09 | −6.46661131E−07 | −2.09653530E−07 |
| A16= | 1.22109855E−11 | 2.38169627E−11 | 6.97380756E−08 | 1.24940649E−07 |
| A18= | | | −4.43077771E−09 | −1.28437744E−08 |
| A20= | | | 1.53051492E−10 | 6.00660502E−10 |
| A22= | | | −2.21035055E−12 | −1.09415022E−11 |
| Surface # | 14 | 15 | 16 | 17 |
| k= | −5.62376000E+00 | −8.05605000E+00 | 2.03912000E+00 | 0.00000000E+00 |
| A4= | −8.53185443E−04 | 5.23882070E−03 | −1.83330656E−03 | −2.30360380E−03 |
| A6= | −1.00972132E−03 | −3.30553568E−03 | −2.17017442E−04 | 4.35423005E−05 |
| A8= | 2.86294434E−04 | 1.02216115E−03 | 1.37522198E−04 | −1.73414923E−06 |
| A10= | −7.53634258E−05 | −2.66811659E−04 | −4.62070143E−05 | −1.86676334E−06 |
| A12= | 1.35585410E−05 | 5.41219812E−05 | 1.09010659E−05 | 1.22136522E−06 |
| A14= | −1.60329069E−06 | −8.08902050E−06 | −1.88341014E−06 | −3.56124225E−07 |
| A16= | 1.14038386E−07 | 8.57789987E−07 | 2.45309161E−07 | 6.24721462E−08 |
| A18= | −4.26456366E−09 | −6.18058593E−08 | −2.41604023E−08 | −7.25131755E−09 |
| A20= | 6.35879122E−11 | 2.84825111E−09 | 1.77349019E−09 | 5.78941995E−10 |
| A22= | | −7.40116455E−11 | −9.39983264E−11 | −3.20867718E−11 |
| A24= | | 7.80550674E−13 | 3.43075183E−12 | 1.21625301E−12 |
| A26= | | | −8.03253032E−14 | −3.01300920E−14 |
| A28= | | | 1.06353654E−15 | 4.39998264E−16 |
| A30= | | | −5.86595108E−18 | −2.87349458E−18 |

Please refer to Table 4A, the object distances and the data of DO, D1 and D2 in Table 4A of the 4th embodiment at the 1st mode and the 2nd mode are listed in Table 4C as below.

TABLE 4C
4th Embodiment

| | 1st mode | | 2nd mode |
|---|---|---|---|
| Object distance (mm) | infinite | Object distance (mm) | 130.100 |
| D0 (mm) | infinite | D0 (mm) | 120.000 |
| D1 (mm) | 1.528 | D1 (mm) | 3.152 |
| D2 (mm) | 4.113 | D2 (mm) | 2.489 |

In the 4th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 4th embodiment, so an explanation in this regard will not be provided again.

Moreover, these parameters can be calculated from Table 4A, Table 4B and Table 4C as the following values and satisfy the following conditions in Table 4D:

TABLE 4D
4th Embodiment

| | | | |
|---|---|---|---|
| fL [mm] | 18.59 | CT1/T23L | 0.61 |
| FnoL | 1.95 | CT1/CT3 | 0.73 |
| HFOVL [deg.] | 17.0 | CT2/CT3 | 0.27 |
| FOVL [deg.] | 34.0 | CT3/(CT4 + | 1.56 |
| | | T45L + CT5) | |
| fS [mm] | 14.68 | CT4/T23L | 0.20 |
| FnoS | 1.94 | (CT4 + CT5)/T56L | 0.38 |
| HFOVS [deg.] | 16.3 | CT6/T56L | 0.36 |
| FOVS [deg.] | 32.6 | T45L/T23L | 0.14 |
| TLL/TLS | 1.00 | (R2 + R3)/(R2 − R3) | 0.40 |
| BLL/BLS | 1.69 | (R3 − R4)/(R3 + R4) | 0.26 |
| (TG1G2S − | 3.04 | (R5 + R6)/(R5 − R6) | 0.60 |
| TG1G2L)/TG1G2L | | | |
| BLL/ImgH | 0.70 | R4/R1 | 0.37 |
| \|f3/f6\| | 0.46 | V4 + V6 | 112.0 |
| \|f3/f5\| | 0.41 | \|Sag3R1L\|/CT3 | 0.04 |
| \|f2/R3\| + \|f2/R4\| | 6.75 | \|Sag6R2L\|/CT6 | 0.85 |
| TLL/Dr1r6L | 2.21 | Y1R1L/Y6R2L | 1.06 |
| Dr1r6L/Dr7r12L | 1.37 | | |

### 5th Embodiment

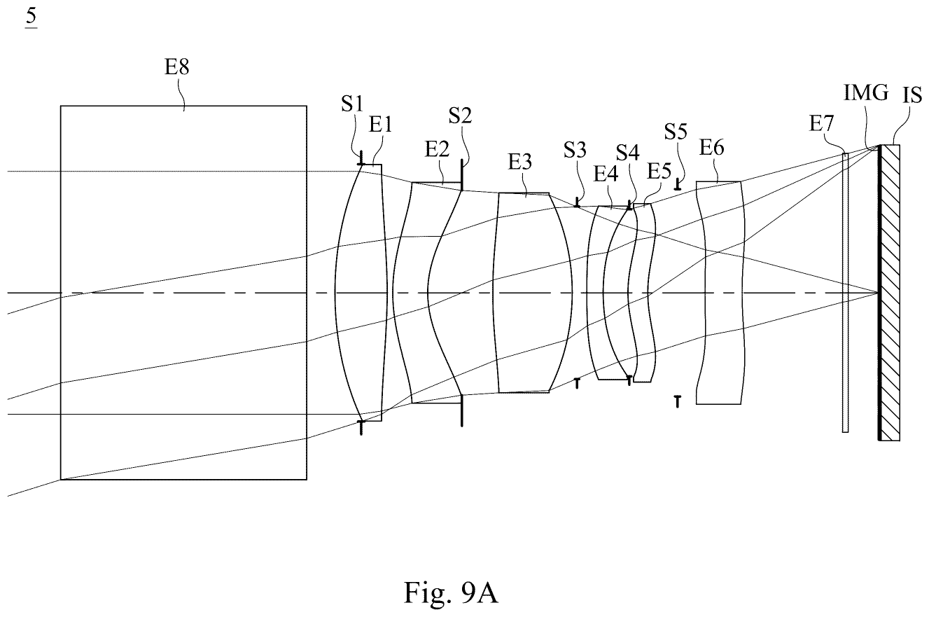

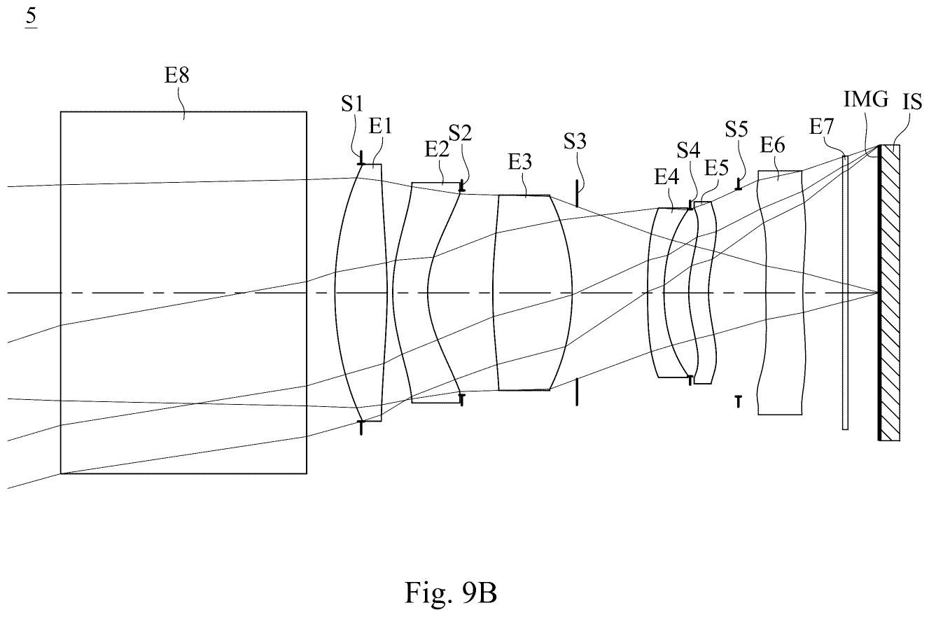

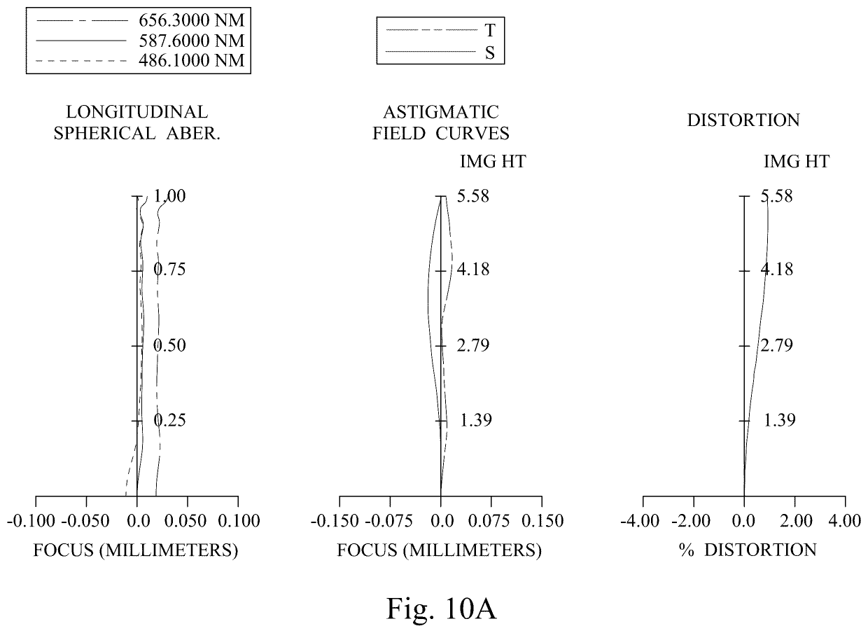

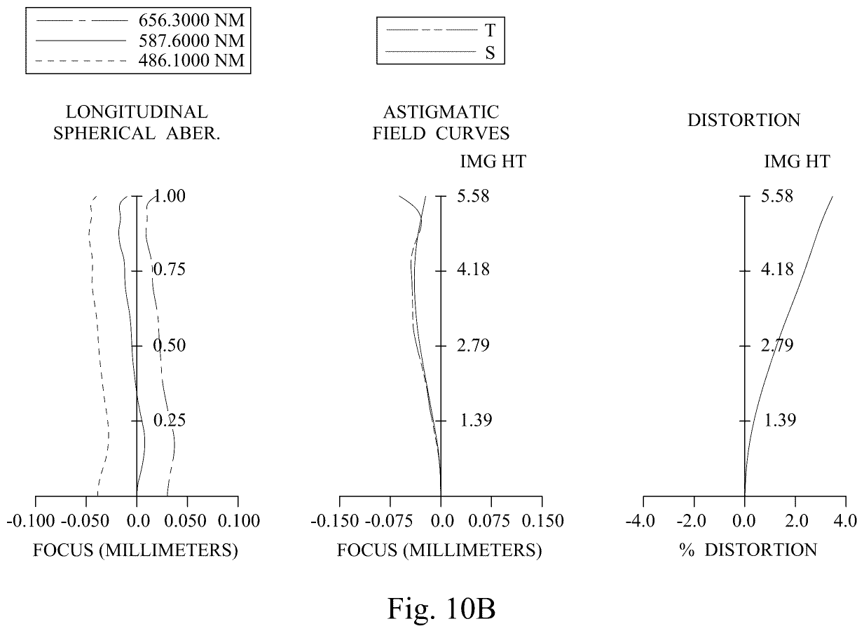

FIG. 9A is a schematic view of an imaging apparatus 5 at the 1st mode according to the 5th embodiment of the present disclosure. FIG. 9B is a schematic view of the imaging apparatus 5 at the 2nd mode according to the 5th embodiment. FIG. 10A shows spherical aberration curves, astigmatic field curves and a distortion curve of the imaging apparatus 5 of FIG. 9A. FIG. 10B shows imaging apparatus 5 of FIG. 9B. In FIG. 9A and FIG. 9B, the imaging apparatus 5 includes an optical photographing lens assembly (its reference numeral is omitted) and an image sensor IS. The optical photographing lens assembly includes, in order from an object side to an image side along an optical path, a reflective element E8, a stop S1, a first lens element E1, a second lens element E2, a stop S2, a third lens element E3, a stop S3, a fourth lens element E4, a stop S4, a fifth lens element E5, a stop S5, a sixth lens element E6, a filter E7 and an image surface IMG, wherein the image sensor IS is disposed on the image surface IMG of the optical photographing lens assembly. The optical photographing lens assembly includes six lens elements (E1, E2, E3, E4, E5, E6) without additional one or more lens elements inserted between the first lens element E1 and the sixth lens element E6. Further, the optical photographing lens assembly includes two lens element groups, which are in order from the object side to the image side along the optical path, a first lens element group and a second lens element group. As shown in FIG. 9A and FIG. 9B, according to the 5th embodiment, the first lens element group includes the first lens element E1, the second lens element E2 and the third lens element E3, the second lens element group includes the fourth lens element E4, the fifth lens element E5 and the sixth lens element E6. When the imaged object is moved from infinite to macro, the optical photographing lens assembly is changed from the 1st mode to the 2nd mode. During the focusing movement (that is, the 1st mode is changed to the 2nd mode), the second lens element group is moved towards to the image side along the optical axis relative to the first lens element group; during the focusing movement, all lens elements in each of the lens element groups have no relative movement. Further, at the 1st mode in FIG. 9A, the stop S2 is the aperture stop in the optical photographing lens assembly; at the 2nd mode in FIG. 9B, the stop S3 is the aperture stop in the optical photographing lens assembly.

The first lens element E1 with positive refractive power has an object-side surface being convex in a paraxial region thereof and an image-side surface being convex in a paraxial region thereof. The first lens element E1 is made of glass material, and has the object-side surface and the image-side surface being both aspheric. Furthermore, the object-side surface of the first lens element E1 includes one inflection point, and the image-side surface of the first lens element E1 includes two inflection points.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Furthermore, the object-side surface of the second lens element includes one inflection point and a concave critical point, and the image-side surface of the second lens element E2 includes one inflection point.

The third lens element E3 with positive refractive power has an object-side surface being convex in a paraxial region thereof and an image-side surface being convex in a paraxial region thereof. The third lens element E3 is made of plastic material, and has the object-side surface and the image-side surface being both aspheric. Furthermore, the object-side surface of the third lens element E3 includes one inflection point.

The fourth lens element E4 with negative refractive power has an object-side surface being convex in a paraxial region thereof and an image-side surface being concave in a paraxial region thereof. The fourth lens element E4 is made of plastic material, and has the object-side surface and the image-side surface being both aspheric.

The fifth lens element E5 with positive refractive power has an object-side surface being convex in a paraxial region thereof and an image-side surface being concave in a paraxial region thereof. The fifth lens element E5 is made of plastic material, and has the object-side surface and the image-side surface being both aspheric. Furthermore, the object-side surface of the fifth lens element E5 includes two inflection points and a concave critical point, and the image-side surface of the fifth lens element E5 includes two inflection points and a convex critical point.

The sixth lens element E6 with negative refractive power has an object-side surface being convex in a paraxial region thereof and an image-side surface being concave in a paraxial region thereof. The sixth lens element E6 is made of plastic material, and has the object-side surface and the image-side surface being both aspheric. Furthermore, the object-side surface of the sixth lens element E6 includes two inflection points, a convex critical point and a concave critical point, and the image-side surface of the sixth lens element E6 includes two inflection points and a convex critical point.

According to the 5th embodiment, the reflective element E8 is disposed between the imaged object and the first lens element E1, that is, the reflective element E8 is at the most object side of the optical photographing lens assembly, wherein, according to the 5th embodiment, the reflective element E8 is a prism, which is made of glass material.

The filter E7 is made of glass material, which is located between the sixth lens element E6 and the image surface IMG in order, and will not affect the focal length of the optical photographing lens assembly.

The detailed optical data of the 5th embodiment are shown in Table 5A and the aspheric surface data are shown in Table 5B below.

TABLE 5A
5th Embodiment

| Surface | | | | | | | | Focal |
|---|---|---|---|---|---|---|---|---|
| # | | Curvature Radius | | Thickness | Material | Index | Abbe # | Length |
| 0 | Object | Plano | | D0 | | | | |
| 1 | Prism | Plano | | 9.300 | Glass | 1.785 | 25.7 | — |
| 2 | | Plano | | 2.062 | | | | |
| 3 | Stop | Plano | | −0.994 | | | | |
| 4 | Lens 1 | 12.6745 | ASP | 1.977 | Glass | 1.524 | 70.3 | 15.29 |
| 5 | | −20.5666 | ASP | 0.209 | | | | |
| 6 | Lens 2 | 6.4429 | ASP | 1.320 | Plastic | 1.639 | 23.5 | −17.81 |
| 7 | | 3.7843 | ASP | 1.293 | | | | |
| 8 | Stop | Plano | | 1.171 | | | | |
| 9 | Lens 3 | 19.6967 | ASP | 3.000 | Plastic | 1.545 | 56.1 | 11.18 |
| 10 | | −8.3475 | ASP | 0.180 | | | | |
| 11 | Stop | Plano | | D1 | | | | |
| 12 | Lens 4 | 41.6667 | ASP | 0.620 | Plastic | 1.544 | 56.0 | −15.90 |
| 13 | | 7.1249 | ASP | 0.988 | | | | |
| 14 | Stop | Plano | | −0.052 | | | | |
| 15 | Lens 5 | 4.4653 | ASP | 0.750 | Plastic | 1.566 | 37.4 | 66.10 |
| 16 | | 4.7626 | ASP | 1.125 | | | | |
| 17 | Stop | Plano | | 1.039 | | | | |
| 18 | Lens 6 | 28.5714 | ASP | 1.400 | Plastic | 1.544 | 56.0 | −49.33 |
| 19 | | 13.5999 | ASP | D2 | | | | |

| | | | | | | | |
|---|---|---|---|---|---|---|---|
| 20 | Filter | Plano | 0.210 | Glass | 1.517 | 64.2 | — |
| 21 | | Plano | 1.191 | | | | |
| 22 | Image | Plano | | | | | |

Effective radius of Surface 17 (stop S5) is 3.917 mm.
Reference wavelength is 587.6 nm (d-line).
Effective radius of Surface 3 (stop S1) is 4.861 mm.
Effective radius of Surface 8 (stop S2) is 3.867 mm.
Effective radius of Surface 11 (stop S3) is 3.261 mm.
Effective radius of Surface 14 (stop S4) is 3.158 mm.

TABLE 5B
Aspheric Coefficients

| Surface # | 4 | 5 | 6 | 7 |
|---|---|---|---|---|
| k= | −8.33208000E−02 | −1.07095000E+01 | −3.85373000E−01 | −1.30595000E+00 |
| A4= | 2.66423935E−04 | 9.54709310E−04 | −3.04519026E−03 | −3.89325507E−03 |
| A6= | −3.25633190E−05 | −4.39345828E−06 | 1.44544053E−04 | 2.30699789E−04 |
| A8= | 5.18307984E−06 | −2.27434044E−06 | −1.16248170E−05 | −7.90139583E−06 |
| A10= | −5.52332972E−07 | −9.65234159E−08 | 9.50269511E−07 | −3.18829514E−06 |
| A12= | 3.87273898E−08 | 4.32291387E−08 | −2.98470595E−07 | 7.83255244E−07 |
| A14= | −1.70747759E−09 | −3.90498622E−09 | 6.71614071E−08 | −1.17757028E−07 |
| A16= | 4.44797422E−11 | 1.73617350E−10 | −8.66621305E−09 | 1.53307839E−08 |
| A18= | −5.85401469E−13 | −3.98881924E−12 | 7.05677987E−10 | −1.65665536E−09 |
| A20= | 2.18660620E−15 | 3.76352521E−14 | −3.76896832E−11 | 1.27592062E−10 |
| A22= | | | 1.29515144E−12 | −6.26122436E−12 |
| A24= | | | −2.61391095E−14 | 1.73810816E−13 |
| A26= | | | 2.36254011E−16 | −2.07314441E−15 |
| Surface # | 9 | 10 | 12 | 13 |
| k= | 8.92709000E+00 | −5.24091000E−01 | −9.81998000E+01 | −4.78930000E+01 |
| A4= | −6.33816544E−04 | 6.23220665E−05 | 3.91890703E−03 | 1.70167112E−02 |
| A6= | 1.44937907E−04 | −1.72905574E−04 | −5.05256817E−04 | −7.08765011E−03 |
| A8= | −1.54606823E−04 | 8.89767929E−05 | 3.18594547E−04 | 3.94167347E−03 |
| A10= | 8.75357499E−05 | −3.00813022E−05 | −1.23173429E−04 | −1.80467122E−03 |
| A12= | −3.21482806E−05 | 6.73109276E−06 | 2.57346659E−05 | 6.39888368E−04 |
| A14= | 8.00244684E−06 | −1.02774144E−06 | −2.15677749E−06 | −1.73325447E−04 |
| A16= | −1.38575698E−06 | 1.08393113E−07 | −2.95528347E−07 | 3.55370836E−05 |
| A18= | 1.68721686E−07 | −7.83150368E−09 | 1.14408929E−07 | −5.44964811E−06 |
| A20= | −1.43838159E−08 | 3.74966867E−10 | −1.65018788E−08 | 6.13080374E−07 |
| A22= | 8.40119979E−10 | −1.10665230E−11 | 1.37359778E−09 | −4.89868202E−08 |
| A24= | −3.20106333E−11 | 1.71994844E−13 | −6.87489998E−11 | 2.62709348E−09 |
| A26= | 7.16476627E−13 | −9.04217696E−16 | 1.92237657E−12 | −8.46764567E−11 |
| A28= | −7.14282089E−15 | | −2.30573786E−14 | 1.23890618E−12 |
| Surface # | 15 | 16 | 18 | 19 |
| k= | −5.14704000E−01 | 2.51029000E−01 | −9.07541000E+01 | 7.07758000E+00 |
| A4= | −1.19021703E−02 | −1.29914863E−02 | −4.73573622E−03 | −4.45272959E−03 |
| A6= | 9.70886931E−05 | 1.38215450E−04 | 4.33552676E−04 | 1.44268554E−04 |
| A8= | 7.36387615E−04 | 3.89832810E−04 | −2.44645713E−04 | −1.61822605E−06 |
| A10= | −6.42962562E−04 | −2.70730525E−04 | 9.74364529E−05 | −7.03575028E−06 |
| A12= | 3.60210709E−04 | 1.23099508E−04 | −2.46424989E−05 | 3.08791952E−06 |
| A14= | −1.39344575E−04 | −4.05444934E−05 | 4.16368541E−06 | −7.09140726E−07 |
| A16= | 3.74805079E−05 | 9.54688382E−06 | −4.76567540E−07 | 1.03292908E−07 |
| A18= | −7.03963811E−06 | −1.58982041E−06 | 3.63872354E−08 | −1.01512330E−08 |
| A20= | 9.18330935E−07 | 1.84742797E−07 | −1.73017340E−09 | 6.84902746E−10 |
| A22= | −8.14466816E−08 | −1.45993496E−08 | 3.95073208E−11 | −3.13412793E−11 |
| A24= | 4.67911784E−09 | 7.45603406E−10 | 4.40287426E−13 | 9.29980004E−13 |
| A26= | −1.56867490E−10 | −2.21252488E−11 | −5.50124841E−14 | −1.61324262E−14 |
| A28= | 2.32789856E−12 | 2.88794429E−13 | 1.39744050E−15 | 1.23988442E−16 |
| A30= | | | −1.27502864E−17 | |

Please refer to Table 5A, the object distances and the data of DO, D1 and D2 in Table 5A of the 5th embodiment at the 1st mode and the 2nd mode are listed in Table 5C as below.

TABLE 5C
5th Embodiment

| | 1st mode | | 2nd mode |
|---|---|---|---|
| Object distance (mm) | infinite | Object distance (mm) | 120.268 |
| D0 (mm) | infinite | D0 (mm) | 109.900 |
| D1 (mm) | 0.370 | D1 (mm) | 2.670 |
| D2 (mm) | 3.800 | D2 (mm) | 1.500 |

In the 5th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 5th embodiment, so an explanation in this regard will not be provided again.

Moreover, these parameters can be calculated from Table 5A, Table 5B and Table 5C as the following values and satisfy the following conditions in Table 5D:

TABLE 5D
5th Embodiment

| | | | |
|---|---|---|---|
| fL [mm] | 17.84 | CT1/T23L | 0.80 |
| FnoL | 1.94 | CT1/CT3 | 0.66 |
| HFOVL [deg.] | 17.2 | CT2/CT3 | 0.44 |
| FOVL [deg.] | 34.4 | CT3/(CT4 + | 1.30 |
| | | T45L + CT5) | |
| fS [mm] | 14.08 | CT4/T23L | 0.25 |
| FnoS | 1.95 | (CT4 + CT5)/T56L | 0.63 |
| HFOVS [deg.] | 16.4 | CT6/T56L | 0.65 |
| FOVS [deg.] | 32.8 | T45L/T23L | 0.38 |
| TLL/TLS | 1.00 | (R2 + R3)/(R2 − R3) | 0.52 |
| BLL/BLS | 1.79 | (R3 − R4)/(R3 + R4) | 0.26 |
| (TG1G2S − | 4.18 | (R5 + R6)/(R5 − R6) | 0.40 |
| TG1G2L)/TG1G2L | | | |
| BLL/ImgH | 0.93 | R4/R1 | 0.30 |
| \|f3/f6\| | 0.23 | V4 + V6 | 112.0 |
| \|f3/f5\| | 0.17 | \|Sag3R1L\|/CT3 | 0.08 |
| \|f2/R3\| + \|f2/R4\| | 7.47 | \|Sag6R2L\|/CT6 | 0.03 |
| TLL/Dr1r6L | 2.30 | Y1R1L/Y6R2L | 1.15 |
| Dr1r6L/Dr7r12L | 1.53 | | |

### 6th Embodiment

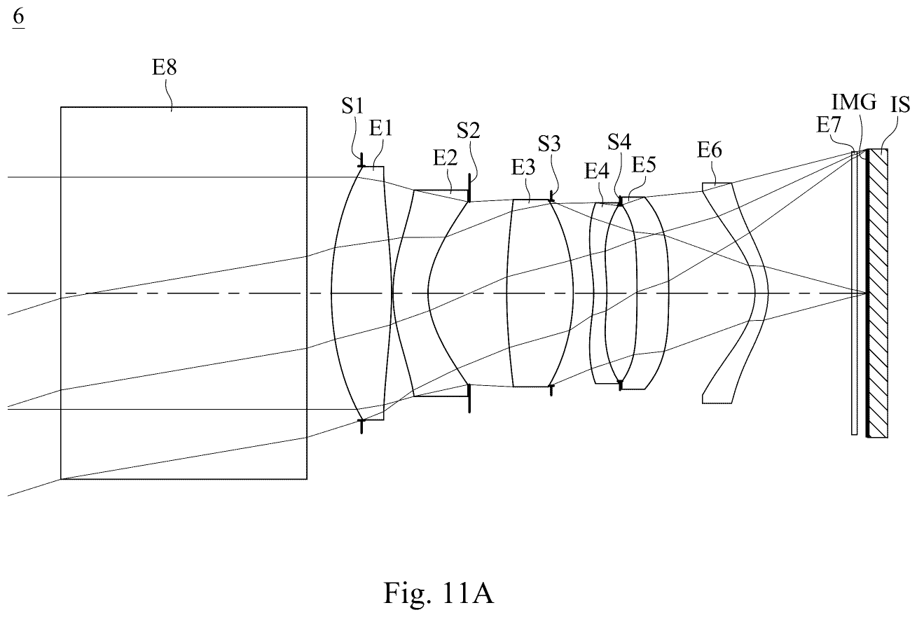

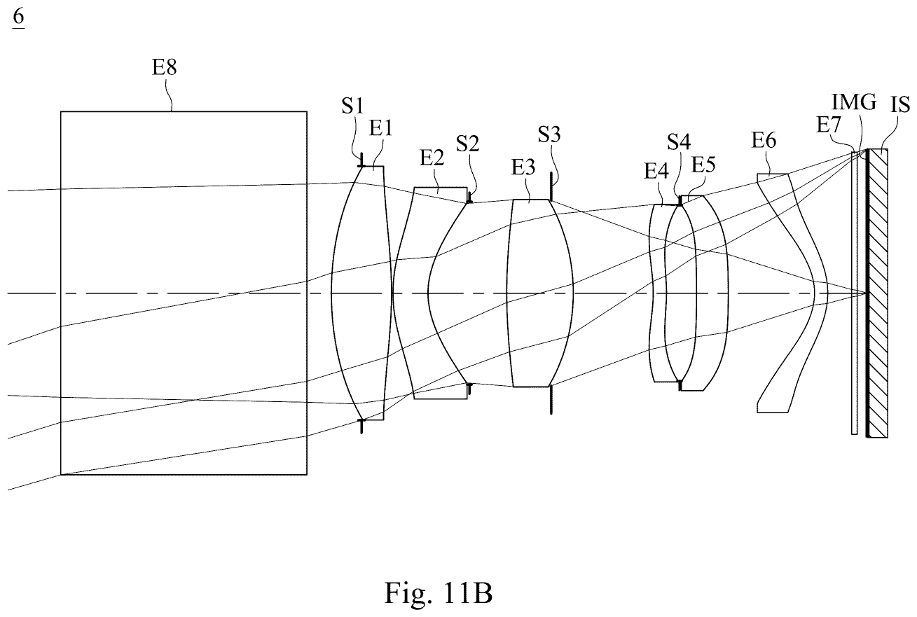

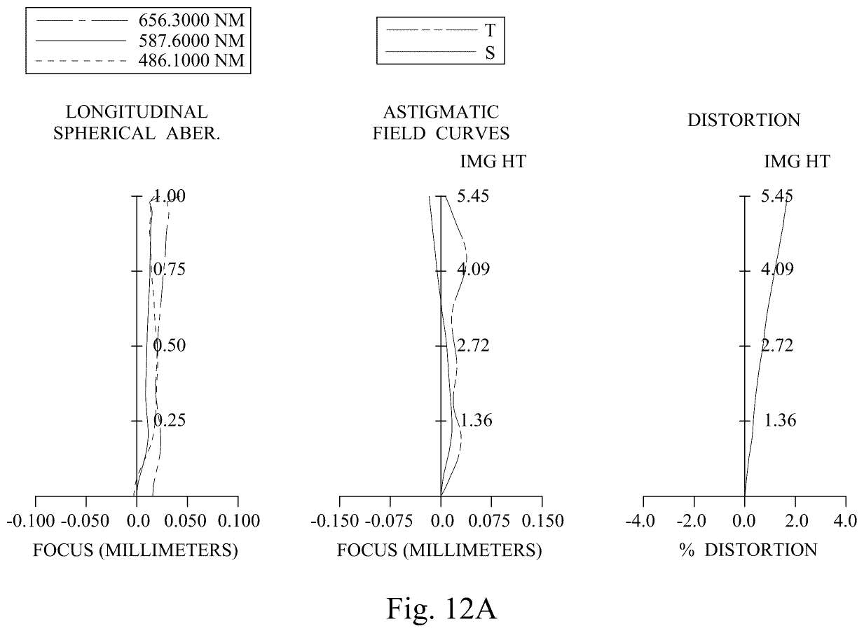

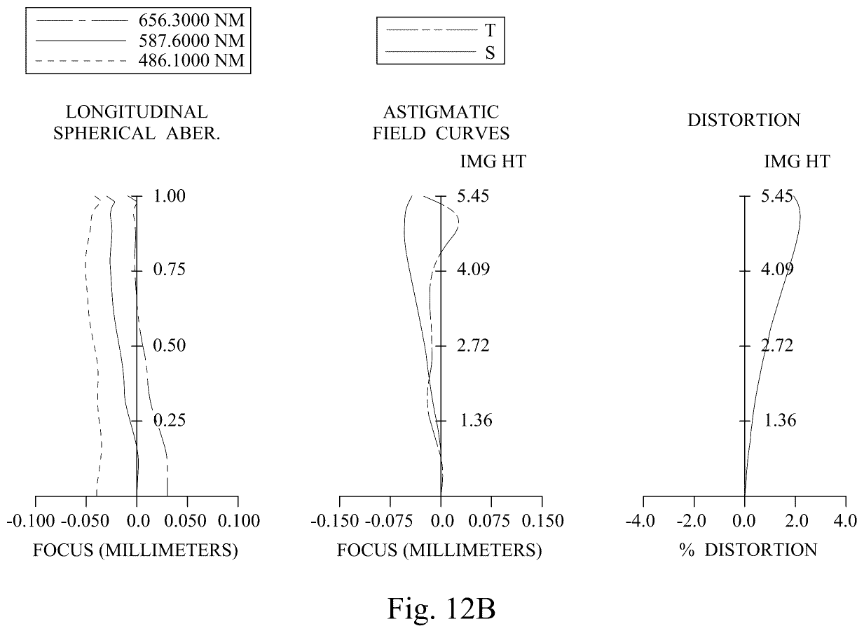

FIG. 11A is a schematic view of an imaging apparatus 6 at the 1st mode according to the 6th embodiment of the present disclosure. FIG. 11B is a schematic view of the imaging apparatus 6 at the 2nd mode according to the 6th embodiment. FIG. 12A shows spherical aberration curves, astigmatic field curves and a distortion curve of the imaging apparatus 6 of FIG. 11A. FIG. 12B shows spherical aberration curves, astigmatic field curves and a distortion curve of the imaging apparatus 6 of FIG. 11B. In FIG. 11A and FIG. 11B, the imaging apparatus 6 includes an optical photographing lens assembly (its reference numeral is omitted) and an image sensor IS. The optical photographing lens assembly includes, in order from an object side to an image side along an optical path, a reflective element E8, a stop S1, a first lens element E1, a second lens element E2, a stop S2, a third lens element E3, a stop S3, a fourth lens element E4, a stop S4, a fifth lens element E5, a sixth lens element E6, a filter E7 and an image surface IMG, wherein the image sensor IS is disposed on the image surface IMG of the optical photographing lens assembly. The optical photographing lens assembly includes six lens elements (E1, E2, E3, E4, E5, E6) without additional one or more lens elements inserted between the first lens element E1 and the sixth lens element E6. Further, the optical photographing lens assembly includes two lens element groups, which are in order from the object side to the image side along the optical path, a first lens element group and a second lens element group. As shown in FIG. 11A and FIG. 11B, according to the 6th embodiment, the first lens element group includes the first lens element E1, the second lens element E2 and the third lens element E3, the second lens element group includes the fourth lens element E4, the fifth lens element E5 and the sixth lens element E6. When the imaged object is moved from infinite to macro, the optical photographing lens assembly is changed from the 1st mode to the 2nd mode. During the focusing movement (that is, the 1st mode is changed to the 2nd mode), the second lens element group is moved towards to the image side along the optical axis relative to the first lens element group; during the focusing movement, all lens elements in each of the lens element groups have no relative movement. Further, at the 1st mode in FIG. 11A, the stop S2 is the aperture stop in the optical photographing lens assembly; at the 2nd mode in FIG. 11B, the stop S3 is the aperture stop in the optical photographing lens assembly.

The first lens element E1 with positive refractive power has an object-side surface being convex in a paraxial region thereof and an image-side surface being convex in a paraxial region thereof. The first lens element E1 is made of glass material, and has the object-side surface and the image-side surface being both aspheric. Furthermore, the image-side surface of the first lens element E1 includes two inflection points.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Furthermore, the object-side surface of the second lens element includes one inflection point.

The third lens element E3 with positive refractive power has an object-side surface being convex in a paraxial region thereof and an image-side surface being convex in a paraxial region thereof. The third lens element E3 is made of plastic material, and has the object-side surface and the image-side surface being both aspheric.

The fourth lens element E4 with negative refractive power has an object-side surface being concave in a paraxial region thereof and an image-side surface being convex in a paraxial region thereof. The fourth lens element E4 is made of plastic material, and has the object-side surface and the image-side surface being both aspheric. Furthermore, the object-side surface of the fourth lens element E4 includes one inflection point and a convex critical point, and the image-side surface of the fourth lens element E4 includes one inflection point and a concave critical point.

The fifth lens element E5 with positive refractive power has an object-side surface being concave in a paraxial region thereof and an image-side surface being convex in a paraxial region thereof. The fifth lens element E5 is made of plastic material, and has the object-side surface and the image-side surface being both aspheric. Furthermore, the object-side surface of the fifth lens element E5 includes one inflection point, and the image-side surface of the fifth lens element E5 includes one inflection point.

The sixth lens element E6 with negative refractive power has an object-side surface being concave in a paraxial region thereof and an image-side surface being convex in a paraxial region thereof. The sixth lens element E6 is made of plastic material, and has the object-side surface and the image-side surface being both aspheric. Furthermore, the object-side surface of the sixth lens element E6 includes two inflection points, and the image-side surface of the sixth lens element E6 includes two inflection points.

According to the 6th embodiment, the reflective element E8 is disposed between the imaged object and the first lens element E1, that is, the reflective element E8 is at the most object side of the optical photographing lens assembly, wherein, according to the 6th embodiment, the reflective element E8 is a prism, which is made of glass material.

The filter E7 is made of glass material, which is located between the sixth lens element E6 and the image surface IMG in order, and will not affect the focal length of the optical photographing lens assembly.

The detailed optical data of the 6th embodiment are shown in Table 6A and the aspheric surface data are shown in Table 6B below.

TABLE 6A
6th Embodiment

| Surface | | | | | | | | Focal |
|---|---|---|---|---|---|---|---|---|
| # | | Curvature Radius | | Thickness | Material | Index | Abbe # | Length |
| 0 | Object | Plano | | D0 | | | | |
| 1 | Prism | Plano | | 9.300 | Glass | 1.785 | 25.7 | — |
| 2 | | Plano | | 2.062 | | | | |
| 3 | Stop | Plano | | −1.139 | | | | |
| 4 | Lens 1 | 11.7057 | ASP | 2.274 | Glass | 1.497 | 81.6 | 13.81 |
| 5 | | −15.5308 | ASP | 0.055 | | | | |
| 6 | Lens 2 | 5.2442 | ASP | 1.320 | Plastic | 1.587 | 28.3 | −14.38 |
| 7 | | 2.9338 | ASP | 1.566 | | | | |
| 8 | Stop | Plano | | 1.410 | | | | |
| 9 | Lens 3 | 21.1472 | ASP | 2.513 | Plastic | 1.545 | 56.1 | 10.24 |
| 10 | | −7.2609 | ASP | −0.832 | | | | |
| 11 | Stop | Plano | | D1 | | | | |
| 12 | Lens 4 | −5.1396 | ASP | 0.500 | Plastic | 1.534 | 56.0 | −41.38 |
| 13 | | −6.9231 | ASP | 0.494 | | | | |
| 14 | Stop | Plano | | 0.643 | | | | |
| 15 | Lens 5 | −35.7143 | ASP | 1.200 | Plastic | 1.614 | 25.6 | 160.79 |
| 16 | | −26.5574 | ASP | 3.256 | | | | |
| 17 | Lens 6 | −2.2825 | ASP | 0.500 | Plastic | 1.614 | 25.6 | −21.57 |
| 18 | | −2.9878 | ASP | D2 | | | | |

| | | | | | | | |
|---|---|---|---|---|---|---|---|
| 19 | Filter | Plano | 0.210 | Glass | 1.517 | 64.2 | — |
| 20 | | Plano | 0.394 | | | | |
| 21 | Image | Plano | | | | | |

Reference wavelength is 587.6 nm (d-line).
Effective radius of Surface 3 (stop S1) is 4.800 mm.
Effective radius of Surface 8 (stop S2) is 3.457 mm.
Effective radius of Surface 11 (stop S3) is 3.500 mm.
Effective radius of Surface 14 (stop S4) is 3.321 mm.

TABLE 6B
Aspheric Coefficients

| Surface # | 4 | 5 | 6 | 7 |
|---|---|---|---|---|
| k= | 5.98343000E−01 | −1.13230000E+01 | −1.14472000E+00 | −1.26825000E+00 |
| A4= | 5.57943340E−04 | 8.65296406E−04 | −4.49856654E−03 | −5.70095148E−03 |
| A6= | −7.70387356E−05 | 7.31595610E−05 | 2.83329895E−04 | 5.70739024E−04 |
| A8= | 1.15461968E−05 | −1.91871880E−05 | −2.07897413E−05 | −1.35822820E−04 |
| A10= | −1.28159368E−06 | 1.69310481E−06 | 5.28972203E−06 | 7.80616384E−05 |
| A12= | 9.41519641E−08 | −4.64856781E−08 | −2.21719277E−06 | −3.27056828E−05 |
| A14= | −4.12084126E−09 | −3.10692645E−09 | 5.16041096E−07 | 8.79728953E−06 |
| A16= | 9.37226573E−11 | 2.94691827E−10 | −7.13125295E−08 | −1.57179346E−06 |
| A18= | −6.66491622E−13 | −9.09729119E−12 | 6.25103574E−09 | 1.89627742E−07 |
| A20= | −6.15422679E−15 | 1.00897608E−13 | −3.53959650E−10 | −1.53089453E−08 |
| A22= | | | 1.26257337E−11 | 7.93677505E−10 |
| A24= | | | −2.59411207E−13 | −2.39089712E−11 |
| A26= | | | 2.35186605E−15 | 3.18268166E−13 |
| Surface # | 9 | 10 | 12 | 13 |
| k= | 1.54278000E+01 | −2.58026000E−01 | −2.71016000E+00 | −3.06831000E+00 |
| A4= | −7.07900035E−04 | −1.06621420E−04 | 2.12025181E−02 | 2.40331497E−02 |
| A6= | 3.49989071E−04 | −9.56885721E−05 | −2.64800053E−03 | −2.91138718E−03 |
| A8= | −3.43452457E−04 | 9.42388019E−05 | 9.27190663E−05 | 3.10407222E−04 |
| A10= | 1.98952968E−04 | −5.47825054E−05 | 4.07179821E−05 | −1.34047685E−04 |
| A12= | −7.62313564E−05 | 1.91983634E−05 | −1.93756293E−06 | 7.82979388E−05 |
| A14= | 2.01538843E−05 | −4.34671649E−06 | −3.84878745E−06 | −2.78766632E−05 |
| A16= | −3.74947016E−06 | 6.59812980E−07 | 1.43726875E−06 | 6.38204601E−06 |
| A18= | 4.93928796E−07 | −6.79861826E−08 | −2.74823623E−07 | −9.83538335E−07 |
| A20= | −4.57693798E−08 | 4.70235774E−09 | 3.28838133E−08 | 1.03071961E−07 |
| A22= | 2.91526553E−09 | −2.09347393E−10 | −2.54543697E−09 | −7.21437385E−09 |
| A24= | −1.21439974E−10 | 5.42764600E−12 | 1.23750943E−10 | 3.20617689E−10 |
| A26= | 2.97764413E−12 | −6.23452032E−14 | −3.42462120E−12 | −8.10762492E−12 |
| A28= | −3.25732606E−14 | | 4.09083159E−14 | 8.78630836E−14 |
| Surface # | 15 | 16 | 17 | 18 |
| k= | −9.09312000E+01 | −9.78283000E+01 | −1.29868000E+00 | −1.64456000E+00 |
| A4= | 1.55844402E−03 | −2.40733457E−03 | 3.82696588E−03 | 4.70370970E−03 |
| A6= | −9.40086486E−04 | −9.27431643E−04 | 7.03085350E−04 | −8.18000773E−04 |
| A8= | −2.85453827E−04 | 4.89728094E−04 | −7.84283704E−04 | 4.84639375E−04 |
| A10= | 3.71779700E−04 | −2.44063343E−04 | 4.75218794E−04 | −1.69423596E−04 |
| A12= | −2.04506816E−04 | 8.84327500E−05 | −1.83201993E−04 | 3.74574441E−05 |
| A14= | 7.17891154E−05 | −2.24714316E−05 | 4.73812669E−05 | −5.57385164E−06 |
| A16= | −1.72592290E−05 | 4.02814017E−06 | −8.51328391E−06 | 5.76286332E−07 |
| A18= | 2.89965462E−06 | −5.11065669E−07 | 1.08522196E−06 | −4.19565079E−08 |
| A20= | −3.39828400E−07 | 4.55678124E−08 | −9.88844874E−08 | 2.14581948E−09 |
| A22= | 2.71925037E−08 | −2.79022449E−09 | 6.39888521E−09 | −7.55599807E−11 |
| A24= | −1.41354358E−09 | 1.11688736E−10 | −2.87153510E−10 | 1.74783916E−12 |
| A26= | 4.29135058E−11 | −2.63369232E−12 | 8.49283683E−12 | −2.39858066E−14 |
| A28= | −5.75493455E−13 | 2.77982035E−14 | −1.48797901E−13 | 1.48747273E−16 |
| A30= | | | 1.16900871E−15 | |

Please refer to Table 6A, the object distances and the data of DO, D1 and D2 in Table 6A of the 6th embodiment at the 1st mode and the 2nd mode are listed in Table 6C as below.

TABLE 6C
6th Embodiment

| | 1st mode | | 2nd mode |
|---|---|---|---|
| Object distance (mm) | infinite | Object distance (mm) | 120.123 |
| D0 (mm) | infinite | D0 (mm) | 109.900 |
| D1 (mm) | 1.603 | D1 (mm) | 3.853 |
| D2 (mm) | 3.150 | D2 (mm) | 0.900 |

In the 6th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 6th embodiment, so an explanation in this regard will not be provided again.

Moreover, these parameters can be calculated from Table 6A, Table 6B and Table 6C as the following values and satisfy the following conditions in Table 6D:

TABLE 6D
6th Embodiment

| | | | |
|---|---|---|---|
| fL [mm] | 17.05 | CT1/T23L | 0.76 |
| FnoL | 1.94 | CT1/CT3 | 0.90 |
| HFOVL [deg.] | 17.4 | CT2/CT3 | 0.53 |
| FOVL [deg.] | 34.8 | CT3/(CT4 + T45L + CT5) | 0.89 |
| fS [mm] | 13.81 | CT4/T23L | 0.17 |
| FnoS | 1.94 | (CT4 + CT5)/T56L | 0.52 |
| HFOVS [deg.] | 17.1 | CT6/T56L | 0.15 |
| FOVS [deg.] | 34.2 | T45L/T23L | 0.38 |
| TLL/TLS | 1.00 | (R2 + R3)/(R2 − R3) | 0.50 |
| BLL/BLS | 2.50 | (R3 − R4)/(R3 + R4) | 0.28 |
| (TG1G2S − TG1G2L)/TG1G2L | 2.92 | (R5 + R6)/(R5 − R6) | 0.49 |
| BLL/ImgH | 0.69 | R4/R1 | 0.25 |
| \|f3/f6\| | 0.47 | V4 + V6 | 81.6 |
| \|f3/f5\| | 0.06 | \|Sag3R1L\|/CT3 | 0.10 |
| \|f2/R3\| + \|f2/R4\| | 7.64 | \|Sag6R2L\|/CT6 | 2.78 |
| TLL/Dr1r6L | 2.22 | Y1R1L/Y6R2L | 1.15 |
| Dr1r6L/Dr7r12L | 1.39 | | |

### 7th Embodiment

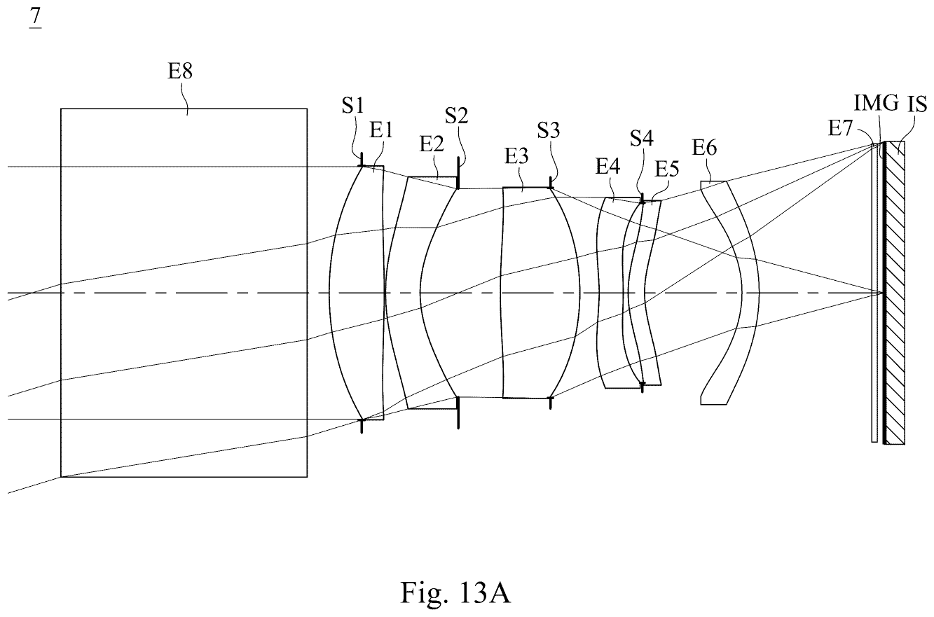

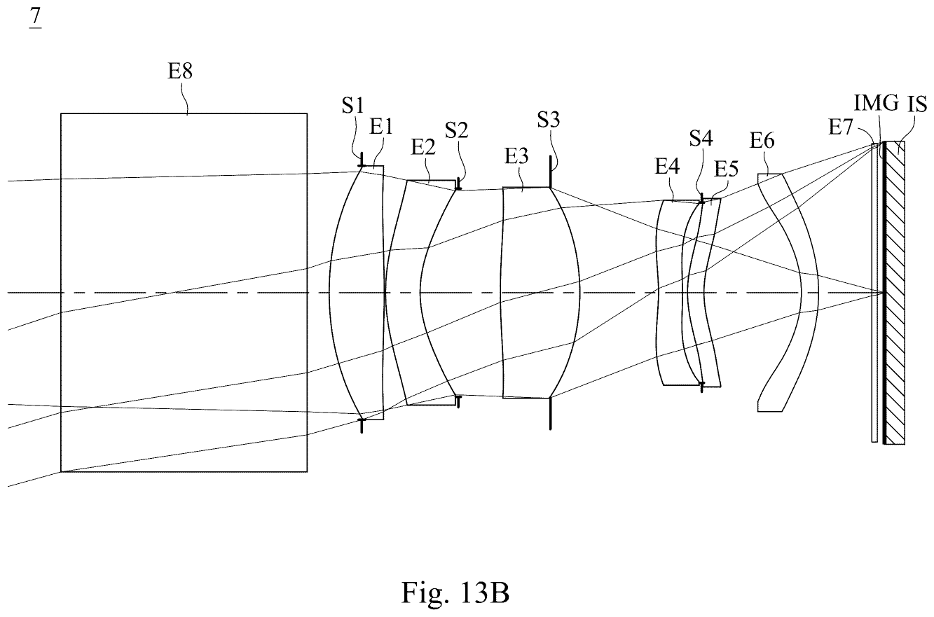

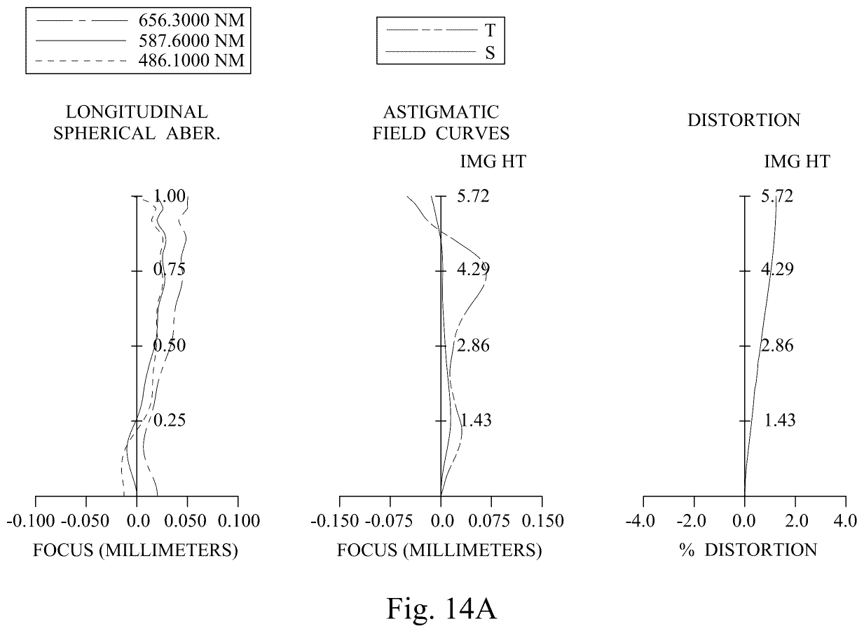

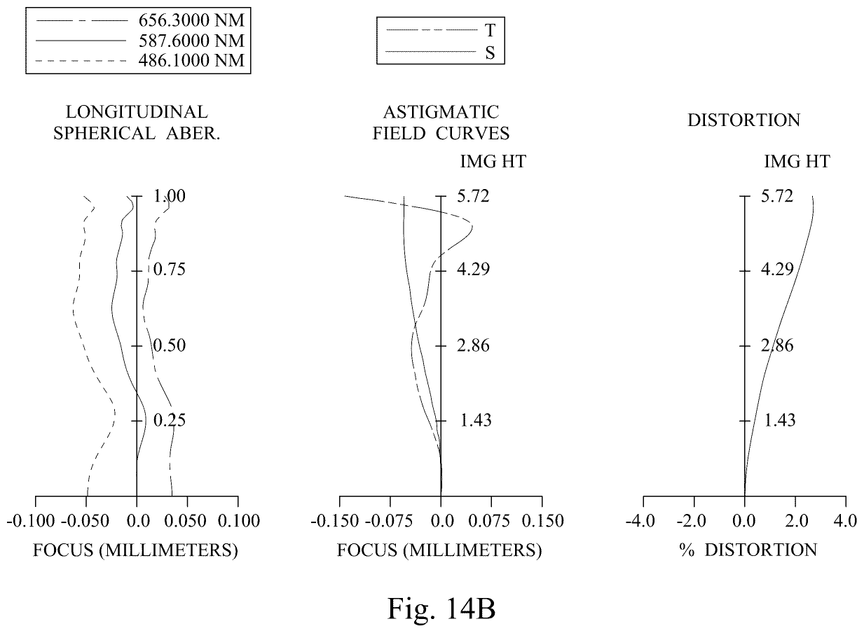

FIG. 13A is a schematic view of an imaging apparatus 7 at the 1st mode according to the 7th embodiment of the present disclosure. FIG. 13B is a schematic view of the imaging apparatus 7 at the 2nd mode according to the 7th embodiment. FIG. 14A shows spherical aberration curves, astigmatic field curves and a distortion curve of the imaging apparatus 7 of FIG. 13A. FIG. 14B shows spherical aberration curves, astigmatic field curves and a distortion curve of the imaging apparatus 7 of FIG. 13B. In FIG. 13A and FIG. 13B, the imaging apparatus 7 includes an optical photographing lens assembly (its reference numeral is omitted) and an image sensor IS. The optical photographing lens assembly includes, in order from an object side to an image side along an optical path, a reflective element E8, a stop S1, a first lens element E1, a second lens element E2, a stop S2, a third lens element E3, a stop S3, a fourth lens element E4, a stop S4, a fifth lens element E5, a sixth lens element E6, a filter E7 and an image surface IMG, wherein the image sensor IS is disposed on the image surface IMG of the optical photographing lens assembly. The optical photographing lens assembly includes six lens elements (E1, E2, E3, E4, E5, E6) without additional one or more lens elements inserted between the first lens element E1 and the sixth lens element E6. Further, the optical photographing lens assembly includes two lens element groups, which are in order from the object side to the image side along the optical path, a first lens element group and a second lens element group. As shown in FIG. 13A and FIG. 13B, according to the 7th embodiment, the first lens element group includes the first lens element E1, the second lens element E2 and the third lens element E3, the second lens element group includes the fourth lens element E4, the fifth lens element E5 and the sixth lens element E6. When the imaged object is moved from infinite to macro, the optical photographing lens assembly is changed from the 1st mode to the 2nd mode. During the focusing movement (that is, the 1st mode is changed to the 2nd mode), the second lens element group is moved towards to the image side along the optical axis relative to the first lens element group; during the focusing movement, all lens elements in each of the lens element groups have no relative movement. Further, at the 1st mode in FIG. 13A, the stop S2 is the aperture stop in the optical photographing lens assembly; at the 2nd mode in FIG. 13B, the stop S3 is the aperture stop in the optical photographing lens assembly.

The first lens element E1 with positive refractive power has an object-side surface being convex in a paraxial region thereof and an image-side surface being convex in a paraxial region thereof. The first lens element E1 is made of glass material, and has the object-side surface and the image-side surface being both aspheric. Furthermore, the image-side surface of the first lens element E1 includes two inflection points and a concave critical point.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Furthermore, the object-side surface of the second lens element includes one inflection point.

The third lens element E3 with positive refractive power has an object-side surface being convex in a paraxial region thereof and an image-side surface being convex in a paraxial region thereof. The third lens element E3 is made of plastic material, and has the object-side surface and the image-side surface being both aspheric. Furthermore, the object-side surface of the third lens element E3 includes two inflection points and a concave critical point.

The fourth lens element E4 with negative refractive power has an object-side surface being concave in a paraxial region thereof and an image-side surface being convex in a paraxial region thereof. The fourth lens element E4 is made of plastic material, and has the object-side surface and the image-side surface being both aspheric. Furthermore, the object-side surface of the fourth lens element E4 includes one inflection point and a convex critical point, and the image-side surface of the fourth lens element E4 includes one inflection point and a concave critical point.

The fifth lens element E5 with negative refractive power has an object-side surface being convex in a paraxial region thereof and an image-side surface being concave in a paraxial region thereof. The fifth lens element E5 is made of plastic material, and has the object-side surface and the image-side surface being both aspheric. Furthermore, the object-side surface of the fifth lens element E5 includes three inflection points, and the image-side surface of the fifth lens element E5 includes three inflection points.

The sixth lens element E6 with negative refractive power has an object-side surface being concave in a paraxial region thereof and an image-side surface being convex in a paraxial region thereof. The sixth lens element E6 is made of plastic material, and has the object-side surface and the image-side surface being both aspheric. Furthermore, the object-side surface of the sixth lens element E6 includes one inflection point, and the image-side surface of the sixth lens element E6 includes two inflection points.

According to the 7th embodiment, the reflective element E8 is disposed between the imaged object and the first lens element E1, that is, the reflective element E8 is at the most object side of the optical photographing lens assembly, wherein, according to the 7th embodiment, the reflective element E8 is a prism, which is made of glass material.

The filter E7 is made of glass material, which is located between the sixth lens element E6 and the image surface IMG in order, and will not affect the focal length of the optical photographing lens assembly.

The detailed optical data of the 7th embodiment are shown in Table 7A and the aspheric surface data are shown in Table 7B below.

TABLE 7A
7th Embodiment

| Surface | | | | | | | | Focal |
|---|---|---|---|---|---|---|---|---|
| # | | Curvature Radius | | Thickness | Material | Index | Abbe # | Length |
| 0 | Object | Plano | | D0 | | | | |
| 1 | Prism | Plano | | 9.300 | Glass | 1.785 | 25.7 | — |
| 2 | | Plano | | 2.063 | | | | |
| 3 | Stop | Plano | | −1.231 | | | | |
| 4 | Lens 1 | 10.3368 | ASP | 2.080 | Glass | 1.497 | 81.6 | 17.00 |
| 5 | | −43.1590 | ASP | 0.050 | | | | |
| 6 | Lens 2 | 6.8007 | ASP | 1.305 | Plastic | 1.639 | 23.5 | −22.10 |
| 7 | | 4.2467 | ASP | 1.442 | | | | |
| 8 | Stop | Plano | | 1.590 | | | | |
| 9 | Lens 3 | 24.7002 | ASP | 3.000 | Plastic | 1.545 | 56.1 | 11.50 |
| 10 | | −8.0416 | ASP | −1.110 | | | | |
| 11 | Stop | Plano | | D1 | | | | |
| 12 | Lens 4 | −7.3989 | ASP | 0.908 | Plastic | 1.545 | 56.1 | −46.75 |
| 13 | | −10.8789 | ASP | 0.724 | | | | |
| 14 | Stop | Plano | | −0.537 | | | | |
| 15 | Lens 5 | 4.4349 | ASP | 0.620 | Plastic | 1.639 | 23.5 | −71.57 |
| 16 | | 3.8225 | ASP | 3.679 | | | | |
| 17 | Lens 6 | −4.1860 | ASP | 0.650 | Plastic | 1.534 | 56.0 | −26.21 |
| 18 | | −6.2941 | ASP | D2 | | | | |

| | | | | | | | |
|---|---|---|---|---|---|---|---|
| 19 | Filter | Plano | 0.210 | Glass | 1.517 | 64.2 | — |
| 20 | | Plano | 0.274 | | | | |
| 21 | Image | Plano | — | | | | |

Reference wavelength is 587.6 nm (d-line).
Effective radius of Surface 3 (stop S1) is 4.800 mm.
Effective radius of Surface 8 (stop S2) is 3.937 mm.
Effective radius of Surface 11 (stop S3) is 3.970 mm.
Effective radius of Surface 14 (stop S4) is 3.405 mm.

TABLE 7B
Aspheric Coefficients

| Surface # | 4 | 5 | 6 | 7 |
|---|---|---|---|---|
| k= | 0.00000000E+00 | 0.00000000E+00 | 0.00000000E+00 | −1.00000000E+00 |
| A4= | 2.44667474E−04 | −1.33919763E−03 | −4.20451452E−03 | −3.22007019E−03 |
| A6= | −6.60627412E−05 | 7.86796936E−04 | 6.67519815E−04 | 1.34554625E−04 |
| A8= | 2.03505906E−05 | −1.42905975E−04 | −9.26888660E−05 | −1.36017725E−05 |
| A10= | −3.10373225E−06 | 1.50506039E−05 | 4.38430395E−06 | 9.30850064E−06 |
| A12= | 2.78875900E−07 | −9.95419893E−07 | 5.22213985E−07 | −3.89098895E−06 |
| A14= | −1.54511987E−08 | 4.14324868E−08 | −1.14609908E−07 | 8.59508225E−07 |
| A16= | 5.17867345E−10 | −1.03730349E−09 | 1.14874407E−08 | −1.13754581E−07 |
| A18= | −9.61281818E−12 | 1.39160487E−11 | −8.01955481E−10 | 9.55587147E−09 |
| A20= | 7.56503553E−14 | −7.34152197E−14 | 4.12920264E−11 | −5.13989211E−10 |
| A22= | | | −1.46437418E−12 | 1.71245005E−11 |
| A24= | | | 3.09763547E−14 | −3.20849752E−13 |
| A26= | | | −2.88950305E−16 | 2.57369397E−15 |
| Surface # | 9 | 10 | 12 | 13 |
| k= | 0.00000000E+00 | 0.00000000E+00 | 0.00000000E+00 | 0.00000000E+00 |
| A4= | −4.29819665E−04 | 3.18179111E−04 | 1.99502476E−02 | 2.72958262E−02 |
| A6= | −3.09828114E−04 | −4.34558477E−04 | −5.13099363E−03 | −1.08710347E−02 |
| A8= | 2.32736161E−04 | 2.04469603E−04 | 1.75780240E−03 | 5.15595665E−03 |
| A10= | −1.21090771E−04 | −6.78356476E−05 | −4.99600700E−04 | −1.78369794E−03 |
| A12= | 4.09529870E−05 | 1.56036329E−05 | 1.02620639E−04 | 4.27973730E−04 |
| A14= | −9.36857713E−06 | −2.51075745E−06 | −1.45390226E−05 | −7.18152444E−05 |
| A16= | 1.48798945E−06 | 2.83836962E−07 | 1.35177716E−06 | 8.62070389E−06 |
| A18= | −1.65882501E−07 | −2.24022166E−08 | −7.24252385E−08 | −7.83830765E−07 |
| A20= | 1.29345020E−08 | 1.20719459E−09 | 9.56910849E−10 | 6.02047549E−08 |
| A22= | −6.90717352E−10 | −4.22911742E−11 | 1.44396511E−10 | −4.19998792E−09 |
| A24= | 2.40676926E−11 | 8.67455394E−13 | −1.02442527E−11 | 2.38444864E−10 |
| A26= | −4.92969226E−13 | −7.90056948E−15 | 2.85436418E−13 | −8.68679872E−12 |
| A28= | 4.50214418E−15 | | −2.99458271E−15 | 1.42054706E−13 |
| Surface # | 15 | 16 | 17 | 18 |
| k= | 0.00000000E+00 | 0.00000000E+00 | −1.00000000E+00 | 0.00000000E+00 |
| A4= | −7.47414475E−03 | −2.03870072E−02 | −9.75498532E−04 | 6.69160209E−04 |
| A6= | −4.08699496E−03 | 3.71515475E−03 | 1.83065269E−03 | 8.16467211E−04 |
| A8= | 2.74580258E−03 | −1.68018055E−03 | −1.21549584E−03 | −5.29960370E−04 |
| A10= | −9.00730532E−04 | 1.01878983E−03 | 5.04561569E−04 | 2.07224104E−04 |
| A12= | 1.63817664E−04 | −4.74427485E−04 | −1.39893425E−04 | −5.37251940E−05 |
| A14= | −1.23217986E−05 | 1.50065365E−04 | 2.66590740E−05 | 9.56440354E−06 |
| A16= | −1.27611340E−06 | −3.25175554E−05 | −3.53215626E−06 | −1.19244376E−06 |
| A18= | 4.25498623E−07 | 4.88736296E−06 | 3.23704538E−07 | 1.04876740E−07 |
| A20= | −4.76050894E−08 | −5.09075961E−07 | −1.99118973E−08 | −6.46838277E−09 |
| A22= | 2.69470684E−09 | 3.60537673E−08 | 7.55417083E−10 | 2.73474977E−10 |
| A24= | −6.49014608E−11 | −1.65598880E−09 | −1.28806921E−11 | −7.54201466E−12 |
| A26= | −3.85514173E−13 | 4.44596877E−11 | −1.73940079E−13 | 1.22094592E−13 |
| A28= | 3.51505757E−14 | −5.29247222E−13 | 1.18374704E−14 | −8.79101317E−16 |
| A30= | | | −1.56107263E−16 | |

Please refer to Table 7A, the object distances and the data of DO, D1 and D2 in Table 7A of the 7th embodiment at the 1st mode and the 2nd mode are listed in Table 7C as below.

TABLE 7C
7th Embodiment

| | 1st mode | | 2nd mode |
|---|---|---|---|
| Object distance (mm) | infinite | Object distance (mm) | 120.032 |
| D0 (mm) | infinite | D0 (mm) | 109.900 |
| D1 (mm) | 1.841 | D1 (mm) | 4.083 |
| D2 (mm) | 4.250 | D2 (mm) | 2.008 |

In the 7th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 7th embodiment, so an explanation in this regard will not be provided again.

Moreover, these parameters can be calculated from Table 7A, Table 7B and Table 7C as the following values and satisfy the following conditions in Table 7D:

TABLE 7D
7th Embodiment

| | | | |
|---|---|---|---|
| fL [mm] | 18.57 | CT1/T23L | 0.69 |
| FnoL | 1.95 | CT1/CT3 | 0.69 |
| HFOVL [deg.] | 16.9 | CT2/CT3 | 0.44 |
| FOVL [deg.] | 33.8 | CT3/(CT4 + T45L + CT5) | 1.75 |
| fS [mm] | 14.49 | CT4/T23L | 0.30 |
| FnoS | 1.93 | (CT4 + CT5)/T56L | 0.42 |
| HFOVS [deg.] | 16.5 | CT6/T56L | 0.18 |
| FOVS [deg.] | 33.0 | T45L/T23L | 0.06 |
| TLL/TLS | 1.00 | (R2 + R3)/(R2 − R3) | 0.73 |
| BLL/BLS | 1.90 | (R3 − R4)/(R3 + R4) | 0.23 |
| (TG1G2S − TG1G2L)/TG1G2L | 3.07 | (R5 + R6)/(R5 − R6) | 0.51 |
| BLL/ImgH | 0.83 | R4/R1 | 0.41 |
| \|f3/f6\| | 0.44 | V4 + V6 | 112.1 |
| \|f3/f5\| | 0.16 | \|Sag3R1L\|/CT3 | 0.03 |
| \|f2/R3\| + \|f2/R4\| | 8.45 | \|Sag6R2L\|/CT6 | 1.91 |
| TLL/Dr1r6L | 2.22 | Y1R1L/Y6R2L | 1.14 |
| Dr1r6L/Dr7r12L | 1.57 | | |

### 8th Embodiment

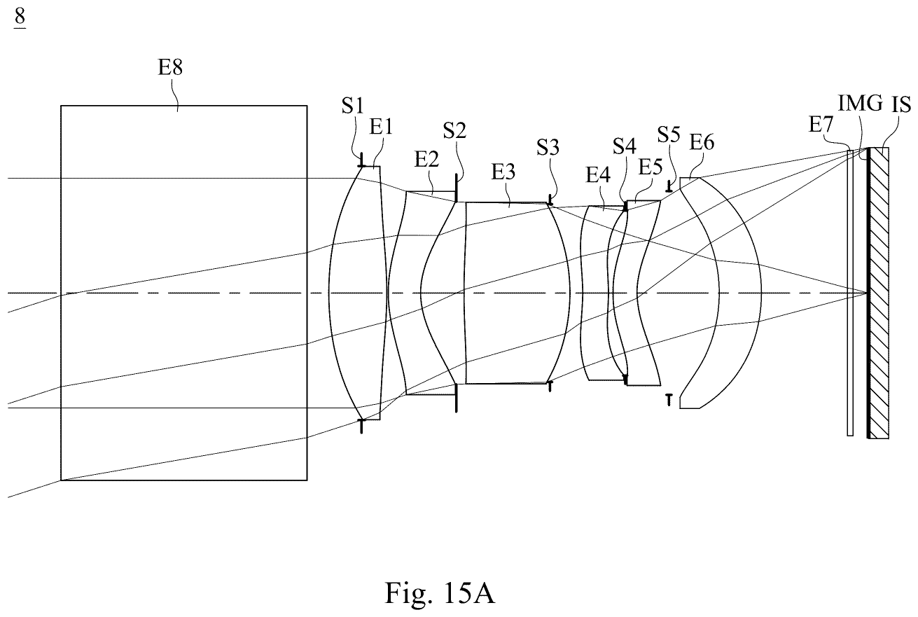

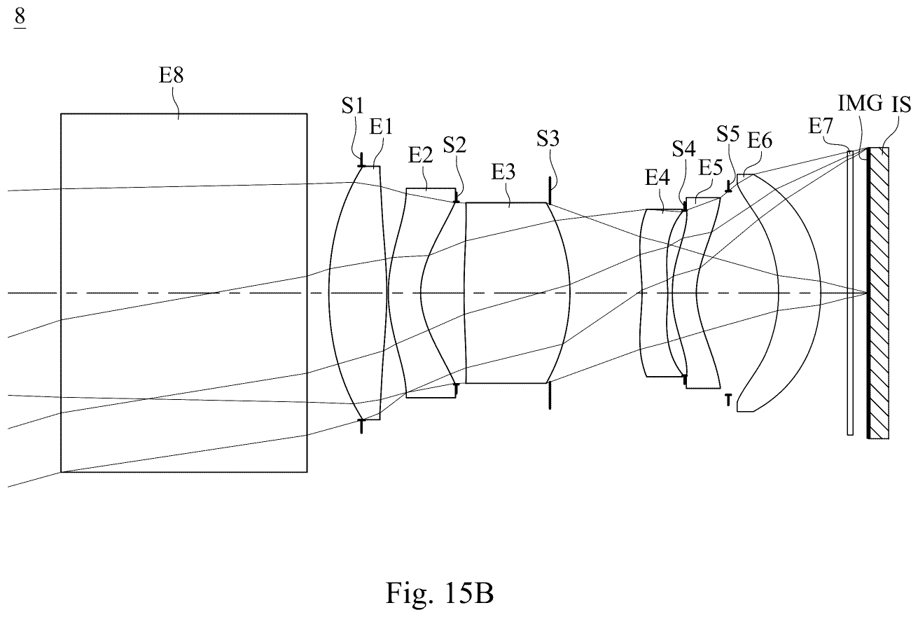

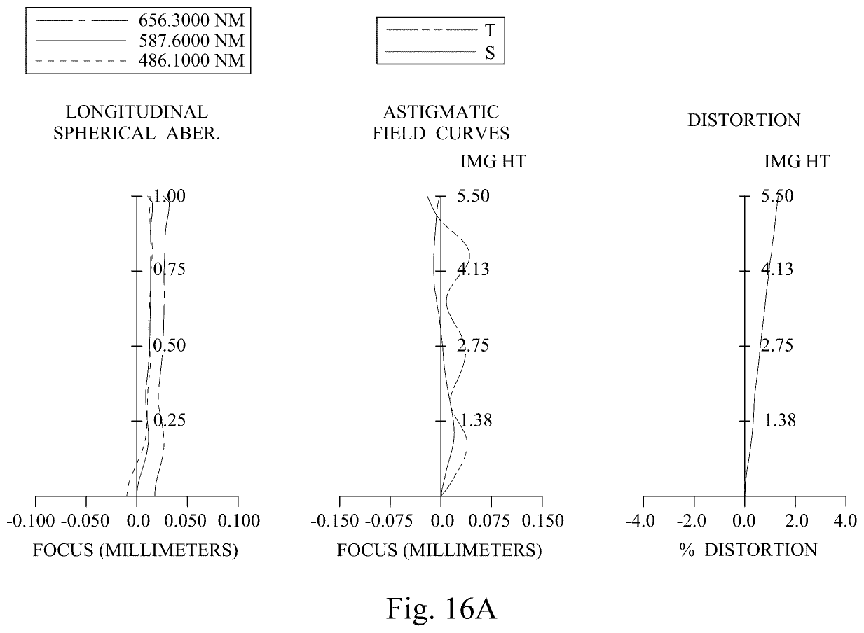

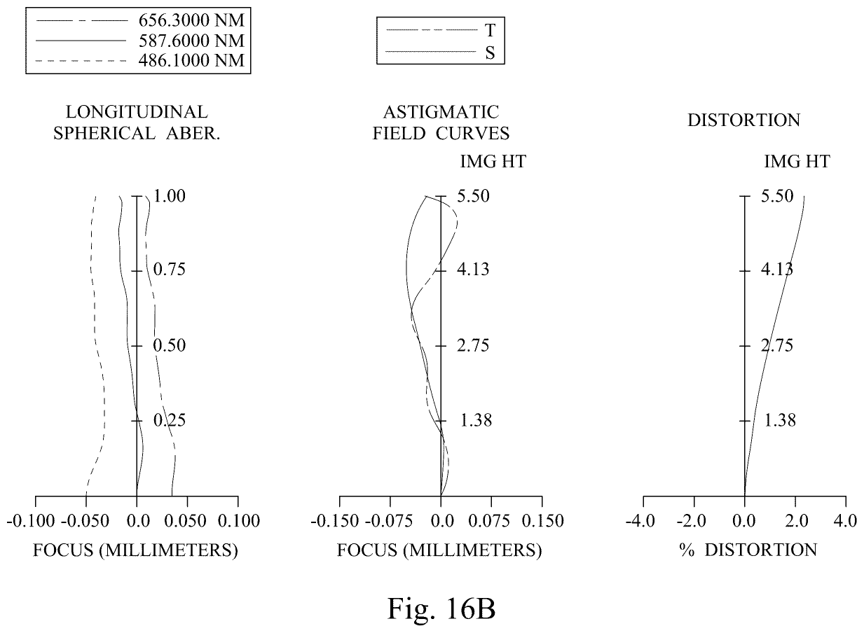

FIG. 15A is a schematic view of an imaging apparatus 8 at the 1st mode according to the 8th embodiment of the present disclosure. FIG. 15B is a schematic view of the imaging apparatus 8 at the 2nd mode according to the 8th embodiment. FIG. 16A shows spherical aberration curves, astigmatic field curves and a distortion curve of the imaging apparatus 8 of FIG. 15A. FIG. 16B shows imaging apparatus 8 of FIG. 15B. In FIG. 15A and FIG. 15B, the imaging apparatus 8 includes an optical photographing lens assembly (its reference numeral is omitted) and an image sensor IS. The optical photographing lens assembly includes, in order from an object side to an image side along an optical path, a reflective element E8, a stop S1, a first lens element E1, a second lens element E2, a stop S2, a third lens element E3, a stop S3, a fourth lens element E4, a stop S4, a fifth lens element E5, a stop S5, a sixth lens element E6, a filter E7 and an image surface IMG, wherein the image sensor IS is disposed on the image surface IMG of the optical photographing lens assembly. The optical photographing lens assembly includes six lens elements (E1, E2, E3, E4, E5, E6) without additional one or more lens elements inserted between the first lens element E1 and the sixth lens element E6. Further, the optical photographing lens assembly includes two lens element groups, which are in order from the object side to the image side along the optical path, a first lens element group and a second lens element group. As shown in FIG. 15A and FIG. 15B, according to the 8th embodiment, the first lens element group includes the first lens element E1, the second lens element E2 and the third lens element E3, the second lens element group includes the fourth lens element E4, the fifth lens element E5 and the sixth lens element E6. When the imaged object is moved from infinite to macro, the optical photographing lens assembly is changed from the 1st mode to the 2nd mode. During the focusing movement (that is, the 1st mode is changed to the 2nd mode), the second lens element group is moved towards to the image side along the optical axis relative to the first lens element group; during the focusing movement, all lens elements in each of the lens element groups have no relative movement. Further, at the 1st mode in FIG. 15A, the stop S2 is the aperture stop in the optical photographing lens assembly; at the 2nd mode in FIG. 15B, the stop S3 is the aperture stop in the optical photographing lens assembly.

The first lens element E1 with positive refractive power has an object-side surface being convex in a paraxial region thereof and an image-side surface being convex in a paraxial region thereof. The first lens element E1 is made of glass material, and has the object-side surface and the image-side surface being both aspheric. Furthermore, the image-side surface of the first lens element E1 includes two inflection points.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Furthermore, the object-side surface of the second lens element includes one inflection point and a concave critical point, and the image-side surface of the second lens element E2 includes two inflection points.

The third lens element E3 with positive refractive power has an object-side surface being convex in a paraxial region thereof and an image-side surface being convex in a paraxial region thereof. The third lens element E3 is made of plastic material, and has the object-side surface and the image-side surface being both aspheric. Furthermore, the object-side surface of the third lens element E3 includes two inflection points and a concave critical point.

The fourth lens element E4 with positive refractive power has an object-side surface being concave in a paraxial region thereof and an image-side surface being convex in a paraxial region thereof. The fourth lens element E4 is made of plastic material, and has the object-side surface and the image-side surface being both aspheric. Furthermore, the object-side surface of the fourth lens element E4 includes one inflection point and a convex critical point, and the image-side surface of the fourth lens element E4 includes one inflection point and a concave critical point.

The fifth lens element E5 with negative refractive power has an object-side surface being convex in a paraxial region thereof and an image-side surface being concave in a paraxial region thereof. The fifth lens element E5 is made of plastic material, and has the object-side surface and the image-side surface being both aspheric. Furthermore, the object-side surface of the fifth lens element E5 includes one inflection point and a concave critical point, and the image-side surface of the fifth lens element E5 includes one inflection point.

The sixth lens element E6 with positive refractive power has an object-side surface being concave in a paraxial region thereof and an image-side surface being convex in a paraxial region thereof. The sixth lens element E6 is made of plastic material, and has the object-side surface and the image-side surface being both aspheric. Furthermore, the object-side surface of the sixth lens element E6 includes one inflection point.

According to the 8th embodiment, the reflective element E8 is disposed between the imaged object and the first lens element E1, that is, the reflective element E8 is at the most object side of the optical photographing lens assembly, wherein, according to the 8th embodiment, the reflective element E8 is a prism, which is made of glass material.

The filter E7 is made of glass material, which is located between the sixth lens element E6 and the image surface IMG in order, and will not affect the focal length of the optical photographing lens assembly.

The detailed optical data of the 8th embodiment are shown in Table 8A and the aspheric surface data are shown in Table 8B below.

TABLE 8A
8th Embodiment

| Surface | | | | | | | | Focal |
|---|---|---|---|---|---|---|---|---|
| # | | Curvature Radius | | Thickness | Material | Index | Abbe # | Length |
| 0 | Object | Plano | | D0 | | | | |
| 1 | Prism | Plano | | 9.300 | Glass | 1.785 | 25.7 | — |
| 2 | | Plano | | 2.062 | | | | |
| 3 | Stop | Plano | | −1.239 | | | | |
| 4 | Lens 1 | 11.1357 | ASP | 2.190 | Glass | 1.547 | 62.7 | 12.60 |
| 5 | | −16.8247 | ASP | 0.057 | | | | |
| 6 | Lens 2 | 5.0987 | ASP | 1.222 | Plastic | 1.614 | 25.6 | −13.95 |
| 7 | | 2.9038 | ASP | 1.348 | | | | |
| 8 | Stop | Plano | | 0.296 | | | | |
| 9 | Lens 3 | 32.3376 | ASP | 4.000 | Plastic | 1.544 | 56.0 | 10.93 |
| 10 | | −6.9674 | ASP | −0.755 | | | | |
| 11 | Stop | Plano | | D1 | | | | |
| 12 | Lens 4 | −6.7947 | ASP | 0.972 | Plastic | 1.544 | 56.0 | 42.35 |
| 13 | | −5.5117 | ASP | 0.632 | | | | |
| 14 | Stop | Plano | | −0.460 | | | | |
| 15 | Lens 5 | 6.1318 | ASP | 0.906 | Plastic | 1.566 | 37.4 | −12.82 |
| 16 | | 3.1456 | ASP | 1.209 | | | | |
| 17 | Stop | Plano | | 1.898 | | | | |
| 18 | Lens 6 | −5.6981 | ASP | 1.597 | Plastic | 1.544 | 56.0 | 141.53 |
| 19 | | −5.8294 | ASP | D2 | | | | |

| | | | | | | | |
|---|---|---|---|---|---|---|---|
| 20 | Filter | Plano | 0.210 | Glass | 1.517 | 64.2 | — |
| 21 | | Plano | 0.588 | | | | |
| 22 | Image | Plano | — | | | | |

Effective radius of Surface 17 (stop S5) is 3.848 mm.
Reference wavelength is 587.6 nm (d-line).
Effective radius of Surface 3 (stop S1) is 4.800 mm.
Effective radius of Surface 8 (stop S2) is 3.449 mm.
Effective radius of Surface 11 (stop S3) is 3.360 mm.
Effective radius of Surface 14 (stop S4) is 3.118 mm.

TABLE 8B
Aspheric Coefficients

| Surface # | 4 | 5 | 6 | 7 |
|---|---|---|---|---|
| k= | 9.22772000E−01 | −3.40390000E+01 | −1.63140000E+00 | −1.58699000E+00 |
| A4= | 6.35867036E−04 | −7.69680348E−04 | −6.09923570E−03 | −5.44688881E−03 |
| A6= | −1.17621702E−04 | 5.63489525E−04 | 6.40193304E−04 | 2.24429377E−05 |
| A8= | 2.21395299E−05 | −1.01521724E−04 | −3.19158854E−05 | 3.03305066E−04 |
| A10= | −2.66191167E−06 | 1.06816630E−05 | 8.64050606E−07 | −1.16669160E−04 |
| A12= | 2.09191598E−07 | −7.29170443E−07 | −2.51266574E−06 | 2.58020799E−05 |
| A14= | −1.06525930E−08 | 3.24769382E−08 | 8.27063988E−07 | −4.06429128E−06 |
| A16= | 3.36203689E−10 | −9.06804807E−10 | −1.31371385E−07 | 4.91118255E−07 |
| A18= | −5.91558058E−12 | 1.43273900E−11 | 1.25466735E−08 | −4.61695787E−08 |
| A20= | 4.35194193E−14 | −9.73576281E−14 | −7.59808956E−10 | 3.25867621E−09 |
| A22= | | | 2.87106178E−11 | −1.59531486E−10 |
| A24= | | | −6.19918096E−13 | 4.73598324E−12 |
| A26= | | | 5.85545202E−15 | −6.32553262E−14 |
| Surface # | 9 | 10 | 12 | 13 |
| k= | 1.12452000E+01 | −5.67264000E−01 | −1.77387000E+00 | −1.45216000E+01 |
| A4= | −4.10072474E−04 | 1.63239497E−05 | 2.36179221E−02 | 7.17035290E−02 |
| A6= | −7.05547617E−06 | −2.09965357E−04 | −5.24544411E−03 | −5.33368408E−02 |
| A8= | −8.93684392E−05 | 1.12683964E−04 | 1.19386958E−03 | 3.47522431E−02 |
| A10= | 7.39524838E−05 | −4.24326331E−05 | −1.56608050E−04 | −1.72657770E−02 |
| A12= | −3.23929787E−05 | 1.14806988E−05 | −2.19331131E−05 | 6.40711706E−03 |
| A14= | 8.97347631E−06 | −2.31289188E−06 | 1.73883867E−05 | −1.77031733E−03 |
| A16= | −1.68707679E−06 | 3.47744760E−07 | −4.58492124E−06 | 3.63431302E−04 |
| A18= | 2.21208930E−07 | −3.81785981 E−08 | 7.24076873E−07 | −5.50447874E−05 |
| A20= | −2.02994221E−08 | 2.94283374E−09 | −7.45791139E−08 | 6.05495911E−06 |
| A22= | 1.28105933E−09 | −1.49680388E−10 | 5.02702536E−09 | −4.69591011E−07 |
| A24= | −5.30742955E−11 | 4.48689648E−12 | −2.12179073E−10 | 2.43113819E−08 |
| A26= | 1.30183048E−12 | −5.98342070E−14 | 5.01381023E−12 | −7.53414345E−10 |
| A28= | −1.43428889E−14 | | −4.92027326E−14 | 1.05638272E−11 |
| Surface # | 15 | 16 | 18 | 19 |
| k= | 1.40012000E+00 | −3.18725000E−01 | −3.81606000E−01 | 2.87919000E−01 |
| A4= | 4.70009823E−02 | −1.66365675E−02 | −1.95909183E−03 | −1.93912395E−04 |
| A6= | −5.12031087E−02 | 4.19379975E−04 | 2.44761611E−03 | −1.07588801E−05 |
| A8= | 3.50012693E−02 | 8.77931070E−04 | −2.18337457E−03 | 3.47124380E−05 |
| A10= | −1.76735513E−02 | −5.75631885E−04 | 1.16743920E−03 | −3.83346179E−05 |
| A12= | 6.60247394E−03 | 2.05970151E−04 | −4.09414459E−04 | 1.78340571E−05 |
| A14= | −1.82909359E−03 | −4.90847425E−05 | 9.89470496E−05 | −4.74512967E−06 |
| A16= | 3.75485048E−04 | 8.16855616E−06 | −1.69652123E−05 | 8.03003829E−07 |
| A18= | −5.67459634E−05 | −9.59788883E−07 | 2.09373713E−06 | −9.05487471E−08 |
| A20= | 6.21618270E−06 | 7.88601200E−08 | −1.86406235E−07 | 6.90531731E−09 |
| A22= | −4.79173466E−07 | −4.39356724E−09 | 1.18480636E−08 | −3.52363570E−10 |
| A24= | 2.46088339E−08 | 1.55886263E−10 | −5.23412471E−10 | 1.15347853E−11 |
| A26= | −7.54951433E−10 | −3.10181000E−12 | 1.52380299E−11 | −2.19074433E−13 |
| A28= | 1.04546680E−11 | 2.51270745E−14 | −2.62303823E−13 | 1.83544958E−15 |
| A30= | | | 2.01824672E−15 | |

Please refer to Table 8A, the object distances and the data of DO, D1 and D2 in Table 8A of the 8th embodiment at the 1st mode and the 2nd mode are listed in Table 8C as below.

TABLE 8C
8th Embodiment

| | 1st mode | | 2nd mode |
|---|---|---|---|
| Object distance (mm) | infinite | Object distance (mm) | 120.023 |
| D0 (mm) | infinite | D0 (mm) | 109.900 |
| D1 (mm) | 1.240 | D1 (mm) | 3.482 |
| D2 (mm) | 3.250 | D2 (mm) | 1.008 |

In the 8th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 8th embodiment, so an explanation in this regard will not be provided again.

Moreover, these parameters can be calculated from Table 8A, Table 8B and Table 8C as the following values and satisfy the following conditions in Table 8D:

TABLE 8D
8th Embodiment

| | | | |
|---|---|---|---|
| fL [mm] | 16.88 | CT1/T23L | 1.33 |
| FnoL | 1.94 | CT1/CT3 | 0.55 |
| HFOVL [deg.] | 17.8 | CT2/CT3 | 0.31 |
| FOVL [deg.] | 35.6 | CT3/(CT4 + T45L + CT5) | 1.95 |
| fS [mm] | 14.80 | CT4/T23L | 0.59 |
| FnoS | 2.03 | (CT4 + CT5)/T56L | 0.60 |
| HFOVS [deg.] | 16.5 | CT6/T56L | 0.51 |
| FOVS [deg.] | 33.0 | T45L/T23L | 0.10 |
| TLL/TLS | 1.00 | (R2 + R3)/(R2 − R3) | 0.53 |
| BLL/BLS | 2.24 | (R3 − R4)/(R3 + R4) | 0.27 |
| (TG1G2S − TG1G2L)/TG1G2L | 4.62 | (R5 + R6)/(R5 − R6) | 0.65 |
| BLL/ImgH | 0.74 | R4/R1 | 0.26 |
| \|f3/f6\| | 0.08 | V4 + V6 | 112.0 |
| \|f3/f5\| | 0.85 | \|Sag3R1L\|/CT3 | 0.02 |
| \|f2/R3\| + \|f2/R4\| | 7.54 | \|Sag6R2L\|/CT6 | 1.47 |
| TLL/Dr1r6L | 2.24 | Y1R1L/Y6R2L | 1.10 |
| Dr1r6L/Dr7r12L | 1.35 | | |

### 9th Embodiment

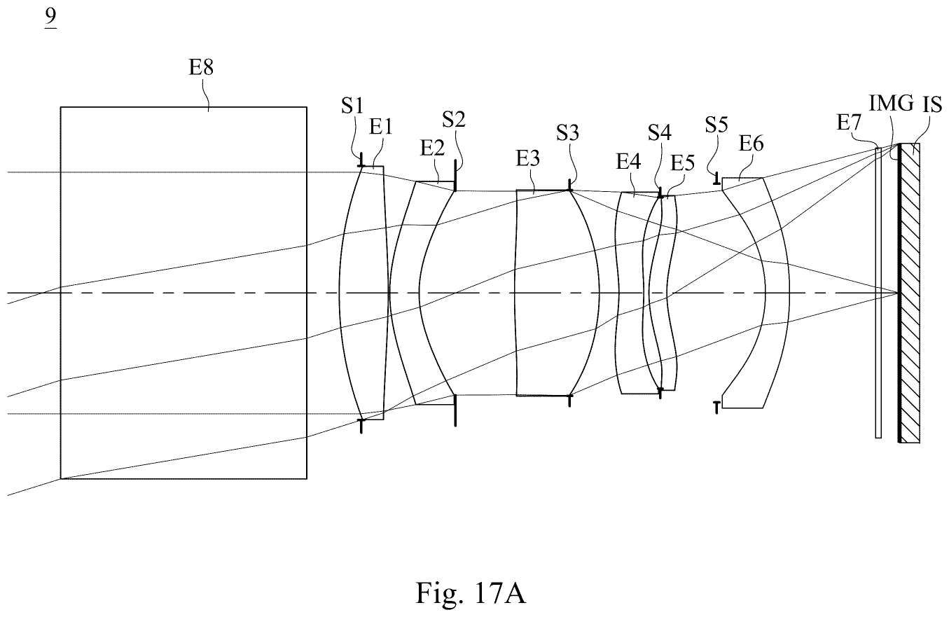

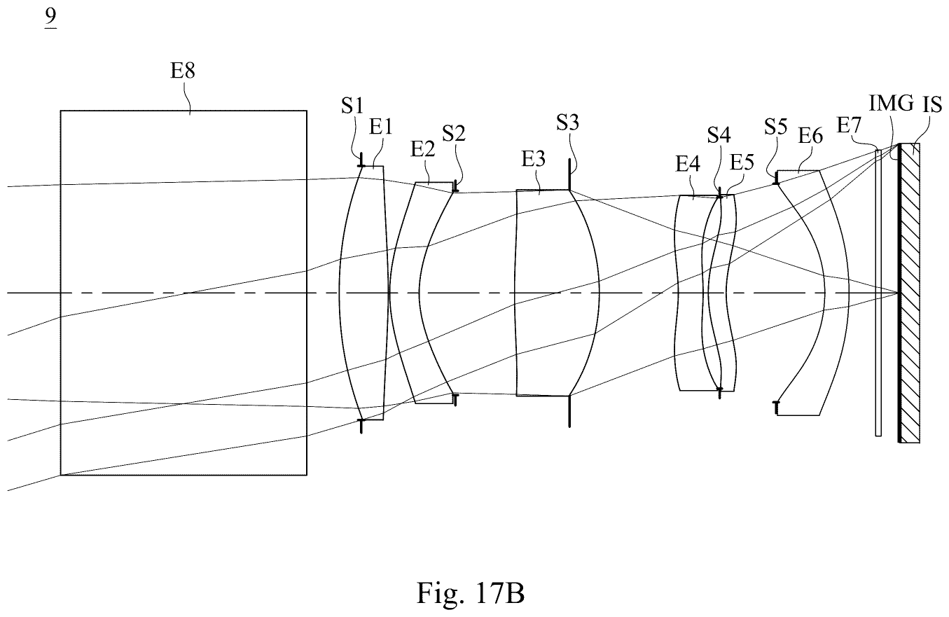

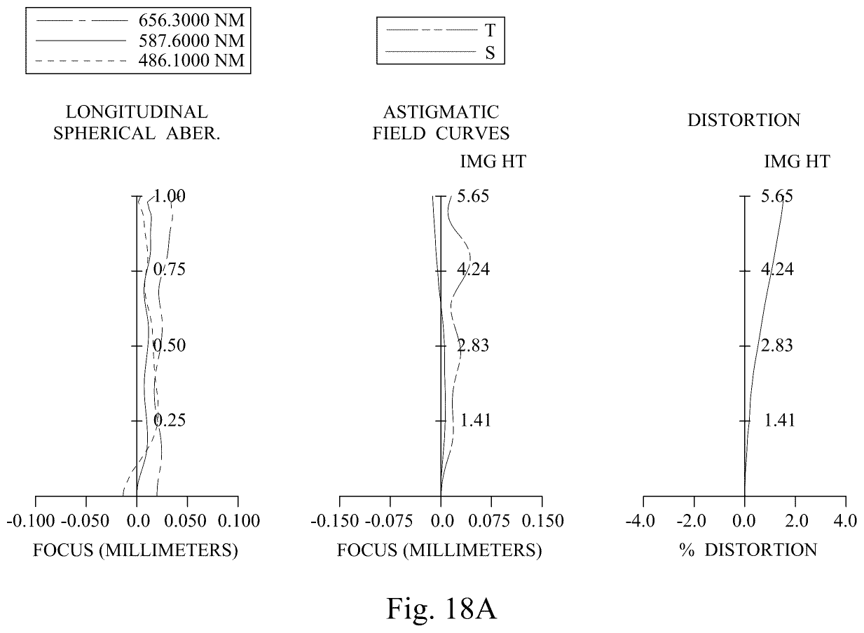

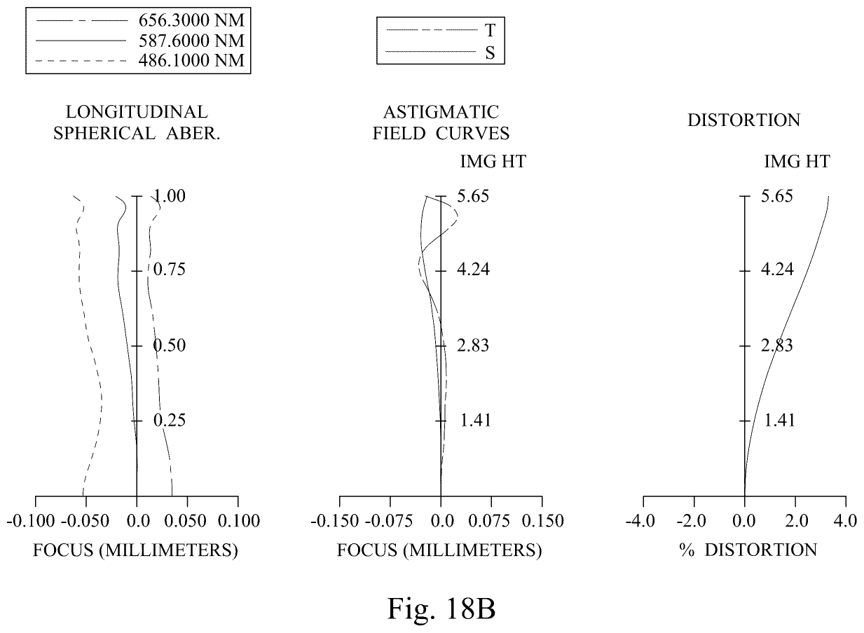

FIG. 17A is a schematic view of an imaging apparatus 9 at the 1st mode according to the 9th embodiment of the present disclosure. FIG. 17B is a schematic view of the imaging apparatus 9 at the 2nd mode according to the 9th embodiment. FIG. 18A shows spherical aberration curves, astigmatic field curves and a distortion curve of the imaging apparatus 9 of FIG. 17A. FIG. 18B shows spherical aberration curves, astigmatic field curves and a distortion curve of the imaging apparatus 9 of FIG. 17B. In FIG. 17A and FIG. 17B, the imaging apparatus 9 includes an optical photographing lens assembly (its reference numeral is omitted) and an image sensor IS. The optical photographing lens assembly includes, in order from an object side to an image side along an optical path, a reflective element E8, a stop S1, a first lens element E1, a second lens element E2, a stop S2, a third lens element E3, a stop S3, a fourth lens element E4, a stop S4, a fifth lens element E5, a stop S5, a sixth lens element E6, a filter E7 and an image surface IMG, wherein the image sensor IS is disposed on the image surface IMG of the optical photographing lens assembly. The optical photographing lens assembly includes six lens elements (E1, E2, E3, E4, E5, E6) without additional one or more lens elements inserted between the first lens element E1 and the sixth lens element E6. Further, the optical photographing lens assembly includes two lens element groups, which are in order from the object side to the image side along the optical path, a first lens element group and a second lens element group. As shown in FIG. 17A and FIG. 17B, according to the 9th embodiment, the first lens element group includes the first lens element E1, the second lens element E2 and the third lens element E3, the second lens element group includes the fourth lens element E4, the fifth lens element E5 and the sixth lens element E6. When the imaged object is moved from infinite to macro, the optical photographing lens assembly is changed from the 1st mode to the 2nd mode. During the focusing movement (that is, the 1st mode is changed to the 2nd mode), the second lens element group is moved towards to the image side along the optical axis relative to the first lens element group; during the focusing movement, all lens elements in each of the lens element groups have no relative movement. Further, at the 1st mode in FIG. 17A, the stop S2 is the aperture stop in the optical photographing lens assembly; at the 2nd mode in FIG. 17B, the stop S3 is the aperture stop in the optical photographing lens assembly.

The first lens element E1 with positive refractive power has an object-side surface being convex in a paraxial region thereof and an image-side surface being convex in a paraxial region thereof. The first lens element E1 is made of glass material, and has the object-side surface and the image-side surface being both aspheric. Furthermore, the object-side surface of the first lens element E1 includes one inflection point, and the image-side surface of the first lens element E1 includes two inflection points.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Furthermore, the object-side surface of the second lens element E2 includes one inflection point.

The third lens element E3 with positive refractive power has an object-side surface being convex in a paraxial region thereof and an image-side surface being convex in a paraxial region thereof. The third lens element E3 is made of plastic material, and has the object-side surface and the image-side surface being both aspheric. Furthermore, the object-side surface of the third lens element E3 includes one inflection point and a concave critical point.

The fourth lens element E4 with negative refractive power has an object-side surface being concave in a paraxial region thereof and an image-side surface being convex in a paraxial region thereof. The fourth lens element E4 is made of plastic material, and has the object-side surface and the image-side surface being both aspheric. Furthermore, the object-side surface of the fourth lens element E4 includes one inflection point and a convex critical point, and the image-side surface of the fourth lens element E4 includes one inflection point and a concave critical point.

The fifth lens element E5 with negative refractive power has an object-side surface being convex in a paraxial region thereof and an image-side surface being concave in a paraxial region thereof. The fifth lens element E5 is made of plastic material, and has the object-side surface and the image-side surface being both aspheric. Furthermore, the object-side surface of the fifth lens element E5 includes two inflection points and a concave critical point, and the image-side surface of the fifth lens element E5 includes four inflection points and a convex critical point.

The sixth lens element E6 with negative refractive power has an object-side surface being concave in a paraxial region thereof and an image-side surface being convex in a paraxial region thereof. The sixth lens element E6 is made of plastic material, and has the object-side surface and the image-side surface being both aspheric. Furthermore, the object-side surface of the sixth lens element E6 includes one inflection point.

According to the 9th embodiment, the reflective element E8 is disposed between the imaged object and the first lens element E1, that is, the reflective element E8 is at the most object side of the optical photographing lens assembly, wherein, according to the 9th embodiment, the reflective element E8 is a prism, which is made of glass material.

The filter E7 is made of glass material, which is located between the sixth lens element E6 and the image surface IMG in order, and will not affect the focal length of the optical photographing lens assembly.

The detailed optical data of the 9th embodiment are shown in Table 9A and the aspheric surface data are shown in Table 9B below.

TABLE 9A
9th Embodiment

| Surface | | | | | | | | Focal |
|---|---|---|---|---|---|---|---|---|
| # | | Curvature Radius | | Thickness | Material | Index | Abbe # | Length |
| 0 | Object | Plano | | D0 | | | | |
| 1 | Prism | Plano | | 9.300 | Glass | 1.785 | 25.7 | — |
| 2 | | Plano | | 2.062 | | | | |
| 3 | Stop | Plano | | −0.835 | | | | |
| 4 | Lens 1 | 14.8245 | ASP | 1.855 | Glass | 1.497 | 81.6 | 19.47 |
| 5 | | −26.7275 | ASP | 0.055 | | | | |
| 6 | Lens 2 | 5.9292 | ASP | 1.109 | Plastic | 1.669 | 19.5 | −29.84 |
| 7 | | 4.2286 | ASP | 1.375 | | | | |
| 8 | Stop | Plano | | 2.233 | | | | |
| 9 | Lens 3 | 29.5102 | ASP | 3.200 | Plastic | 1.534 | 56.0 | 11.55 |
| 10 | | −7.5077 | ASP | −1.120 | | | | |
| 11 | Stop | Plano | | D1 | | | | |
| 12 | Lens 4 | −6.0688 | ASP | 0.938 | Plastic | 1.567 | 37.4 | −47.98 |
| 13 | | −8.2498 | ASP | 0.624 | | | | |
| 14 | Stop | Plano | | −0.429 | | | | |
| 15 | Lens 5 | 4.7044 | ASP | 0.676 | Plastic | 1.686 | 18.4 | −190.58 |
| 16 | | 4.2755 | ASP | 1.886 | | | | |
| 17 | Stop | | | 1.840 | | | | |
| 18 | Lens 6 | −5.0728 | ASP | 0.914 | Plastic | 1.587 | 28.3 | −19.30 |
| 19 | | −9.7935 | ASP | D2 | | | | |

| | | | | | | | |
|---|---|---|---|---|---|---|---|
| 20 | Filter | Plano | 0.210 | Glass | 1.517 | 64.2 | — |
| 20 | | Plano | 0.694 | | | | |
| 21 | Image | Plano | — | | | | |

Reference wavelength is 587.6 nm (d-line).
Effective radius of Surface 3 (stop S1) is 4.800 mm.
Effective radius of Surface 8 (stop S2) is 3.859 mm.
Effective radius of Surface 11 (stop S3) is 3.886 mm.
Effective radius of Surface 14 (stop S4) is 3.614 mm.
Effective radius of Surface 17 (stop S5) is 4.129 mm.

TABLE 9B
Aspheric Coefficients

| Surface # | 4 | 5 | 6 | 7 |
|---|---|---|---|---|
| k= | 2.66611000E−01 | 1.07474000E+00 | −1.83228000E−01 | −1.02702000E+00 |
| A4= | 5.02777036E−04 | −6.29610877E−04 | −4.25298130E−03 | −3.71386071E−03 |
| A6= | −7.90679847E−05 | 5.97126567E−04 | 4.91748869E−04 | 2.53010843E−05 |
| A8= | 1.85455814E−05 | −1.16841316E−04 | −5.78143498E−05 | 9.74646520E−05 |
| A10= | −2.83426698E−06 | 1.28952455E−05 | 5.27845044E−06 | −2.87815325E−05 |
| A12= | 2.63975629E−07 | −8.90768822E−07 | −1.34278481E−06 | 4.12812482E−06 |
| A14= | −1.52392482E−08 | 3.89340944E−08 | 3.42769839E−07 | −2.44871536E−07 |
| A16= | 5.31470882E−10 | −1.03704909E−09 | −5.08107210E−08 | −1.53141244E−08 |
| A18= | −1.02130766E−11 | 1.51925450E−11 | 4.59055740E−09 | 4.29092657E−09 |
| A20= | 8.24312033E−14 | −9.28840719E−14 | −2.61755963E−10 | −3.89920761 E−10 |
| A22= | | | 9.26583103E−12 | 1.93238173E−11 |
| A24= | | | −1.86799027E−13 | −5.21802994E−13 |
| A26= | | | 1.64420938E−15 | 6.04072766E−15 |
| Surface # | 9 | 10 | 12 | 13 |
| k= | 7.65939000E+00 | −2.14262000E−01 | −2.72932000E−01 | 4.02593000E−01 |
| A4= | −8.06812353E−04 | −2.95600243E−04 | 1.91202405E−02 | 2.47669221E−02 |
| A6= | 7.34971644E−06 | 4.44111643E−05 | −2.41292358E−03 | −3.48759391 E−03 |
| A8= | −3.19584594E−06 | −1.27722979E−05 | −8.23292960E−05 | −4.13153958E−04 |
| A10= | −2.21479511E−06 | −2.05084053E−06 | 2.30387622E−04 | 6.64492051E−04 |
| A12= | 1.29925047E−06 | 2.03313014E−06 | −9.32898367E−05 | −2.94506709E−04 |
| A14= | −3.17737325E−07 | −5.68363296E−07 | 2.27152345E−05 | 7.90004885E−05 |
| A16= | 4.57991024E−08 | 8.96005077E−08 | −3.77479310E−06 | −1.43229010E−05 |
| A18= | −4.23976245E−09 | −8.92475361E−09 | 4.42174156E−07 | 1.81091815E−06 |
| A20= | 2.58930881E−10 | 5.73975156E−10 | −3.65538058E−08 | −1.59891490E−07 |
| A22= | −1.04482176E−11 | −2.31742698E−11 | 2.08820670E−09 | 9.65033814E−09 |
| A24= | 2.74936637E−13 | 5.35128298E−13 | −7.84329574E−11 | −3.78453196E−10 |
| A26= | −4.54805480E−15 | −5.39688945E−15 | 1.74193233E−12 | 8.65949168E−12 |
| A28= | 3.93517098E−17 | | −1.73224116E−14 | −8.73632730E−14 |
| Surface # | 15 | 16 | 18 | 19 |
| k= | 5.46706000E−02 | 1.48944000E−01 | −3.08648000E−01 | −1.32899000E−01 |
| A4= | −9.24281640E−03 | −2.10751156E−02 | −4.79809356E−04 | −1.65520056E−04 |
| A6= | 1.89056055E−03 | 5.55303344E−03 | −1.25074755E−03 | −7.56021683E−04 |
| A8= | −1.66025431E−03 | −2.40563711E−03 | 9.64886223E−04 | 3.95154041E−04 |
| A10= | 9.81781732E−04 | 9.31566165E−04 | −4.58825702E−04 | −1.14186059E−04 |
| A12= | −3.68580598E−04 | −2.76658852E−04 | 1.57044245E−04 | 2.24064318E−05 |
| A14= | 9.24298185E−05 | 5.93828252E−05 | −3.92278246E−05 | −3.17966052E−06 |
| A16= | −1.60506363E−05 | −9.08921748E−06 | 7.14057592E−06 | 3.34920018E−07 |
| A18= | 1.95635749E−06 | 9.83066028E−07 | −9.44820277E−07 | −2.62867765E−08 |
| A20= | −1.66553336E−07 | −7.37608773E−08 | 9.03834721E−08 | 1.51524943E−09 |
| A22= | 9.66110869E−09 | 3.69896346E−09 | −6.17028470E−09 | −6.20501488E−11 |
| A24= | −3.61676757E−10 | −1.15296273E−10 | 2.92688660E−10 | 1.70098285E−12 |
| A26= | 7.80927891E−12 | 1.91939869E−12 | −9.15978329E−12 | −2.78788616E−14 |
| A28= | −7.29492999E−14 | −1.13635776E−14 | 1.70002285E−13 | 2.05963276E−16 |
| A30= | | | −1.41707816E−15 | |

Please refer to Table 9A, the object distances and the data of DO, D1 and D2 in Table 9A of the 9th embodiment at the 1st mode and the 2nd mode are listed in Table 9C as below.

TABLE 9C
9th Embodiment

| | 1st mode | | 2nd mode |
|---|---|---|---|
| Object distance (mm) | infinite | Object distance (mm) | 120.427 |
| D0 (mm) | infinite | D0 (mm) | 109.900 |
| D1 (mm) | 1.864 | D1 (mm) | 4.106 |
| D2 (mm) | 3.250 | D2 (mm) | 1.008 |

In the 9th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 9th embodiment, so an explanation in this regard will not be provided again.

Moreover, these parameters can be calculated from Table 9A, Table 9B and Table 9C as the following values and satisfy the following conditions in Table 9D:

TABLE 9D
9th Embodiment

| | | | |
|---|---|---|---|
| fL [mm] | 17.74 | CT1/T23L | 0.51 |
| FnoL | 1.94 | CT1/CT3 | 0.58 |
| HFOVL [deg.] | 17.4 | CT2/CT3 | 0.35 |
| FOVL [deg.] | 34.8 | CT3/(CT4 + T45L + CT5) | 1.77 |
| fS [mm] | 13.74 | CT4/T23L | 0.26 |
| FnoS | 1.89 | (CT4 + CT5)/T56L | 0.43 |
| HFOVS [deg.] | 17.2 | CT6/T56L | 0.25 |
| FOVS [deg.] | 34.4 | T45L/T23L | 0.05 |
| TLL/TLS | 1.00 | (R2 + R3)/(R2 − R3) | 0.64 |
| BLL/BLS | 2.17 | (R3 − R4)/(R3 + R4) | 0.17 |
| (TG1G2S − TG1G2L)/TG1G2L | 3.01 | (R5 + R6)/(R5 − R6) | 0.59 |
| BLL/ImgH | 0.74 | R4/R1 | 0.29 |
| \|f3/f6\| | 0.60 | V4 + V6 | 65.7 |
| \|f3/f5\| | 0.06 | \|Sag3R1L\|/CT3 | 0.02 |
| \|f2/R3\| + \|f2/R4\| | 12.09 | \|Sag6R2L\|/CT6 | 1.11 |
| TLL/Dr1r6L | 2.15 | Y1R1L/Y6R2L | 1.10 |
| Dr1r6L/Dr7r12L | 1.52 | | |

### 10th Embodiment

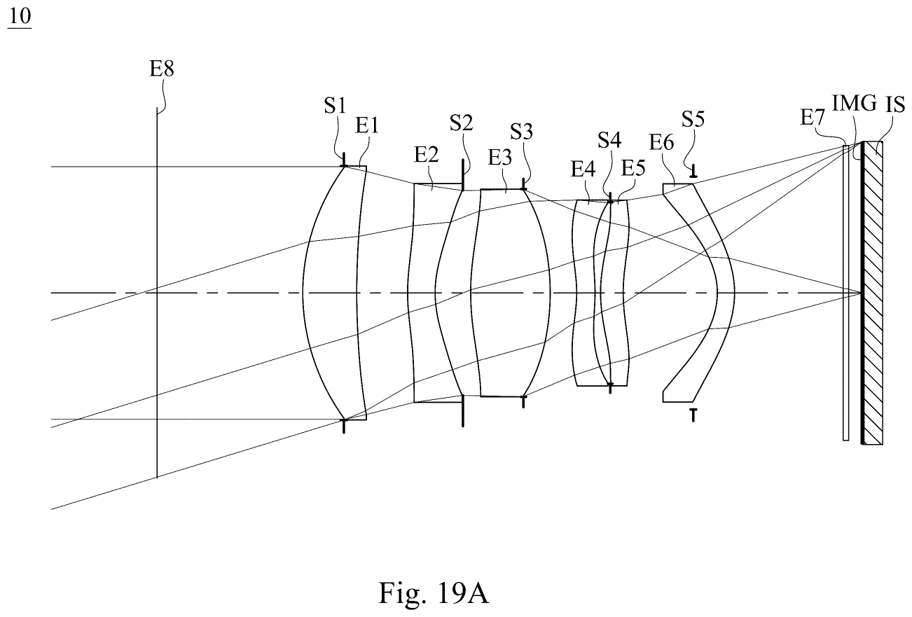

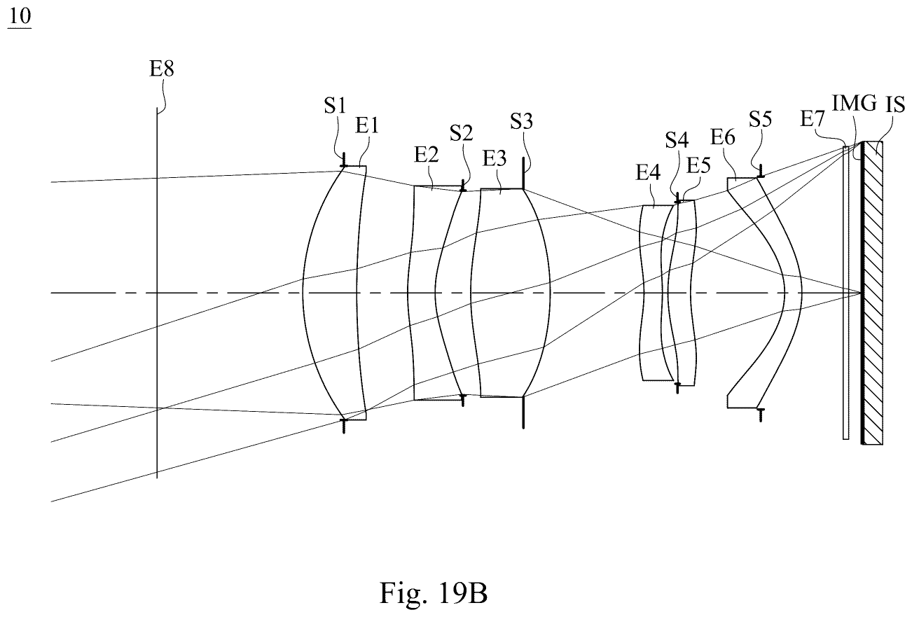

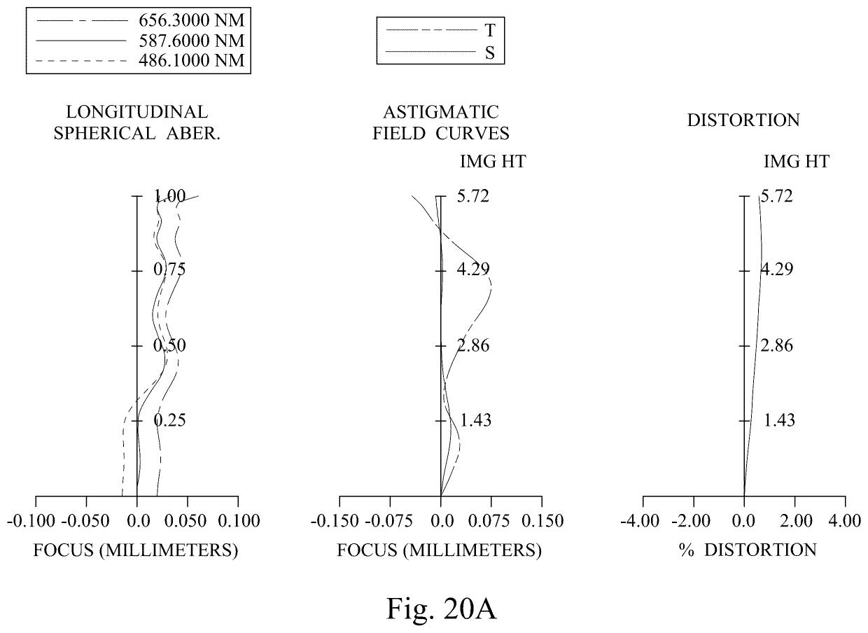

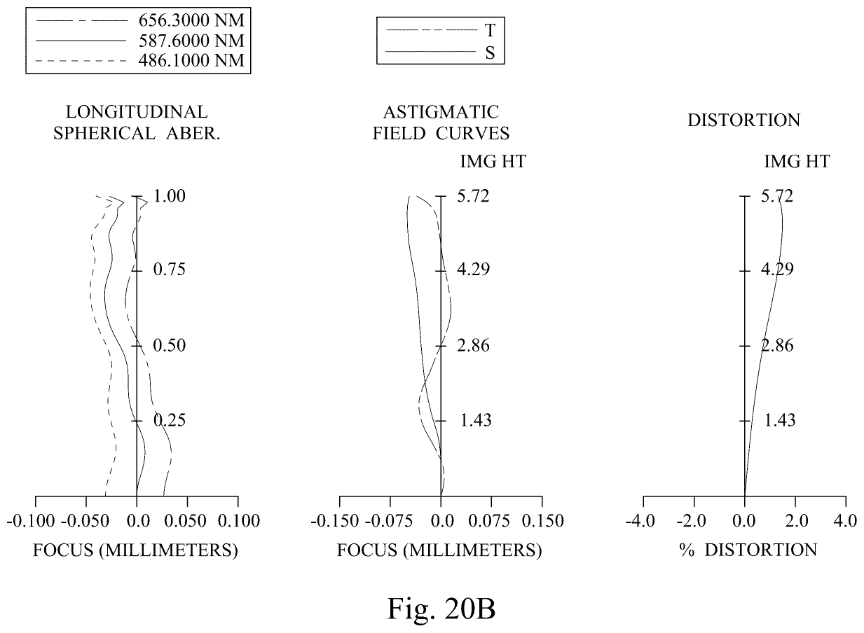

FIG. 19A is a schematic view of an imaging apparatus 10 at the 1st mode according to the 10th embodiment of the present disclosure. FIG. 19B is a schematic view of the imaging apparatus 10 at the 2nd mode according to the 10th embodiment. FIG. 20A shows spherical aberration curves, astigmatic field curves and a distortion curve of the imaging apparatus 10 of FIG. 19A. FIG. 20B shows spherical aberration curves, astigmatic field curves and a distortion curve of the imaging apparatus 10 of FIG. 19B. In FIG. 19A and FIG. 19B, the imaging apparatus 10 includes an optical photographing lens assembly (its reference numeral is omitted) and an image sensor IS. The optical photographing lens assembly includes, in order from an object side to an image side along an optical path, a reflective element E8, a stop S1, a first lens element E1, a second lens element E2, a stop S2, a third lens element E3, a stop S3, a fourth lens element E4, a stop S4, a fifth lens element E5, a sixth lens element E6, a stop S5, a filter E7 and an image surface IMG, wherein the image sensor IS is disposed on the image surface IMG of the optical photographing lens assembly. The optical photographing lens assembly includes six lens elements (E1, E2, E3, E4, E5, E6) without additional one or more lens elements inserted between the first lens element E1 and the sixth lens element E6. Further, the optical photographing lens assembly includes two lens element groups, which are in order from the object side to the image side along the optical path, a first lens element group and a second lens element group. As shown in FIG. 19A and FIG. 19B, according to the 10th embodiment, the first lens element group includes the first lens element E1, the second lens element E2 and the third lens element E3, the second lens element group includes the fourth lens element E4, the fifth lens element E5 and the sixth lens element E6. When the imaged object is moved from infinite to macro, the optical photographing lens assembly is changed from the 1st mode to the 2nd mode. During the focusing movement (that is, the 1st mode is changed to the 2nd mode), the second lens element group is moved towards to the image side along the optical axis relative to the first lens element group; during the focusing movement, all lens elements in each of the lens element groups have no relative movement. Further, at the 1st mode in FIG. 19A, the stop S2 is the aperture stop in the optical photographing lens assembly; at the 2nd mode in FIG. 19B, the stop S3 is the aperture stop in the optical photographing lens assembly.

The first lens element E1 with positive refractive power has an object-side surface being convex in a paraxial region thereof and an image-side surface being concave in a paraxial region thereof. The first lens element E1 is made of glass material, and has the object-side surface and the image-side surface being both aspheric. Furthermore, the image-side surface of the first lens element E1 includes one inflection point.

The second lens element E2 with negative refractive power has an object-side surface being convex in a paraxial region thereof and an image-side surface being concave in a paraxial region thereof. The second lens element E2 is made of plastic material, and has the object-side surface and the image-side surface being both aspheric. Furthermore, the object-side surface of the second lens element E2 includes one inflection point and a concave critical point, and the image-side surface of the second lens element E2 includes two inflection points.

The third lens element E3 with positive refractive power has an object-side surface being convex in a paraxial region thereof and an image-side surface being convex in a paraxial region thereof. The third lens element E3 is made of plastic material, and has the object-side surface and the image-side surface being both aspheric. Furthermore, the object-side surface of the third lens element E3 includes one inflection point and a concave critical point.

The fourth lens element E4 with negative refractive power has an object-side surface being concave in a paraxial region thereof and an image-side surface being convex in a paraxial region thereof. The fourth lens element E4 is made of plastic material, and has the object-side surface and the image-side surface being both aspheric. Furthermore, the object-side surface of the fourth lens element E4 includes one inflection point and a convex critical point, and the image-side surface of the fourth lens element E4 includes one inflection point and a concave critical point.

The fifth lens element E5 with positive refractive power has an object-side surface being convex in a paraxial region thereof and an image-side surface being concave in a paraxial region thereof. The fifth lens element E5 is made of plastic material, and has the object-side surface and the image-side surface being both aspheric. Furthermore, the object-side surface of the fifth lens element E5 includes three inflection points, and the image-side surface of the fifth lens element E5 includes three inflection points and a convex critical point.

The sixth lens element E6 with negative refractive power has an object-side surface being concave in a paraxial region thereof and an image-side surface being convex in a paraxial region thereof. The sixth lens element E6 is made of plastic material, and has the object-side surface and the image-side surface being both aspheric. Furthermore, the object-side surface of the sixth lens element E6 includes one inflection point, and the image-side surface of the sixth lens element E6 includes two inflection points.

According to the 10th embodiment, the reflective element E8 is disposed between the imaged object and the first lens element E1, that is, the reflective element E8 is at the most object side of the optical photographing lens assembly, wherein, according to the 10th embodiment, the reflective element E8 is a reflective mirror, which is made of glass material.

The filter E7 is made of glass material, which is located between the sixth lens element E6 and the image surface IMG in order, and will not affect the focal length of the optical photographing lens assembly.

The detailed optical data of the 10th embodiment are shown in Table 10A and the aspheric surface data are shown in Table 10B below.

TABLE 10A
10th Embodiment

| | | | | | | | | Focal |
|---|---|---|---|---|---|---|---|---|
| Surface # | | Curvature Radius | | Thickness | Material | Index | Abbe # | Length |
| 0 | Object | Plano | | D0 | | | | |
| 1 | Mirror | Plano | | 7.063 | | | | |
| 2 | Stop | Plano | | −1.555 | | | | |
| 3 | Lens 1 | 7.7988 | ASP | 2.035 | Glass | 1.497 | 81.6 | 21.41 |
| 4 | | 26.6664 | ASP | 1.926 | | | | |
| 5 | Lens 2 | 7.8413 | ASP | 1.038 | Plastic | 1.587 | 28.3 | −16.43 |
| 6 | | 4.1140 | ASP | 1.054 | | | | |
| 7 | Stop | Plano | | 0.294 | | | | |
| 8 | Lens 3 | 10.0836 | ASP | 3.000 | Plastic | 1.540 | 67.0 | 9.30 |
| 9 | | −8.9551 | ASP | −1.009 | | | | |
| 10 | Stop | Plano | | D1 | | | | |
| 11 | Lens 4 | −4.7826 | ASP | 0.694 | Plastic | 1.545 | 56.1 | −35.76 |
| 12 | | −6.6626 | ASP | 0.572 | | | | |
| 13 | Stop | Plano | | −0.363 | | | | |
| 14 | Lens 5 | 6.2514 | ASP | 0.854 | Plastic | 1.587 | 28.3 | 162.74 |
| 15 | | 6.3509 | ASP | 3.557 | | | | |
| 16 | Lens 6 | −2.7694 | ASP | 0.650 | Plastic | 1.534 | 56.0 | −24.26 |
| 17 | | −3.8096 | ASP | −1.554 | | | | |

| | | | | | | | |
|---|---|---|---|---|---|---|---|
| 18 | Stop | Plano | D2 | | | | |
| 19 | Filter | Plano | 0.210 | Glass | 1.517 | 64.2 | — |
| 20 | | Plano | 0.527 | | | | |
| 21 | Image | Plano | — | | | | |

Reference wavelength is 587.6 nm (d-line).
Effective radius of Surface 2 (stop S1) is 4.800 mm.
Effective radius of Surface 7 (stop S2) is 3.872 mm.
Effective radius of Surface 10 (stop S3) is 3.925 mm.
Effective radius of Surface 13 (stop S4) is 3.430 mm.
Effective radius of Surface 18 (stop S5) is 4.400 mm.

TABLE 10B
Aspheric Coefficients

| Surface # | 3 | 4 | 5 | 6 |
|---|---|---|---|---|
| k= | 0.00000000E+00 | 0.00000000E+00 | 0.00000000E+00 | 0.00000000E+00 |
| A4= | 3.72755569E−05 | −2.59008805E−04 | −6.35606901 E−03 | −9.22103142E−03 |
| A6= | −4.32672534E−05 | −5.71758988E−05 | −2.46827366E−05 | −2.09038672E−04 |
| A8= | 8.10213951E−06 | 1.78594938E−05 | 8.43687666E−05 | 2.47600413E−04 |
| A10= | −9.45485983E−07 | −2.62448532E−06 | −1.29158576E−05 | −8.49592418E−05 |
| A12= | 6.73971211E−08 | 2.45356975E−07 | 7.93386922E−07 | 2.14907367E−05 |
| A14= | −2.84369080E−09 | −1.45549891E−08 | 7.23651270E−08 | −4.07288807E−06 |
| A16= | 6.57743555E−11 | 5.31290444E−10 | −2.22486125E−08 | 5.61053081E−07 |
| A18= | −6.32655938E−13 | −1.08983507E−11 | 2.51123946E−09 | −5.47590777E−08 |
| A20= | −7.43488759E−16 | 9.52662970E−14 | −1.65318653E−10 | 3.66765420E−09 |
| A22= | | | 6.61864926E−12 | −1.59902217E−10 |
| A24= | | | −1.49794795E−13 | 4.08251720E−12 |
| A26= | | | 1.47375391E−15 | −4.63316258E−14 |

| Surface # | 8 | 9 | 11 | 12 |
|---|---|---|---|---|
| k= | 0.00000000E+00 | 0.00000000E+00 | 0.00000000E+00 | 0.00000000E+00 |
| A4= | −1.18347374E−03 | 2.59135369E−04 | 3.28245589E−02 | 4.96597280E−02 |
| A6= | −5.83802626E−05 | −4.04218676E−04 | −1.05610386E−02 | −2.85215466E−02 |
| A8= | −7.14949449E−05 | 2.04916767E−04 | 4.28621695E−03 | 1.63701031E−02 |
| A10= | 4.27936436E−05 | −7.43044291E−05 | −1.49864109E−03 | −7.14373128E−03 |
| A12= | −1.33519667E−05 | 1.83233947E−05 | 4.05747192E−04 | 2.30397927E−03 |
| A14= | 2.67066049E−06 | −3.12648312E−06 | −8.29312984E−05 | −5.51604576E−04 |
| A16= | −3.59730469E−07 | 3.73037381E−07 | 1.27086520E−05 | 9.83184960E−05 |
| A18= | 3.30663727E−08 | −3.10294628E−08 | −1.44759606E−06 | −1.29808317E−05 |
| A20= | −2.04933118E−09 | 1.76216015E−09 | 1.20456848E−07 | 1.24964500E−06 |
| A22= | 8.19924104E−11 | −6.50950218E−11 | −7.09490310E−09 | −8.50640739E−08 |
| A24= | −1.91302041E−12 | 1.40904707E−12 | 2.79571324E−10 | 3.87119581E−09 |
| A26= | 1.97688873E−14 | −1.35560667E−14 | −6.59957213E−12 | −1.05464849E−10 |
| A28= | | | 7.04732316E−14 | 1.29824942E−12 |
| Surface # | 14 | 15 | 16 | 17 |
| k= | 0.00000000E+00 | 0.00000000E+00 | −1.00000000E+00 | −1.00000000E+00 |
| A4= | 1.24949677E−02 | −9.81317826E−03 | 4.83099192E−04 | 2.41192287E−03 |
| A6= | −1.99590939E−02 | −4.34265704E−04 | 1.96365940E−03 | −1.58682294E−04 |
| A8= | 1.32713818E−02 | 8.11481653E−04 | −1.27773829E−03 | 3.38659328E−04 |
| A10= | −6.02849914E−03 | −3.28284317E−04 | 5.53856277E−04 | −2.01097330E−04 |
| A12= | 1.96998459E−03 | 7.74705982E−05 | −1.68706351E−04 | 6.52542718E−05 |
| A14= | −4.73921644E−04 | −1.33259983E−05 | 3.67741753E−05 | −1.34915694E−05 |
| A16= | 8.45834012E−05 | 2.09270010E−06 | −5.77941658E−06 | 1.88337831E−06 |
| A18= | −1.11556877E−05 | −3.25857687E−07 | 6.53425587E−07 | −1.81814960E−07 |
| A20= | 1.07046737E−06 | 4.26408100E−08 | −5.24550975E−08 | 1.21724189E−08 |
| A22= | −7.24771290E−08 | −3.94851953E−09 | 2.90807487E−09 | −5.55288580E−10 |
| A24= | 3.27441061E−09 | 2.33285217E−10 | −1.05584375E−10 | 1.64774579E−11 |
| A26= | −8.84172913E−11 | −7.83959745E−12 | 2.25376524E−12 | −2.86873574E−13 |
| A28= | 1.07741051E−12 | 1.13875863E−13 | −2.13907779E−14 | 2.22457209E−15 |

Please refer to Table 10A, the object distances and the data of DO, D1 and D2 in Table 10A of the 10th embodiment at the 1st mode and the 2nd mode are listed in Table 10C as below.

TABLE 10C
10th Embodiment

| | 1st mode | | 2nd mode |
|---|---|---|---|
| Object distance (mm) | infinite | Object distance (mm) | 120.000 |
| D0 (mm) | infinite | D0 (mm) | 114.492 |
| D1 (mm) | 2.010 | D1 (mm) | 4.554 |
| D2 (mm) | 5.654 | D2 (mm) | 3.110 |

In the 10th embodiment, the equation of the aspheric surface profiles of the aforementioned lens elements is the same as the equation of the 1st embodiment. Also, the definitions of these parameters shown in the following table are the same as those stated in the 1st embodiment with corresponding values for the 10th embodiment, so an explanation in this regard will not be provided again.

Moreover, these parameters can be calculated from Table 10A, Table 10B and Table 10C as the following values and satisfy the following conditions in Table 10D:

TABLE 10D
10th Embodiment

| | | | |
|---|---|---|---|
| fL [mm] | 18.57 | CT1/T23L | 1.51 |
| FnoL | 1.95 | CT1/CT3 | 0.68 |
| HFOVL [deg.] | 17.0 | CT2/CT3 | 0.35 |
| FOVL [deg.] | 34.0 | CT3/(CT4 + T45L + CT5) | 1.71 |
| fS [mm] | 14.76 | CT4/T23L | 0.51 |
| FnoS | 1.93 | (CT4 + CT5)/T56L | 0.44 |
| HFOVS [deg.] | 16.7 | CT6/T56L | 0.18 |
| FOVS [deg.] | 33.4 | T45L/T23L | 0.16 |
| TLL/TLS | 1.00 | (R2 + R3)/(R2 − R3) | 1.83 |
| BLL/BLS | 2.11 | (R3 − R4)/(R3 + R4) | 0.31 |
| (TG1G2S − TG1G2L)/TG1G2L | 2.54 | (R5 + R6)/(R5 − R6) | 0.06 |
| BLL/ImgH | 0.85 | R4/R1 | 0.53 |
| \|f3/f6\| | 0.38 | V4 + V6 | 112.1 |
| \|f3/f5\| | 0.06 | \|Sag3R1L\|/CT3 | 0.12 |
| \|f2/R3\| + \|f2/R4\| | 6.09 | \|Sag6R2L\|/CT6 | 2.43 |
| TLL/Dr1r6L | 2.26 | Y1R1L/Y6R2L | 1.16 |
| Dr1r6L/Dr7r12L | 1.57 | | |

### 11th Embodiment

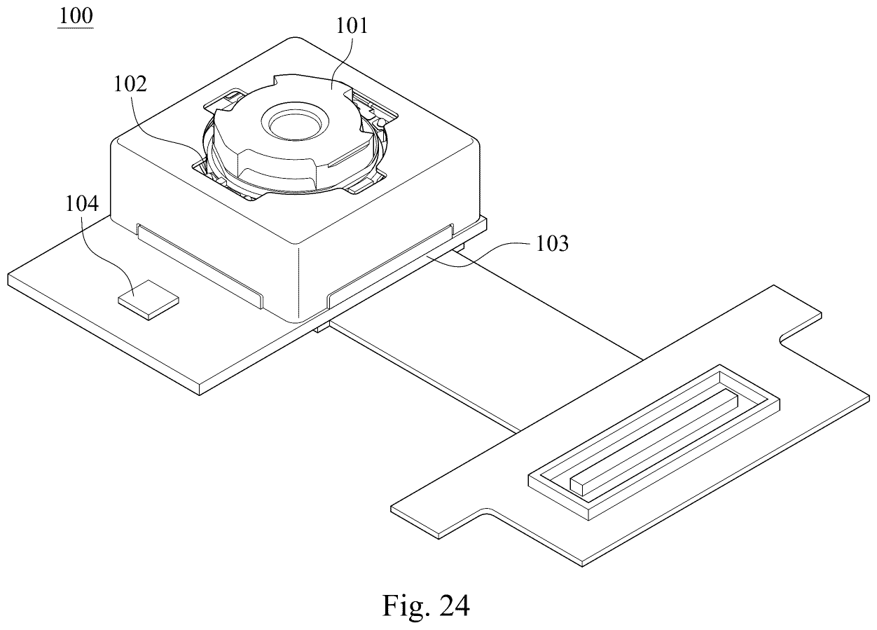

FIG. 24 is a schematic view of an imaging apparatus 100 according to the 11th embodiment of the present disclosure. In FIG. 24, the imaging apparatus 100 of the 11th embodiment is a camera module, the imaging apparatus 100 includes an imaging lens assembly 101, a driving apparatus 102 and an image sensor 103, wherein the imaging lens assembly 101 includes the optical photographing lens assembly of the present disclosure and a lens barrel (not shown in drawings) for carrying the optical photographing lens assembly. The imaging apparatus 100 can focus light from an imaged object via the imaging lens assembly 101, perform image focusing by the driving apparatus 102, and generate an image on the image sensor 103, and the imaging information can be transmitted.

The driving apparatus 102 can be an auto-focus module, which can be driven by driving systems, such as voice coil motors (VCM), micro electro-mechanical systems (MEMS), piezoelectric systems, and shape memory alloys etc. The optical photographing lens assembly can obtain a favorable imaging position by the driving apparatus 102 so as to capture clear images when the imaged object is disposed at different object distances.

The imaging apparatus 100 can include the image sensor 103 located on the image surface of the optical photographing lens assembly, such as CMOS and CCD, with superior photosensitivity and low noise. Thus, it is favorable for providing realistic images with high definition image quality thereof. Moreover, the imaging apparatus 100 can further include an image stabilization module 104, which can be a kinetic energy sensor, such as an accelerometer, a gyro sensor, and a Hall Effect sensor. In the 11th embodiment, the image stabilization module 104 is a gyro sensor, but is not limited thereto. Therefore, the variation of different axial directions of the optical photographing lens assembly can adjusted so as to compensate the image blur generated by motion at the moment of exposure, and it is further favorable for enhancing the image quality while photographing in motion and low light situation. Furthermore, advanced image compensation functions, such as optical image stabilizations (OIS) and electronic image stabilizations (EIS) etc., can be provided.

### 12th Embodiment

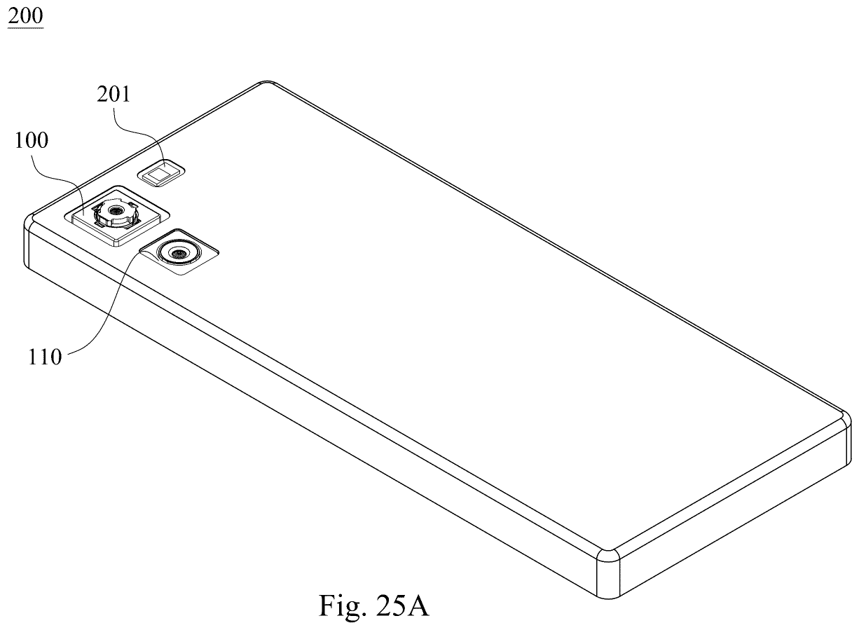

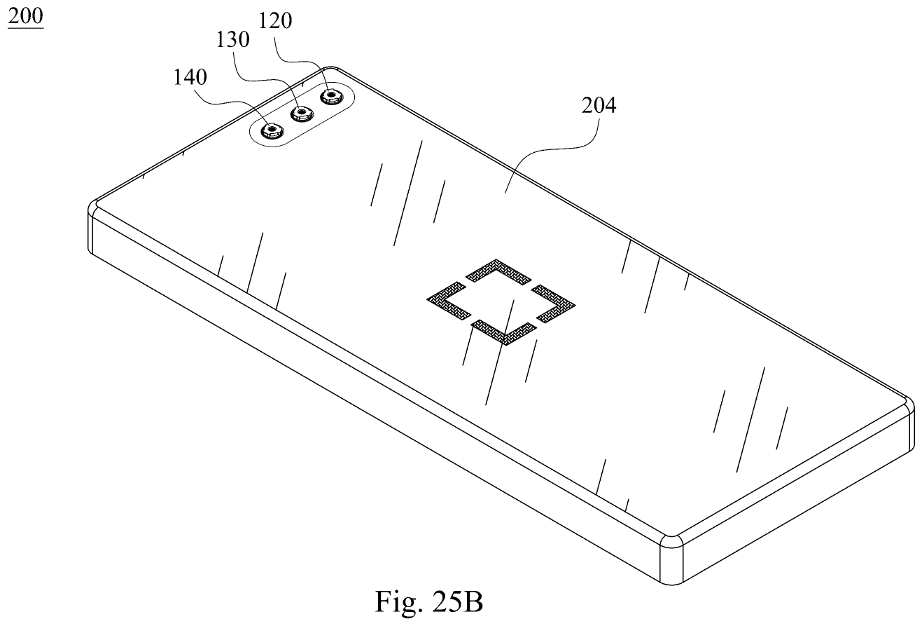

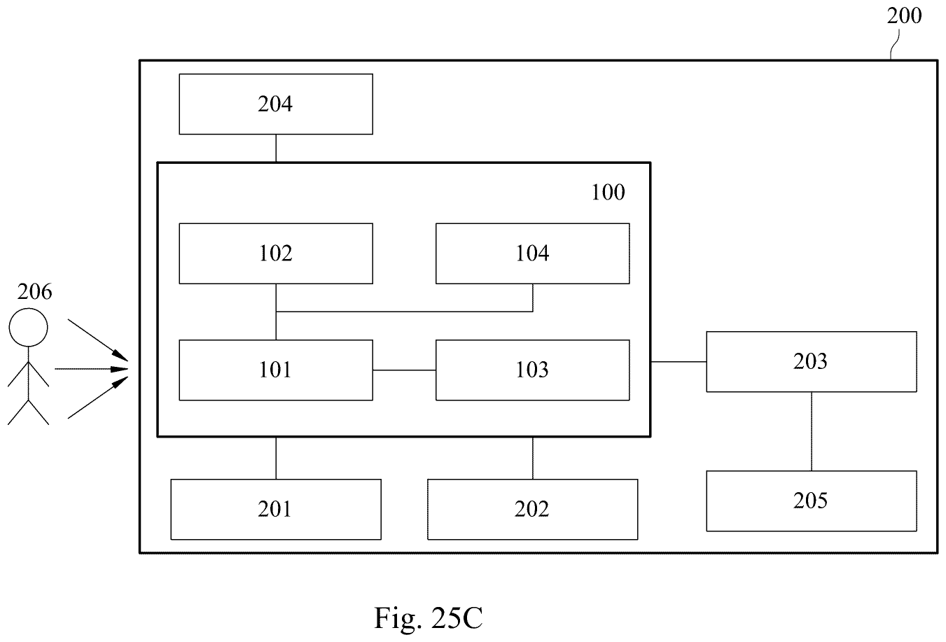

FIG. 25A is a schematic view of one side of an electronic device 200 according to the 12th embodiment of the present disclosure. FIG. 25B is a schematic view of another side of the electronic device 200 of FIG. 25A. FIG. 25C is a system schematic view of the electronic device 200 of FIG. 25A. In FIGS. 25A, 25B and 25C, the electronic device 200 according to the 12th embodiment is a smartphone, which include imaging apparatuses 100, 110, 120, 130, 140, a flash module 201, a focusing assisting module 202, an image signal processor (ISP) 203, a user interface 204 and an image software processor 205, wherein each of the imaging apparatuses 120, 130, 140 is a front camera. When the user captures images of an imaged object 206 via the user interface 204, the electronic device 200 focuses and generates an image via at least one of the imaging apparatuses 100, 110, 120, 130, 140, while compensating for low illumination via the flash module 201 when necessary. Then, the electronic device 200 quickly focuses on the imaged object 206 according to its object distance information provided by the focusing assisting module 202, and optimizes the image via the image signal processor 203 and the image software processor 205. Thus, the image quality can be further enhanced. The focusing assisting module 202 can adopt conventional infrared or laser for obtaining quick focusing, and the user interface 204 can utilize a touch screen or a physical button for capturing and processing the image with various functions of the image processing software.

Each of the imaging apparatuses 100, 110, 120, 130, 140 according to the 12th embodiment can include the optical photographing lens assembly of the present disclosure, and can be the same or similar to the imaging apparatus 100 according to the aforementioned 11th embodiment, and will not describe again herein. In detail, according to the 12th embodiment, the imaging apparatuses 100, 110 can be wide angle imaging apparatus and ultra-wide angle imaging apparatus, respectively. The imaging apparatuses 120, 130, 140 can be wide angle imaging apparatus, ultra-wide angle imaging apparatus and TOF (Time-Of-Flight) module, respectively, or can be others imaging apparatuses, which will not be limited thereto. Further, the connecting relationships between each of the imaging apparatuses 110, 120, 130, 140 and other elements can be the same as the imaging apparatus 100 in FIG. 24C, or can be adaptively adjusted according to the type of the imaging apparatuses, which will not be shown and detailed descripted again.

### 13th Embodiment

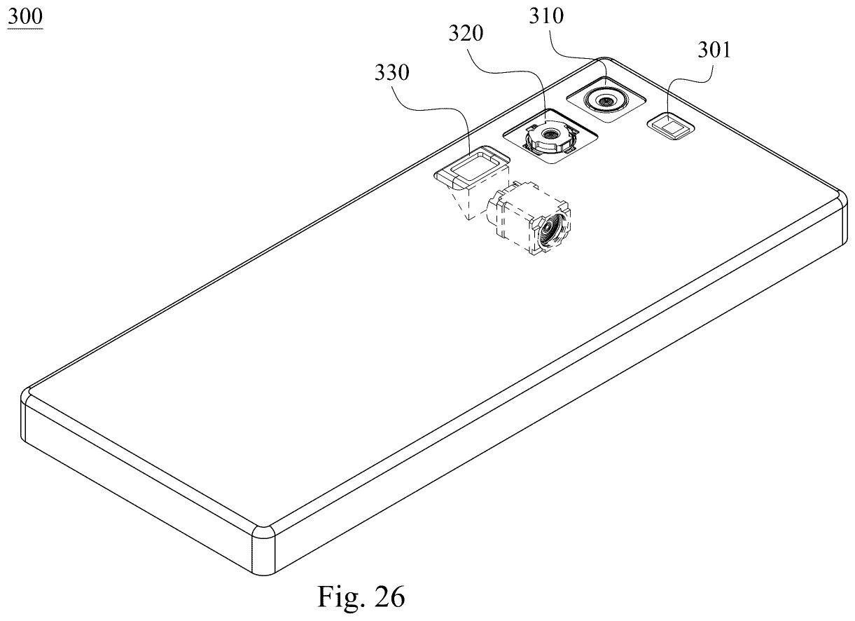

FIG. 26 is a schematic view of one side of an electronic device 300 according to the 13th embodiment of the present disclosure. According to the 13th embodiment, the electronic device 300 is a smartphone, which include imaging apparatuses 310, 320, 330 and a flash module 301.

The electronic device 300 according to the 13th embodiment can include the same or similar elements to that according to the 12th embodiment, and each of the imaging apparatuses 310, 320, 330 according to the 13th embodiment can have a configuration which is the same or similar to that according to the 12th embodiment, and will not describe again herein. In detail, according to the 13th embodiment, each of the imaging apparatuses 310, 320, 330 can include the optical photographing lens assembly of the present disclosure, and can be the same or similar to the imaging apparatus 100 according to the aforementioned 11th embodiment, and will not describe again herein. In detail, the imaging apparatus 310 can be ultra-wide angle imaging apparatus, the imaging apparatus 320 can be wide angle imaging apparatus, the imaging apparatus 330 can be telephoto imaging apparatus (which can include light path folding element), or can be adaptively adjusted according to the type of the imaging apparatuses, which will not be limited to the arrangement.

### 14th Embodiment

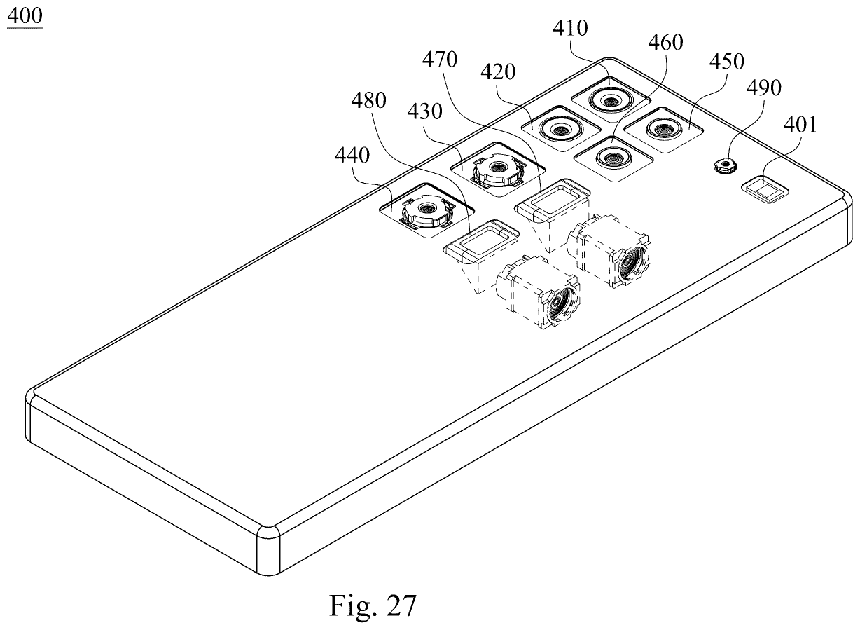

FIG. 27 is a schematic view of one side of an electronic device 400 according to the 14th embodiment of the present disclosure. According to the 14th embodiment, the electronic device 400 is a smartphone, which include imaging apparatuses 410, 420, 430, 440, 450, 460, 470, 480, 490 and a flash module 401.

The electronic device 400 according to the 14th embodiment can include the same or similar elements to that according to the 12th embodiment, and each of the imaging apparatuses 410, 420, 430, 440, 450, 460, 470, 480, 490 and the flash module 401 can have a configuration which is the same or similar to that according to the 12th embodiment, and will not describe again herein. In detail, according to the 14th embodiment, each of the imaging apparatuses 410, 420, 430, 440, 450, 460, 470, 480, 490 can include the optical photographing lens assembly of the present disclosure, and can be the same or similar to the imaging apparatus 100 according to the aforementioned 11th embodiment, and will not describe again herein.

In detail, each of the imaging apparatuses 410, 420 can be ultra-wide angle imaging apparatus, each of the imaging apparatuses 430, 440 can be wide angle imaging apparatus, each of the imaging apparatuses 450, 460 can be telephoto imaging apparatus, each of the imaging apparatuses 470, 480 can be telephoto imaging apparatus (which can include light path folding element), the imaging apparatus 490 can be TOF module, or can be adaptively adjusted according to the type of the imaging apparatuses, which will not be limited to the arrangement.

### 15th Embodiment

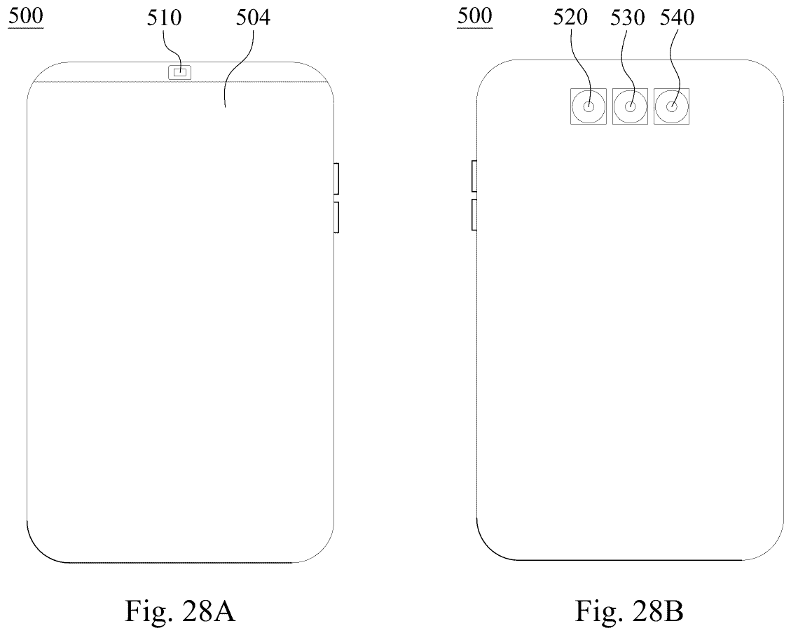

FIG. 28A is a schematic view of one side of an electronic device 500 according to the 15th embodiment of the present disclosure. FIG. 28B is a schematic view of another side of the electronic device 500 according to the 15th embodiment of FIG. 28A. In FIG. 28A and FIG. 28B, according to the 15th embodiment, the electronic device 500 is a smartphone, which include imaging apparatuses 510, 520, 530, 540 and a user interface 504.

The electronic device 500 according to the 15th embodiment can include the same or similar elements to that according to the 12th embodiment, and each of the imaging apparatuses 510, 520, 530, 540 and the user interface 504 can have a configuration which is the same or similar to that according to the 12th embodiment, and will not describe again herein. In detail, according to the 15th embodiment, the imaging apparatus 510 corresponds to a non-circular opening located on an outer side of the electronic device 500 for capturing the image, and the imaging apparatuses 520, 530, 540 can be telephoto imaging apparatus, wide angle imaging apparatus and ultra-wide angle imaging apparatus, respectively, or can be adaptively adjusted according to the type of the imaging apparatuses, which will not be limited to the arrangement.

The foregoing description, for purpose of explanation, has been described with reference to specific embodiments. It is to be noted that Tables show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An optical photographing lens assembly comprising six lens elements, the six lens elements being, in order from an object side to an image side along an optical path:
a first lens element, a second lens element, a third lens element, a fourth lens element, a fifth lens element and a sixth lens element; each of the six lens elements has an object-side surface towards the object side and an image-side surface towards the image side;
wherein the first lens element has positive refractive power, the object-side surface of the first lens element is convex in a paraxial region thereof;
the second lens element has negative refractive power, the object-side surface of the second lens element is convex in a paraxial region thereof, the image-side surface of the second lens element is concave in a paraxial region thereof;
the third lens element has positive refractive power, the image-side surface of the third lens element is convex in a paraxial region thereof;
at least one of the first lens element to the sixth lens element comprises at least one inflection point;
wherein a maximum field of view of the optical photographing lens assembly at an object distance being infinite is FOVL, a focal length of the second lens element is f2, a focal length of the third lens element is f3, a focal length of the sixth lens element is f6, a central thickness of the second lens element is CT2, a central thickness of the third lens element is CT3, a central thickness of the fourth lens element is CT4, a central thickness of the fifth lens element is CT5, an axial distance between the fifth lens element and the sixth lens element of the optical photographing lens assembly at the object distance being infinite is T56L, a curvature radius of the object-side surface of the second lens element is R3, a curvature radius of the image-side surface of the second lens element is R4, and the following conditions are satisfied:
$$\begin{matrix}10. degrees < FOVL < 55. degrees ; \\ 0 < \vert f 3 / f 6 \vert < 0.75 ; \\ 0 < ( CT 4 + CT 5 ) / T 56 L < 0.9 ; \\ 4.5 < \vert f 2 / R 3 \vert + \vert f 2 / R 4 \vert < 18. ; and \\ 0.05 < CT 2 / CT 3 < 0.75 .\end{matrix}$$

2. The optical photographing lens assembly of claim 1, wherein the object-side surface of the fifth lens element is convex in a paraxial region thereof; the image-side surface of the sixth lens element is convex in a paraxial region thereof; an axial distance between the object-side surface of the first lens element and the image-side surface of the third lens element of the optical photographing lens assembly at the object distance being infinite is Dr1r6L, an axial distance between the object-side surface of the fourth lens element and the image-side surface of the sixth lens element of the optical photographing lens assembly at the object distance being infinite is Dr7r12L, and the following condition is satisfied:
$$1. < Dr 1 r 6 L / Dr 7 r 12 L < 2. .$$

3. The optical photographing lens assembly of claim 1, wherein at least one of the object-side surface and the image-side surface of the fourth lens element comprises at least one critical point; the maximum field of view of the optical photographing lens assembly at an object distance being infinite is FOVL, and the following condition is satisfied:
$$20. degrees < FOVL < 45. degrees .$$

4. The optical photographing lens assembly of claim 1, wherein the object-side surface of the fourth lens element comprises at least one convex critical point; at least one of the first lens element to the sixth lens element is made of glass material.

5. The optical photographing lens assembly of claim 1, wherein the curvature radius of the object-side surface of the second lens element is R3, the curvature radius of the image-side surface of the second lens element is R4, and the following condition is satisfied:
$$0 < ( R 3 - R 4 ) / ( R 3 + R 4 ) < 0.5 .$$

6. The optical photographing lens assembly of claim 1, wherein a curvature radius of the object-side surface of the first lens element is R1, the curvature radius of the image-side surface of the second lens element is R4, a curvature radius of the object-side surface of the third lens element is R5, a curvature radius of the image-side surface of the third lens element is R6, and the following conditions are satisfied:
$$\begin{matrix}0.1 < R 4 / R 1 < 0.7 ; and \\ - 0.2 < ( R 5 + R 6 ) / ( R 5 - R 6 ) < 2. .\end{matrix}$$

7. The optical photographing lens assembly of claim 1, wherein a central thickness of the first lens element is CT1, an axial distance between the second lens element and the third lens element of the optical photographing lens assembly at the object distance being infinite is T23L, and the following condition is satisfied:
$$0.35 < CT 1 / T 23 L < 1.7 .$$

8. The optical photographing lens assembly of claim 1, wherein an axial distance between an image-side surface of a lens element closet to the image side and an image surface of the optical photographing lens assembly at the object distance being infinite is BLL, a maximum image height of the optical photographing lens assembly is ImgH, and the following condition is satisfied:
$$0.5 < BLL / ImgH < 1.1 .$$

9. The optical photographing lens assembly of claim 1, wherein the central thickness of the third lens element is CT3, a central thickness of the sixth lens element is CT6, a displacement in parallel with an optical axis from an axial vertex on the object-side surface of the third lens element to a maximum effective radius position on the object-side surface of the third lens element of the optical photographing lens assembly at the object distance being infinite is Sag3R1L, a displacement in parallel with the optical axis from an axial vertex on the image-side surface of the sixth lens element to a maximum effective radius position on the image-side surface of the sixth lens element of the optical photographing lens assembly at the object distance being infinite is Sag6R2L, and the following conditions are satisfied:
$$\begin{matrix}0 < \vert Sag 3 R 1 L \vert / CT 3 < 0.3 ; and \\ 0.6 < \vert Sag 6 R 2 L \vert / CT 6 < 5. .\end{matrix}$$

10. The optical photographing lens assembly of claim 1, wherein a maximum effective radius position of the object-side surface of the first lens element of the optical photographing lens assembly at the object distance being infinite is Y1R1L, a maximum effective radius position of the image-side surface of the sixth lens element of the optical photographing lens assembly at the object distance being infinite is Y6R2L, and the following condition is satisfied:
$$0.8 < Y 1 R 1 L / Y 6 R 2 L < 1.3 .$$

11. The optical photographing lens assembly of claim 1, further comprising:
a reflective element disposed between an imaged object and the first lens element.

12. An imaging apparatus, comprising:
the optical photographing lens assembly of claim 1; and
an image sensor disposed on an image surface of the optical photographing lens assembly.

13. An electronic device, comprising:
the imaging apparatus of claim 12.

14. An optical photographing lens assembly comprising six lens elements, the six lens elements being, in order from an object side to an image side along an optical path:
a first lens element, a second lens element, a third lens element, a fourth lens element, a fifth lens element and a sixth lens element; each of the six lens elements has an object-side surface towards the object side and an image-side surface towards the image side;
wherein the first lens element has positive refractive power, the object-side surface of the first lens element is convex in a paraxial region thereof;
the second lens element has negative refractive power, the object-side surface of the second lens element is convex in a paraxial region thereof, the image-side surface of the second lens element is concave in a paraxial region thereof;
the third lens element has positive refractive power, the image-side surface of the third lens element is convex in a paraxial region thereof;
at least one of the first lens element to the sixth lens element comprises at least one inflection point;
wherein a maximum field of view of the optical photographing lens assembly at an object distance being infinite is FOVL, a focal length of the third lens element is f3, a focal length of the sixth lens element is f6, a central thickness of the fourth lens element is CT4, a central thickness of the fifth lens element is CT5, an axial distance between the second lens element and the third lens element of the optical photographing lens assembly at the object distance being infinite is T23L, an axial distance between the fifth lens element and the sixth lens element of the optical photographing lens assembly at the object distance being infinite is T56L, a curvature radius of the image-side surface of the first lens element is R2, a curvature radius of the object-side surface of the second lens element is R3, and the following conditions are satisfied:
$$\begin{matrix}10. degrees < FOVL < 55. degrees ; \\ 0 < \vert f 3 / f 6 \vert < 0.75 ; \\ 0 < ( CT 4 + CT 5 ) / T 56 L < 0.9 ; \\ 0.15 < ( R 2 + R 3 ) / ( R 2 - R 3 ) < 5. ; and \\ 0.05 < CT 4 / T 23 L < 0.75 .\end{matrix}$$

15. The optical photographing lens assembly of claim 14, wherein the curvature radius of the image-side surface of the first lens element is R2, the curvature radius of the object-side surface of the second lens element is R3, a curvature radius of the object-side surface of the third lens element is R5, a curvature radius of the image-side surface of the third lens element is R6, and the following conditions are satisfied:
$$\begin{matrix}- 0.1 \; 0 < ( R 5 + R 6 ) / ( R 5 - R 6 ) < 1.25 ; and \\ 0.2 < ( R 2 + R 3 ) / ( R 2 - R 3 ) < 3. .\end{matrix}$$

16. The optical photographing lens assembly of claim 14, wherein the sixth lens element has negative refractive power; the focal length of the third lens element is f3, a focal length of the fifth lens element is f5, and the following condition is satisfied:
$$0.01 < \vert f 3 / f 5 \vert < 0. 80 .$$

17. The optical photographing lens assembly of claim 14, wherein the object-side surface of the fourth lens element is concave in a paraxial region thereof; the image-side surface of the sixth lens element is convex in a paraxial region thereof; an axial distance between the object-side surface of the first lens element and an image surface of the optical photographing lens assembly at the object distance being infinite is TLL, an axial distance between the object-side surface of the first lens element and the image-side surface of the third lens element of the optical photographing lens assembly at the object distance being infinite is Dr1r6L, and the following condition is satisfied:
$$1. < TLL / Dr 1 r 6 L < 3.5 .$$

18. The optical photographing lens assembly of claim 14, wherein a central thickness of the third lens element is CT3, the central thickness of the fourth lens element is CT4, the central thickness of the fifth lens element is CT5, an axial distance between the fourth lens element and the fifth lens element of the optical photographing lens assembly at the object distance being infinite is T45L, and the following condition is satisfied:
$$0.8 < CT 3 / ( CT 4 T 45 L + CT 5 ) < 3. .$$

19. The optical photographing lens assembly of claim 14, wherein the axial distance between the second lens element and the third lens element of the optical photographing lens assembly at the object distance being infinite is T23L, an axial distance between the fourth lens element and the fifth lens element of the optical photographing lens assembly at the object distance being infinite is T45L, and the following condition is satisfied:
$$0.01 < T 45 L / T 23 L < 0.5 .$$

20. The optical photographing lens assembly of claim 14, wherein an Abbe number of the fourth lens element is V4, an Abbe number of the sixth lens element is V6, and the following condition is satisfied:
$$90. < V 4 + V 6 < 130.$$

21. The optical photographing lens assembly of claim 14, wherein a central thickness of the first lens element is CT1, a central thickness of the third lens element is CT3, and the following condition is satisfied:
$$0.1 < CT 1 / CT 3 < 1.2 .$$

22. The optical photographing lens assembly of claim 14, wherein the maximum field of view of the optical photographing lens assembly at the object distance being infinite is FOVL, a focal length of the second lens element is f2, the focal length of the third lens element is f3, the focal length of the sixth lens element is f6, a central thickness of the second lens element is CT2, a central thickness of the third lens element is CT3, the central thickness of the fourth lens element is CT4, the central thickness of the fifth lens element is CT5, the axial distance between the second lens element and the third lens element of the optical photographing lens assembly at the object distance being infinite is T23L, the axial distance between the fifth lens element and the sixth lens element of the optical photographing lens assembly at the object distance being infinite is T56L, the curvature radius of the image-side surface of the first lens element is R2, the curvature radius of the object-side surface of the second lens element is R3, a curvature radius of the image-side surface of the second lens element is R4, and the following conditions are satisfied:
$$\begin{matrix}33.6 degrees \leq FOVL \leq 35.6 degrees ; \\ 0.08 \leq \vert f 3 / f 6 \vert \leq 0.6 ; \\ 0.28 \leq ( CT 4 + CT 5 ) / T 56 L \leq 0.63 ; \\ 6.09 \leq \vert f 2 / R 3 \vert + \vert f 2 / R 4 \vert \leq 12.09 ; \\ 0.19 \leq CT 2 / CT 3 \leq 0.53 . \\ 0.4 \leq ( R 2 + R 3 ) / ( R 2 - R 3 ) \leq 1.83 ; and \\ 0.17 \leq CT 4 / T 23 L \leq 0.59 .\end{matrix}$$

23. An optical photographing lens assembly comprising two lens element groups, the two lens element groups comprising six lens elements, the two lens element groups being, in order from an object side to an image side along an optical path:
a first lens element group and a second lens element group;
wherein the six lens elements are, in order from the object side to the image side along the optical path, a first lens element, a second lens element, a third lens element, a fourth lens element, a fifth lens element and a sixth lens element; each of the six lens elements has an object-side surface towards the object side and an image-side surface towards the image side;
wherein when the imaged object is moved from infinite to macro, the optical photographing lens assembly is changed from a 1st mode to a 2nd mode; during a focusing movement, the second lens element group is moved towards to the image side along an optical axis relative to the first lens element group; during the focusing movement, all lens elements in each of the two lens element groups have no relative movement;
wherein the first lens element group comprises the first lens element, the second lens element and the third lens element; the second lens element group comprises the fourth lens element, the fifth lens element and the sixth lens element;
wherein the first lens element has positive refractive power; at least one of the first lens element to the sixth lens element comprises at least one inflection point;
wherein a central thickness of the first lens element is CT1, a central thickness of the third lens element is CT3, a central thickness of the fourth lens element is CT4, a central thickness of the fifth lens element is CT5, an axial distance between the fifth lens element and the sixth lens element of the optical photographing lens assembly at an object distance being infinite is T56L, an axial distance between the object-side surface of the first lens element and an image surface of the optical photographing lens assembly at the object distance being infinite is TLL, an axial distance between the object-side surface of the first lens element and the image-side surface of the third lens element of the optical photographing lens assembly at the object distance being infinite is Dr1r6L, an axial distance between the object-side surface of the first lens element and the image surface of the optical photographing lens assembly at the object distance being macro is TLS, and the following conditions are satisfied:
$$\begin{matrix}0.1 < ( CT 4 + CT 5 ) / T 56 L < 1.5 ; \\ 0.1 < CT 1 / CT 3 < 1.8 ; \\ 1. < TLL / Dr 1 r 6 L < 3. ; and \\ 0.9 < TLL / TLS < 1.1 .\end{matrix}$$

24. The optical photographing lens assembly of claim 23, wherein the second lens element has negative refractive power; the image-side surface of the sixth lens element is convex in a paraxial region thereof.

25. The optical photographing lens assembly of claim 23, wherein an axial distance between the first lens element group and the second lens element group of the optical photographing lens assembly at the object distance being infinite is TG1G2L, an axial distance between the first lens element group and the second lens element group of the optical photographing lens assembly at the object distance being macro is TG1G2S, and the following condition is satisfied:
$$2.2 < ( TG 1 G 2 S - TG 1 G 2 L ) / TG 1 G 2 L < 6. .$$

26. The optical photographing lens assembly of claim 23, wherein the central thickness of the first lens element is CT1, an axial distance between the second lens element and the third lens element of the optical photographing lens assembly at the object distance being infinite is T23L, and the following condition is satisfied:
$$0.1 < CT 1 / T 23 L < 1.7 .$$

27. The optical photographing lens assembly of claim 23, wherein an axial distance between an image-side surface of a lens element closet to the image side and an image surface of the optical photographing lens assembly at the object distance being infinite is BLL, an axial distance between an image-side surface of a lens element closet to the image side and the image surface of the optical photographing lens assembly at the object distance being macro is BLS, and the following condition is satisfied:
$$1.5 < BLL / BLS < 3. .$$

28. The optical photographing lens assembly of claim 23, wherein a central thickness of the sixth lens element is CT6, the axial distance between the fifth lens element and the sixth lens element of the optical photographing lens assembly at the object distance being infinite is T56L, and the following condition is satisfied:
$$0.01 < CT 6 / T 56 L < 1. .$$

29. The optical photographing lens assembly of claim 23, wherein the central thickness of the first lens element is CT1, the central thickness of the third lens element is CT3, the central thickness of the fourth lens element is CT4, the central thickness of the fifth lens element is CT5, the axial distance between the fifth lens element and the sixth lens element of the optical photographing lens assembly at the object distance being infinite is T56L, the axial distance between the object-side surface of the first lens element and an image surface of the optical photographing lens assembly at the object distance being infinite is TLL, the axial distance between the object-side surface of the first lens element and the image-side surface of the third lens element of the optical photographing lens assembly at the object distance being infinite is Dr1r6L, the axial distance between the object-side surface of the first lens element and the image surface of the optical photographing lens assembly at the object distance being macro is TLS, and the following conditions are satisfied:
$$\begin{matrix}0.28 \leq ( CT 4 + CT 5 ) / T 56 L \leq 0.63 ; \\ 0.55 \leq CT 1 / CT 3 \leq 0.9 ; \\ 2.15 \leq TLL / Dr 1 r 6 L \leq 2.3 ; and \\ TTL / TLS = 1. .\end{matrix}$$
